(19) United States
(12) Patent Application Publication
(10) Pub. No.: US 2012/0322675 A1
(43) Pub. Date: Dec. 20, 2012

(54) GENOME-SCALE ANALYSIS OF REPLICATION TIMING

(75) Inventors: David M. Gilbert, Tallahassee, FL (US); Tyrone Ryba, Tallahassee, FL (US); Ichiro Hiratani, Mishima, Shizouka (JP)

(73) Assignee: Florida State University Research Foundation, Tallahassee, FL (US)

(21) Appl. No.: 13/479,686

(22) Filed: May 24, 2012

Related U.S. Application Data
(63) Continuation-in-part of application No. 12/200,186, filed on Aug. 28, 2008.
(60) Provisional application No. 60/969,399, filed on Aug. 31, 2007.
(60) Provisional application No. 61/489,467, filed on May 24, 2011.

(51) Int. Cl. C40B 30/04; G06F 19/20

(52) U.S. Cl. 506/9; 702/19

(57) ABSTRACT

Methods for identifying and/or distinguishing a homogeneous population of cells based on their replication domain timing profile using high resolution genomic arrays or sequencing procedures are provided. These methods may be used to compare the replication timing profile for a population of cells to another replication timing profile(s), a replication timing fingerprint, and/or one or more informative segments of a replication timing fingerprint, which may be simultaneously or previously determined and/or contained in a database, to determine whether there is a match between them. Based on such information, the identity of the population of cells may be determined, or the identity of the population of cells may be distinguished from other populations of cells or cell types. Methods for determining a replication timing fingerprint for particular cell types are also provided.

### CROSS-REFERENCE TO RELATED APPLICATIONS

This application claims priority from, and is a continuation-in-part of, U.S. patent application Ser. No. 12/200,186, entitled “METHOD FOR IDENTIFYING CELLS BASED ON DNA REPLICATION DOMAIN TIMING PROFILES,” filed Aug. 28, 2008, which in turn claims the priority date of co-pending Provisional Application No. 60/969,399, entitled “METHOD FOR IDENTIFYING CELLS BASED ON DNA REPLICATION DOMAIN TIMING PROFILES,” filed Aug. 31, 2007. The present application also claims priority from U.S. Provisional Application No. 61/489,467, entitled “GENOME-SCALE ANALYSIS OF REPLICATION TIMING: FROM BENCH TO BIOINFORMATICS,” filed May 24, 2011. The entire contents and disclosures of the above patent application and provisional applications are incorporated herein by reference.

### GOVERNMENT INTEREST STATEMENT

The United States government may have rights in this invention pursuant to National Institutes of Health (NIH) Grant Nos. GM083337 and GM085354-015319.

### BACKGROUND

1. Field of the Invention

The present invention broadly relates to a method for identifying cells based on their replication domain timing profiles using a high resolution genomic array. The present invention also broadly relates to a method for distinguishing cells from other cells based on replication timing profiles using a high resolution genomic array. The present invention further broadly relates to determining one or more replication timing fingerprints of a cell by comparing replication domain timing profiles obtained using a high resolution genomic array.

2. Related Art

Conventional mechanisms to classify or identify cells involve a variety of heterogeneous biochemical and molecular procedures. For example, morphology-based approaches (e.g., histology) rely on microscopic examination of cell shape and features to determine cell type. This approach is useful in cases in which cells display a distinctive shape (e.g., long axons in neurons) and/or an easily recognizable feature (e.g., a lipid vesicle stained for fats), but most cells are difficult to distinguish based on their appearance alone. Histology-based procedures for cell identification also require a highly trained person, making them impossible to apply in a high-throughput manner.

Protein-based approaches, including biochemical and/or immunological techniques, involve detection of specific proteins that may indicate a particular cell type. A protein may be recognized by an antibody specific for such protein present either on the cell surface (e.g., by immunohistology) or in extracts or samples from disintegrated cells (e.g., by immunoblotting or ELISA). These assays are generally sensitive, fast and simple. However, because each antibody recognizes only one particular protein antigen, such approaches generally do not provide sufficient information to distinguish various types of cells. In other words, a single protein marker is rarely a guarantee of a particular cell type. On the other hand, larger-scale protein detection methods (e.g., proteomics) suffer from insufficient sensitivity and a lack of capability for automation.

RNA-based approaches are based generally on the detection of mRNA as a reflection of gene expression that may be indicative of a particular cell type and may be performed individually or by using an array system. See, e.g., Spellman et al., Mol. Biol. Cell 9:3273-97 (1998); DeRisi et al., Science 278:680-86 (1997); Burton et al., Gene 293:21-31 (2002). Indeed, these technologies can produce a great deal of information about the overall pattern of gene expression of a cell. However, the decisive drawback of this system is the instability of RNA. Every experiment with RNA must take into account possible degradation of RNA that may occur during sample collection, storage and experimentation. This is especially problematic when working with archived samples (e.g., preserved biopsies) or with limited amounts of cellular material. A further problem with RNA-based approaches is that mRNA fluctuates in response to temporary changes in environmental conditions. In addition, it has been demonstrated recently that mouse embryonic stem cells (mESCs) display considerable cell-to-cell heterogeneity in the expression of certain pluripotency-specific marker genes. See, e.g., Silva et al., “Capturing pluripotency,” Cell 132:532-536 (2008); and Toyooka et al., “Identification and characterization of subpopulations in undifferentiated ES cell culture,” Development 135:909-18 (2008).

Therefore, RNA-based approaches for cell identification are limited by perturbations in gene expression caused by transient cell culture conditions, cell-to-cell heterogeneity in gene expression, and random degradation of mRNA in cell-derived extracts or samples that adversely affect the robustness, reproducibility and interpretation of such techniques. As a result, biological and stochastic variability must be countered by intense bioinformatic analysis. In general, RNA-based arrays are useful discovery tools, but they are not yet widely applicable as a clinical or large-scale assay method for the identification of cells. See, e.g., Miller et al., Cancer Cell 2:353-61 (2002); Nadon et al., Trends Genet. 18:265-71 (2002); Murphy D, Adv. Physiol. Educ., 26:256-70 (2002).

In recent years, some markers for epigenetic modifications to chromatin, such as DNA methylation and histone acetylation, have been used to study and distinguish cells. Such approaches are based on the fact that higher organisms must impose and maintain different patterns of gene expression in various types of tissues and/or cells despite having essentially the same DNA sequence encoded by the genome of all cell types within the body of an individual. This is achieved largely through changes in chromatin structure caused in part by chemical modification of chromatin. Generally speaking, the most condensed chromatin domains, known as heterochromatin, are inaccessible to DNA binding factors and tend to be transcriptionally silent, whereas more extended chromatin domains, known as euchromatin, correspond to more accessible portions of the genome that tend to be transcriptionally active.

Therefore, assaying for various epigenetic modifications to chromatin within a collection of cells may provide a basis for distinguishing not only different types of cells, but normal versus transformed cells. For example, aberrant methylation of DNA frequently accompanies the transformation event from healthy to cancerous cells. Indeed, there are examples where specific methylation status may be used to identify and/or distinguish various forms of cancer (see, e.g., Jones et al., Nature Genetics 21:163-167 (1999); Esteller et al., Oncogene 21:5427-5440 (2002); Laird et al., Nature Reviews Cancer 3:253-66 (2003)), as well as different stages and lineage commitments of normal cells (see, e.g., Attwood et al., CMLS 59:241-57 (2002)). However, these techniques based on epigenetic chemical modifications to identify cell states are limited by the following factors (1) they require very high resolution (200 bp nucleosomal units), (2) they reflect dynamic chromatin states that can change or become heterogeneous within a homogeneous cell type, (3) there is a large diversity of histone modifications that would need to be individually investigated to gain a comprehensive profile, and (4) these techniques rely on the use of different and expensive antibodies and other reagents that would create challenges for high-throughput analysis.

Accordingly, new and improved methods for identifying and/or distinguishing cells are still needed.

### SUMMARY

According to one broad aspect of the present invention, a method for identifying cells comprising the following step: identifying the cell type of a population of cells by comparing a replication timing test profile to a replication timing reference profile and determining whether the replication timing test profile and the replication timing reference profile are substantially the same, wherein the replication timing test profile for the population of cells is derived from hybridizing fluorescently labeled DNA from the population of cells to a genomic array having an average probe spacing of about 6 kilobases (kb) or less to determine a replication timing test profile for the population of cells.

### BRIEF DESCRIPTION OF THE DRAWINGS

The accompanying drawings, which are incorporated herein and constitute part of this specification, illustrate exemplary embodiments of the invention and, together with the general description given above and the detailed description given below, serve to explain the features of the invention.

FIG. 1A is a schematic representation showing a protocol for genome-wide replication timing analysis using a 5.8 kb resolution oligonucleotide microarray.

FIG. 1B is a graph showing an exemplary mESC replication timing profile of a segment of chromosome 1 with raw values for probe log ratios [=log₂(Early/Late)] along the chromosome.

FIG. 1C is a graph showing the same replication timing profile values of a segment of chromosome 1 from FIG. 1A but with a local polynomial smoothing (loess) curve to highlight the clear demarcation between regions of coordinate replication.

FIG. 1D is a graph showing a comparison of loess-smoothed replication timing profiles generated using either a 5.8 kb resolution CGH array or a 100-bp resolution tiling array with probe log ratio values for the 100-bp resolution tiling array revealing essentially identical smoothed replication timing profiles.

FIG. 2A is a table providing validation of results from microarray experiments by PCR.

FIGS. 2B and 2B-1 together represent a table comparing the results from microarray experiments to a previously published replication timing analysis of 46C ESCs by PCR (see, e.g., Hiratani et al., “Differentiation-induced replication-timing changes are restricted to AT-rich/long interspersed nuclear element (LINE)-rich isochores,” PNAS USA 101:16861-66 (2004), the entire contents and disclosure of which are incorporated herein by reference), with PCR results classified as early (E) and late (L) based on the same criteria as those used in FIG. 2A.

FIGS. 2C and 2C-1 together represent a table comparing the results from microarray experiments to a previously published replication timing analysis of OS25 ESCs by PCR (see, e.g., Perry et al., “A dynamic switch in the replication timing of key regulator genes in embryonic stem cells upon neural induction,” Cell Cycle 3:1645-50 (2004), the entire contents and disclosure of which are incorporated herein by reference), with genes called E, ME and M by Perry et al. classified as early (E) and with genes called ML and L by Perry et al. classified as late (L).

FIG. 3 is a graph showing the autocorrelation analysis of replication timing data, with the autocorrelation function (ACF) indicating the degree of similarity between neighboring data points (y-axis) plotted against inter-probe chromosome distance (Lag) in Mb (x-axis).

FIG. 4A is a graph showing a loess-smoothed replication timing profile for chromosome 1 from an ESC line with the identification of replication domains (horizontal lines) and their boundaries (dotted lines) by a segmentation algorithm (see, e.g., Venkatraman et al., “A faster circular binary segmentation algorithm for the analysis of array CGH data,” Bioinformatics 23:657-63 (2007)).

FIG. 4B shows graphical box plots of early (E; log ratio>0) and late (L; log ratio<00) replication domain sizes with horizontal bars representing the 10th, 25th, 50th (median), 75th and 90th percentiles, and with arrowheads representing the mean.

FIG. 4C is a graph comparing three different mESC lines (D3, 46C and TT2) having similar replication domain organization, as revealed by visual inspection of a segment on chromosome 1.

FIG. 4D is a table showing high Pearson's R² values for pair-wise comparisons of the three different mESC lines (D3, 46C and TT2).

FIG. 4E is a graphical scatter plot of replication timing ratio differentials for transition regions with a time scale (based on the assumption that the replication timing ratio difference of 3 roughly corresponds to an approximately 10-hour S-phase), plotted against the physical distance (Mb) between the ends of 75 pairs (25 for each chromosome) of adjacent replication domains from chromosomes 2, 11 and 16 revealing a positive linear correlation with a slope that is consistent with mammalian replication fork speeds.

FIG. 5A is a bar graph showing the size distributions of early and late replication domains in ESCs categorized into bins of equal intervals (0.2 Mb or 40 kb below 0.4 Mb) with domains having replication timing ratios above and below zero defined as early and late replication domains, respectively.

FIG. 5B is a bar graph showing the size distributions of early and late replication domains in neural precursor cells (NPCs) categorized into bins of equal intervals (0.2 Mb or 40 kb below 0.4 Mb) with domains having replication timing ratios above and below zero defined as early and late replication domains, respectively.

FIG. 5C is a bar graph showing the size distributions of replication domains categorized into bins of equal intervals (0.2 Mb or 40 kb below 0.4 Mb) that change replication timing from early-to-late (EtoL) or late-to-early (LtoE).

FIG. 5D is a graphical scatter plot of replication timing ratios versus domain size (Mb) in ESCs and NPCs.

FIG. 6A is a pair of graphs of loess-smoothed replication timing profiles for an exemplary segment of chromosome 7 with replication domains indicated by horizontal lines showing dramatic changes upon differentiation of ESCs to NPCs.

FIG. 6B is a graph of loess-smoothed replication timing profiles for three NPCs derived from distinct neural differentiation schemes showing fairly similar replication timing profiles among them by visual inspection.

FIG. 6C is a table providing Pearson's R² values for pair-wise comparisons of NPCs derived from distinct neural differentiation schemes and three independent mESC lines.

FIG. 6D is a graph of a loess-smoothed replication timing profile for a small segment of chromosome 5 showing an exemplary early-to-late (EtoL) consolidation.

FIG. 6E is a graph of a loess-smoothed replication timing profile for a small segment of chromosome 6 showing an exemplary early-to-late (EtoL) consolidation.

FIG. 6F is a graph of a loess-smoothed replication timing profile for a small segment of chromosome 13 showing an exemplary late-to-early (LtoE) consolidation.

FIG. 6G is a graph of a loess-smoothed replication timing profile for a small segment of chromosome 18 showing an exemplary late-to-early (LtoE) consolidation.

FIG. 6H is a schematic representation of replication domain consolidation, boundary shift and isolation events that may occur during differentiation.

FIG. 6I is a table summarizing replication domain properties from ESCs and NPCs.

FIG. 6J is a table summarizing replication domain sizes by chromosome with chromosome Y excluded from the analysis due to being underrepresented on the microarray.

FIG. 6K shows graphical box plots of the sizes of domains that changed replication timing (EtoL and LtoE), as well as early- and late-replicating domains in NPCs with horizontal bars representing the 10th, 25th, 50th (median), 75th and 90th percentiles, and with arrowheads representing the mean.

FIG. 7A is a pair of graphs showing loess-smoothed replication timing profiles of ESCs (top) and NPCs (bottom) compared to % GC computed as moving averages of 500 kb windows of GC content for a segment of chromosome 8 with grey highlighted areas showing regions where differentiation aligns replication timing to GC/LINE-1 content.

FIG. 7B is a pair of graphs showing loess-smoothed replication timing profiles of ESCs (top) and NPCs (bottom) compared to % LINE-1 computed as moving averages of 500 kb windows of LINE-1 content for a segment of chromosome 8, with grey highlighted areas showing regions where differentiation aligns replication timing to GC/LINE-1 content.

FIG. 7C is a graphical scatter plot showing average replication timing ratios of replication domains in ESCs plotted against their % GC content, with Pearson's R² values shown.

FIG. 7D is a graphical scatter plot showing average replication timing ratios of replication domains in NPCs plotted against their % GC content, with Pearson's R² values shown.

FIG. 7E is a graphical scatter plot showing average replication timing ratios of replication domains in ESCs plotted against their % LINE-1 content, with Pearson's R² values shown.

FIG. 7F is a graphical scatter plot showing average replication timing ratios of replication domains in NPCs plotted against their % LINE-1 content, with Pearson's R² values shown.

FIG. 7G is a table showing the mean size (Mb), % GC, % LINE-1 and gene density (RefSeq genes/Mb) of EtoL, LtoE, EtoE and LtoL domain categories with domains having the 5% greatest replication timing changes defined as EtoL and LtoE, and with domains having the least replication timing changes (lowest 20th percentile) that maintain replication timing ratios above 0.5 or below −0.5 defined as EtoE and LtoL, respectively.

FIG. 7H is a table showing correlations of % GC, % LINE-1 and gene density with replication timing of domains in ESCs and NPCs expressed as Pearson's R² values.

FIG. 7I is a graphical scatter plot of % GC content and gene density showing that EtoE, LtoL, LtoE and EtoL domains are generally GC-rich/gene-rich, GC-poor/gene-poor, GC-rich/gene-poor and GC-poor/gene-rich, respectively.

FIG. 7J is a graph of replication timing profiles from mESCs and induced pluripotent stem (iPS) cells showing that iPS cells match the replication timing profiles of ESCs by visual inspection.

FIG. 7K is a table showing Pearson's R² values for pair-wise comparisons of iPS cells to ESCs and NPCs showing high correlation with ESCs but not with NPCs.

FIG. 8A is a graphical scatter plot showing average replication timing ratios of replication domains from ESCs plotted against their “present” (=transcriptionally active) gene density, with Pearson's R² values shown.

FIG. 8B is a graphical scatter plot showing average replication timing ratios of replication domains from NPCs plotted against their “present” (=transcriptionally active) gene density, with Pearson's R² values shown.

FIG. 8C is a bar graph of “bins” of 100 genes ranked according to their replication timing ratios for ESCs, with the width of each bin representing the range of replication timing ratios needed to achieve 100 genes per bin and the height of each bin representing the percentage of active (=“present”) genes within such bin, with logistic regression (inner line) and 95% confidence intervals (outer lines) shown.

FIG. 8D is a bar graph of “bins” of 100 genes ranked according to their replication timing ratios for NPCs, with the width of each bin representing the range of replication timing ratios needed to achieve 100 genes per bin and the height of each bin representing the percentage of active (=“present”) genes within such bin, with logistic regression (inner line) and 95% confidence intervals (outer lines) shown.

FIG. 8E is a pair of graphical box plots showing the fold changes in transcription [=log₂(NPC/ESC)] of LtoE, EtoL, LtoL and EtoE genes with RefSeq genes having the 5% greatest replication timing changes defined as EtoL and LtoE, while those having the least replication timing changes (lowest 20th percentile) that maintain replication timing ratios above 0.5 or below −0.5 are defined as EtoE and LtoL, respectively, with horizontal bars representing the 10th, 25th, 50th (median), 75th and 90th percentiles, and with arrowheads representing the mean.

FIG. 8F is a bar graph showing the relative percentage of “two-fold up” or “two-fold down” regulated genes within LtoE, EtoL, LtoL and EtoE domains as defined in FIG. 7G.

FIG. 8G is a table providing a summary of expression patterns of genes within LtoE, EtoL, LtoL and EtoE domains with “Up” and “Down” genes having above “two-fold up” or “two-fold down” regulation, respectively. “Unchanged” genes having below “two-fold up” or “two-fold down” regulation; “Unchanged Only” domains having only active and silent genes that change by less than two-fold; and “Silent Only” domains having only silent genes.

FIG. 8H is an image of RNA-FISH showing active transcription of LINE-1 transposable elements in ESCs, but not in NPCs, with mean and standard error of mean (SE) of the number of RNA-FISH signals per nucleus (N=30 from two biological replicates) and the P-value obtained from a two-tailed t-test for comparison of two unpaired groups shown.

FIG. 9A is a bar graph of “bins” of 100 genes ranked according to their replication timing ratios for ESCs, with the width of each bin representing the range of replication timing ratios needed to achieve 100 genes per bin and the height of each bin representing the percentage of H3K4me3-positive genes within each bin, with logistic regression (inner line) and 95% confidence intervals (outer lines) shown.

FIG. 9B is a bar graph of “bins” of 100 genes ranked according to their replication timing ratios for NPCs with the width of each bin representing the range of replication timing ratios needed to achieve 100 genes per bin and the height of each bin representing the percentage of H3K4me3-positive genes within each bin, with logistic regression (inner line) and 95% confidence intervals (outer lines) shown.

FIG. 9C is a table showing the relationship between replication timing and the density of different histone modifications (total intensity/domain size) based on a ChIP-Seq study (see Mikkelsen et al., “Genome-wide maps of chromatin state in pluripotent and lineage-committed cells,” Nature 448:553-60 (2007)) calculated for all replication domains in ESCs or NPCs and expressed in terms of Pearson's R² values.

FIG. 9D is a set of graphical plots comparing replication timing ratios with different histone modifications in four exemplary 5 Mb genomic regions of ESCs and NPCs.

FIG. 9E is a graphical box plot showing the distribution of replication timing changes of “bivalently” modified genes (=K4/K27) in ESCs that change to four different modification states (K4/K27, K27, K4, or none) in NPCs, with horizontal bars representing the 10th, 25th, 50th (median), 75th and 90th percentiles and P-values obtained from a two-tailed t-test for comparison of the two unpaired groups shown.

FIG. 10A is a graphical box plot showing the expression level of transcriptionally active (“present”) genes with different promoter CpG densities (LCP, ICP and HCP representing low-, intermediate- and high-CpG promoters, respectively) based on Affymetrix GeneChip analysis of RefSeq genes, with horizontal bars representing the 10th, 25th, 50th (median), 75th, and 90th percentiles and P-values obtained from a two-tailed t-test for comparison of the two unpaired groups shown.

FIG. 10B is a graphical box plot showing the fold changes in transcription [=log₂(NPC/ESC)] of LCP, ICP and HCP genes among EtoL genes, with horizontal bars representing the 10th, 25th, 50th (median), 75th and 90th percentiles and P-values obtained from a two-tailed t-test for comparison of the two unpaired groups shown.

FIG. 10C is a graphical box plot showing the fold changes in transcription [=log₂(NPC/ESC)] of LCP, ICP and HCP genes among LtoE genes, with horizontal bars representing the 10th, 25th, 50th (median), 75th and 90th percentiles and P-values obtained from a two-tailed t-test for comparison of the two unpaired groups shown.

FIGS. 11A and 11A-1 together represent an upper set of graphical box plots providing the subnuclear position (i.e., radial distance) of 8 genomic regions as determined by 3D-FISH in ESCs and NPCs with 0 and 1 representing the periphery and the center of the nucleus, respectively, as well as a lower set of graphical plots providing replication timing profiles and the probe positions (red squares) for the same 8 genomic regions.

FIG. 11B is a representative set of images showing DNA-FISH signals (arrowheads) for Dppa2 and Ptn, with dotted lines representing the rim of nuclear DAPI signal.

FIG. 11C is a model diagram representing a proposed higher-order chromosomal organization in the nucleus during neural differentiation.

FIG. 12 is a table showing primers used for human and mouse BrdU IP screening in Example 12 below.

FIG. 13A is noncorrected BrdU/PI plot of two-dimensional cell-cycle sorting for S— and G1-phases.

FIG. 13B is a corrected BrdU/PI plot of two-dimensional cell-cycle sorting for S— and G1-phases.

FIG. 14 is a cell-cycle profile for a mammalian fibroblast population obtained during FACS analysis by plotting cell count versus DNA content.

FIG. 15A is a graph of distribution of signal intensities before normalization.

FIG. 15B is a graph of distribution of signal intensities after within-array normalization.

FIG. 15C is a graph of distribution of signal intensities after between-array normalization.

FIG. 16A is a graph of dependence of timing ratios on signal intensity before within-array normalization.

FIG. 16B is a graph of dependence of timing ratios on signal intensity after within-array normalization.

FIG. 17A is a boxplot of timing values before normalization between arrays, for a 9-d differentiation from embryonic stem cells to neural precursor cells with 3-d intermediates: (EBM0 (embryonic stem cells); EBM3, EBM6 and EBM9 (neural precursor cells)).⁵

FIG. 17B is a boxplot of timing values after normalization between arrays, for a 9-d differentiation from embryonic stem cells to neural precursor cells with 3-d intermediates: (EBM0 (embryonic stem cells); EBM3, EBM6 and EBM9 (neural precursor cells)).⁵

FIG. 18A is a plot of individual log₂(Cy5/Cy3) probe intensities (y axis) against their position on chromosome 1 (x axis) for replicate 1 of Example 12 below.

FIG. 18B is a plot of individual log₂(Cy5/Cy3) probe intensities (y axis) against their position on chromosome 1 (x axis) for replicate 2 of Example 12 below.

FIG. 19A is a graph of autocorrelation function for a first RT experiment.

FIG. 19B is a graph of autocorrelation function for a second RT experiment.

FIG. 19C is a graph of the average of the autocorrelation functions of FIGS. 19A and 19B.

FIG. 20 is nimbleGen microarray image after a successful experiment.

FIG. 21 are graphs showing a replication timing profile for raw (light) and LOESS-smoothed (dark) RT values along chromosome 1 for replicate 1, replicate 2 of Example 12 below and for an average of replicate 1 and replicate 2.

FIG. 22 is graph showing a replication time profile of raw data (light) overlaid with segmented timing domains (dark) along chromosome 2 of Example 12 below, as defined by circular binary segmentation.⁴²

FIG. 23 is a table of troubleshooting strategies for the method of Example 12 below.

### DETAILED DESCRIPTION OF THE PREFERRED EMBODIMENTS

### Definitions

Where the definition of a term departs from the commonly used meaning of the term, applicant intends to utilize the definitions provided below, unless specifically indicated.

For purposes of the present invention, it should be noted that the singular forms, “a,” “an” and “the,” include reference to the plural unless the context as herein presented clearly indicates otherwise.

For purposes of the present invention, a value or property is “based” on or “derived” from a particular value, property, the satisfaction of a condition or other factor if that value is derived by performing a mathematical calculation or logical decision using that value, property, condition or other factor.

For purposes of the present invention, the term “array” and the term “microarray,” when used to determine the replication timing profile for a population of cells, refer interchangeably to a field or array of a multitude of spots corresponding to nucleic acid probes or oligonucleotides for all or at least a portion of the genome of a species placed on a support or substrate to allow for simultaneous detection and/or quantification of nucleic acid molecules present in one or more sample(s) by hybridization as commonly understood in the art. For purposes of the present invention, the term “array” generally refers to a genomic array, such as a comparative genomic hybridization (CGH) array, a tiling array, etc.

For purposes of the present invention, the term “cell type” refers to the kind, identity and/or classification of cells according to any and all criteria, such as their tissue and species of origin, their differentiation state, whether or not (and in what manner) they are normal or diseased, etc. For example, the term “cell type” may refer separately and specifically to any specific kind of cell found in nature, such as an embryonic stem cell, a neural precursor cell, a myoblast, a mesodermal cell, etc. Such a list of possible cell types is meant herein to be unlimited.

For purposes of the present invention, the term “computer” refers to any type of computer or other device that implements software, including an individual computer such as a personal computer, laptop computer, tablet computer, mainframe computer, mini-computer, etc. A computer also refers to electronic devices such as a smartphone, an eBook reader, a cell phone, a television, a handheld electronic game console, a video game console, a compressed audio or video player such as an MP3 player, a Blu-ray player, a DVD player, a microwave oven, etc. In addition, the term “computer” refers to any type of network of computers, such as a network of computers in a business, a computer bank, the Cloud, the Internet, etc. A computer may include a storage device, memory or other hardware and/or software for loading computer programs or other instructions into the computer. A computer may include a communication unit. The communication unit may allow the computer to connect to other databases and the Internet through an I/O interface. The communication unit may allow the transfer to, as well as reception of data from, other databases. The communication unit may include a modem, an Ethernet card or any similar device that enables the computer system to connect to databases and networks such as LAN, MAN, WAN and the Internet. A computer may facilitate inputs from a user through an input device, accessible to the system through an I/O interface. A computer may execute a set of instructions that are stored in one or more storage devices, in order to process input data. The storage devices may also hold data or other information as desired. The storage element may be in the form of an information source or a physical memory element present in the processing machine. The set of instructions may include various commands that instruct the processing machine to perform specific tasks, such as the steps that constitute the method of the present technique. The set of instructions may be in the form of a software program. Further, the software may be in the form of a collection of separate programs, a program module with a larger program or a portion of a program module, as in the present technique. The software may also include modular programming in the form of object-oriented programming. The processing of input data by the processing machine may be in response to user commands, results of previous processing or a request made by another processing machine. In one embodiment of the present invention a computer may be used to implement steps of the method of the present invention and steps of the various protocols described below.

For purposes of the present invention, the term “differential,” the term “replication timing profile differential” and the term “replication timing differential” refer interchangeably to differences in replication timing values between any combination of: (1) one or more replication timing profile(s); (2) a replication timing fingerprint; and/or (3) one or more informative segment(s) of a replication timing fingerprint. For example, the “replication timing differential” may refer to differences in replication timing ratios, such as differences in replication timing ratios expressed on a logarithmic scale, between two or more populations of cells or cell types at a given genomic or chromosomal locus or along the length of at least a segment of one or more chromosome(s) within a genome, etc.

For purposes of the present invention, the term “epigenetic signature” and the term “epigenetic signatures” broadly refer to any manifestation or phenotype of cells of a particular cell type that is believed to derive from the chromatin structure of such cells.

For purposes of the present invention, the term “epigenetics,” the term “epigenetic markers” and the term “epigenetic parameters” generally refer to chemical modifications of DNA, histones or other chromatin-associated molecules that impart changes in gene expression, such as methylation, acetylation, ubiquitylation, etc. However, the terms “epigenetics,” “epigenetic markers” and “epigenetic parameters” may refer more generally to any changes in chromatin structure that affect gene expression apart from DNA sequence. For example, the terms “epigenetics,” “epigenetic markers” and “epigenetic parameters” may refer to incorporation of histone variants or chromosomal remodeling by enzymes.

For purposes of the present invention, the term “genome-wide” and the term “whole genome” may refer interchangeably to the entire genome of a cell or population of cells. Alternatively, the terms “genome-wide” or “whole genome” may refer to most or nearly all of the genome. For example, the terms “genome-wide” or “whole genome” may exclude a few portions of the genome that are difficult to sequence, do not differ among cells or cell types, are not represented on a whole genome array, or raise some other issue or difficulty that prompts exclusion of such portions of the genome.

For purposes of the present invention, the term “genomic array” is an array having probes and/or oligonucleotides corresponding to both coding and non-coding intergenic sequences for at least a portion of a genome and may include the whole genome of an organism. For example, a “genomic array” may have probes and/or oligonucleotides for only those portions of a genome of an organism that correspond to replication timing fingerprint(s) or informative segments of fingerprint(s). The term “genomic array” may also refer to a set of nucleic acid probes or oligonucleotides representing sequences that are about evenly spaced along the length of each chromosome or chromosomal segment. However, even spacing of probes may be dispensable with very high-density genomic arrays (i.e., genomic arrays having an average probe spacing of much less than about 6 kb).

For purposes of the present invention, the term “hardware and/or software” refers to a device that may be implemented by digital software, digital hardware or a combination of both digital hardware and digital software.

For purposes of the present invention, the term “high resolution array” and the term “high resolution genomic array” generally refers a genomic array having sufficient resolution to provide enough information to generate a smooth replication timing profile to reliably determine the exact positions, lengths, boundaries, etc., of the replication timing domains. The term “high resolution array” or “high resolution genomic array” may correspond to the whole genome or a substantial portion of a genome of a particular cell or population of cells. The term “high resolution array” or “high resolution genomic array” may also refer to a genomic array having an average probe spacing of about 6 kilobases (kb) or less.

For purposes of the present invention, the term “informative segment” and the term “informative segments” refer to one or more contiguous portions or segments of one or more chromosome(s) within a genome that are used to define a replication timing fingerprint. In other words, the terms “informative segment” and “informative segments” may refer to one or more contiguous portions or segments of one or more chromosome(s) within a genome that differ between two or more different cell types. For example, the terms “informative segment” or “informative segments” may refer to one or more regions or segments of a genome for a population of cells of a particular cell type having the following characteristics: (1) the region covers at least about 50 kilobases (kb) of genomic DNA; and (2) the region has at least about a 0.5 replication timing ratio differential across such length compared to all other cell types, or at least compared to all other relevant cell types.

For purposes of the present invention, the term “machine-readable medium” refers to any mechanism that stores information in a form accessible by a machine such as a computer, network device, personal digital assistant, manufacturing tool, any device with a set of one or more processors, etc. For example, a machine-readable medium may be a recordable/non-recordable medium (e.g., a read-only memory (ROM), a random access memory (RAM), a magnetic disk storage medium, an optical storage medium, a flash memory device, etc.), a bar code, an RFID tag, etc.

For purposes of the present invention, the term “mammalian cells” refers to a population of cells that are, or were, originally derived from a mammalian organism. The term “mammalian cells” may include primary cells derived from a mammalian species or a cell line originally derived from a mammalian species. The term “mammalian cells” may refer to a homogeneous population of cells from a mammalian organism.

For purposes of the present invention, the term “population of cells” refers to a homogeneous group or population of cells. The term “population of cells” may also include a single cell in culture having the potential to grow and divide into a plurality of homogeneous cells under appropriate culturing conditions.

For purposes of the present invention, the term “primary cell” refers to a cell or cells isolated from a tissue of an organism and placed in culture. The “primary cell” may be derived from any tissue of any organism, such as a mammalian organism. The term “primary cell” generally includes any cell or cells that may be isolated from a tissue of an organism to create a reasonably homogeneous population of cells, such as by first creating single-cell suspensions.

For purposes of the present invention, the term “replication timing ratio” refers to a ratio value for the timing of replication at a particular locus of a chromosome within the genome of a cell. For example, the “replication timing ratio” may be a ratio of the extent of replication in early S-phase cells divided by the extent of replication in late S-phase cells, or vice versa, at a given locus. Alternatively, the replication timing ratio may be expressed on a logarithmic scale, such as log₂(early/late) or log₂(late/early). Alternatively, for example, the term “replication timing ratio” may refer to the ratio of the extent of replicated DNA in S-phase cells to the amount of DNA in G1-phase cells. The extent of replication or the amount of DNA may be measured, for example, by the fluorescence intensity of an attached label.

For purposes of the present invention, the term “replication timing domain” refers to a contiguous region of a chromosome of a cell or population of cells having roughly the same (i.e., early vs. late) replication timing, such as a contiguous region of a chromosome of a cell or population of cells having roughly the same replication timing ratio value.

For purposes of the present invention, the term “replication timing profile” refers to a series of values for replication timing (e.g., early versus late S-phase replication timing) along the length of at least a segment of one or more chromosome(s) within a genome. For example, the “replication timing profile” may be expressed as a series of replication timing ratio values, such as early/late S-phase replication or late/early S-phase replication, along the length of at least a segment of one or more chromosome(s), which may further be expressed on a logarithmic scale. Alternatively, the “replication timing profile” may refer to a ratio of the amounts of S-phase DNA to G1-phase DNA from a population of asynchronously dividing cells along the length of at least a segment of one or more chromosome(s), which further may be expressed on a logarithmic scale, with a higher ratio indicating earlier replication and a lower ratio indicating later replication. The term “replication timing profile” may include a replication timing fingerprint for a particular cell type or a set of replication timing profiles for informative segments of a replication timing fingerprint for a particular cell type. The term “replication timing profile” further may include a replication timing profile differential between any combination of: (1) one or more replication timing profile(s); (2) a replication timing fingerprint; and/or (3) one or more informative segment(s) of a replication timing fingerprint(s). The “replication timing profile” may be determined, for example, by quantifying an amount of replicated DNA in a sample from a population of cells by measuring fluorescently labeled DNA, by sequencing, etc.

For purposes of the present invention, the term “replication timing test profile” refers to the replication timing profile for a population of cells of interest having an unknown or uncertain identity to the user of the embodiments of the methods of the present invention.

For purposes of the present invention, the term “replication timing reference profile” refers to a replication timing profile used as a basis for comparison to identify and/or distinguish a population of cells based on the population's replication timing test profile. Such “replication timing reference profile” may include a replication timing profile for a population of cells, an average replication timing profile for a group of related or identical cells or from replicate experiments, a replication timing fingerprint, one or more informative segment(s) of a replication timing fingerprint, etc., or any combination thereof. Such a “replication timing reference profile” may be simultaneously or previously determined, may be contained in a database, etc.

For purposes of the present invention, the term “replication timing fingerprint” refers to one or more segments or portions of a replication timing profile for a particular type of cell(s) that differs from all other cell types or all other relevant cell types, which may be used to identify, distinguish, etc., cells of that type. The term “replication timing fingerprint” may refer to the collection of all informative segments of a genome of cells of a particular cell type defined as segments that display a replication timing profile that differs from the replication timing profiles of one or more other cell types. The term “replication timing fingerprint” may further include one or more informative segment(s) that have replication timing profiles that are shared by two or more cell types (i.e., the replication timing profiles are identical or similar) for purposes of comparing a population of cells to a limited set of candidate cell types that have a different replication timing profile for such informative segment(s). A “replication timing fingerprint” may generally exclude uninformative segments that are not consistent among cells of the same type or that do not differ among cells of different types.

For purposes of the present invention, the term “resolution,” with reference to arrays, refers to how much resolution may be achieved along the length of one or more chromosomes. In general, the more probes and/or oligonucleotides along a given length of a chromosome, the greater or higher the resolution may be for such length of a chromosome, assuming roughly equal spacing. Therefore, the terms “density” and “probe density” for an array are directly related to the term “resolution,” since a greater or higher probe density along a given length of a chromosome would generally result in greater or higher resolution for the same length of a chromosome. Conversely, the term “spacing” or “probe spacing” is inversely related to gene density and resolution for an array, since a lower or reduced spacing on average between probes and/or oligonucleotides on the array as a function of chromosomal position would generally result in greater or higher resolution or probe density. For example, an array having an average “probe spacing” of about 6 kb or less along a length of a chromosome would have a “probe density” or “resolution” of about 6 kb or higher for such length of chromosome.

For purposes of the present invention, the term “spot” refers to an area, region, etc. of the surface of a support, substrate, etc., having identical, similar, and/or related nucleic acid probe or oligonucleotide sequences. Such nucleic acid probes may include vectors, such as BACs, PACs, etc. Each “spot” may be arranged so that it does not touch, become indistinguishable from or become continuous with other adjacent spots.

For purposes of the present invention, the term “storage” and the term “storage medium” refer to any form of storage that may be used to store bits of information. Examples of storage include both volatile and non-volatile memories such as ERAM, flash memory, floppy disks, Zip™ disks, CD-ROM, CD-R, CD-RW, DVD, DVD-R, DVD+R, hard disks, optical disks, etc.

For purposes of the present invention, the term “visual display device” or “visual display apparatus” includes any type of visual display device or apparatus such as a CRT monitor, an LCD screen, an LED screen, a projected display, a printer for printing out an image such as a picture and/or text, etc. A visual display device may be a part of another device such as a computer monitor, television, projector, cell phone, smartphone, laptop computer, tablet computer, handheld music and/or video player, personal digital assistant (PDA), handheld game player, head-mounted display, a heads-up display (HUD), global positioning system (GPS) receiver, automotive navigation system, dashboard, watch, microwave oven, electronic organ, automated teller machine (ATM), etc. A visual display device may be used to display to a user images of the various images, plots, graphs, etc. described below and shown in the drawings. A printer may “display” an image, plot, graph, etc. to a user by printing out the image, plot, graph, etc.

### DESCRIPTION

DNA replication is regulated via the coordinate firing of clusters of replicons that duplicate megabase-sized chromosome segments at specific times during S-phase. Cytogenetic studies show that these “replicon clusters” coalesce as sub-chromosomal units or domains that persist through multiple cell generations. Replicon clusters can be visualized in living cells as discrete foci by pulse labeling with fluorescent nucleotide analogs. When followed through multiple cell divisions, labeled foci do not mix, separate or change in shape, indicating that the DNA that replicates coordinately derives from a single chromosome segment. In general it is thought that adjacent replication origins form what is known as a replicon cluster. These replicon clusters replicate within 45-60 minutes and encompass approximately 500 kb, and several adjacent replicon clusters coalesce to form coordinate multi-megabase “replication domains” that replicate within 1-2 hours (see, e.g., Sadoni et al., “Stable chromosomal units determine the spatial and temporal organization of DNA replication,” J. Cell Sci. 117:5353-65 (2004); Dimitrova et al., “The spatial position and replication timing of chromosomal domains are both established in early G1-phase,” Mol. Cell. 4:983-93 (1999); Ma et al., “Spatial and temporal dynamics of DNA replication sites in mammalian cells,” J. Cell Biol. 143:1415-25 (1998); Jackson et al., “Replicon clusters are stable units of chromosome structure: evidence that nuclear organization contributes to the efficient activation and propagation of S phase in human cells,” J. Cell Biol. 140:1285-95 (1998); and Sporbert et al., “DNA polymerase clamp shows little turnover at established replication sites but sequential de novo assembly at adjacent origin clusters,” Mol. Cell. 10:1355-65 (2002), the entire contents and disclosures of which are incorporated herein by reference). So far, however, many details concerning the molecular properties of such domains remain unknown.

Embodiments of the present invention provide methods for identifying and/or distinguishing a population of cells from other cells or populations of cells on the basis of their replication timing profiles obtained by querying a high resolution genomic array. This approach is founded on several discoveries described herein recognizing that replication timing profiles are both stable and reproducible for a particular population of cells and that replication timing profiles differ among different cell types.

Others have attempted to characterize replication timing in various cell types. For example, several studies have determined replication timing of several genomic loci by targeted PCR from samples that contain fragments of replicated DNA purified by immunoprecipitation from cells sorted into various cell cycle fractions. See, e.g., Perry et al., “A dynamic switch in the replication timing of key regulator genes in embryonic stem cells upon neural induction,” Cell Cycle 3: 1645-50 (2004); Azuara et al., “Chromatin signatures of pluripotent cell lines,” Nat. Cell Biol. 8:532-38 (2006); Azuara et al., “Heritable gene silencing in lymphocytes delays chromatid resolution without affecting the timing of DNA replication,” Nat. Cell Biol. 5(7):668-74 (2003); Azuara V., “Profiling of DNA replication timing in unsynchronized cell populations,” Nat. Protoc. 1(4):2171-77 (2006); and Hiratani et al., “Differentiation-induced replication timing changes are restricted to AT-rich/long interspersed nuclear element (LINE)-rich isochores,” PNAS USA 101:16861-66 (2004)). However, the PCR-based methods described in these references are able to determine replication timing only at the few discrete genomic loci that happen to be directly tested by PCR. Such methods would not be able to generate a smooth and continuous replication timing profile for a population of cells, which is necessary to determine the exact positions, lengths and boundaries of replication timing domains. Accordingly, those in the art would not be able to use the PCR-based methods from the above references to accurately and reliably identify and/or distinguish cells on the basis of the exact positions, lengths and boundaries of their replication timing domains.

With existing technology, the only known way to construct a replication timing profile for a population of cells that is able to reliably discern the exact positions, lengths and boundaries of replication timing domains in a high-throughput manner over a large portion of the genome of cells from higher organisms is to subject some form of replicated DNA to analysis using a high-resolution genomic array. However, previous reports have not described a genome-wide analysis of replication timing of cells using high-resolution arrays.

Other groups have carried out genome-wide timing of replication using only low-density arrays. For example, in Schubeler et al., “Genome-wide DNA replication profile for Drosophila melanogaster: a link between transcription and replication timing,” Nat. Genet. 32:438-42 (2002), labeled replicated DNA was subjected to a DNA array that queried only 5,221 sequences having an average chromosomal distance of 20.5 kb, and some probes had a chromosomal distance of 100 kb or greater. In Woodfine et al., “Replication timing of the human genome,” Hum. Mol. Genet. 13:191-202 (2004), replication timing was determined at only 1 Mb resolution. However, such low-density arrays are unable to generate sufficient information or resolution to accurately and reliably determine the exact positions, lengths and boundaries of replication timing domains. In fact, a later publication by the same author (see, Woodfine et al., “Replication Timing of Human Chromosome 6,” Cell Cycle 4:172-76 (2005)) showed that the 1 Mb resolution array is not capable of discerning all early- and late-replicating domains.

Other groups have described the study of replication timing in cells using higher density arrays. However, those studies focused on only a portion or segment of a chromosome and not the whole genome. For example, White et al., “DNA replication-timing analysis of human chromosome 22 at high resolution and different developmental states,” PNAS USA 101:17771-76 (2004), investigated replication timing only of human chromosome 22; MacAlpine et al., “Coordination of replication and transcription along a Drosophila chromosome,” Genes Dev. 18:3094-3105 (2004) studied replication timing only for the left arm of chromosome 2 in Drosophila; and Woodfine et al., “Replication Timing of Human Chromosome 6.” Cell Cycle 4:172-76 (2005) queried only human chromosome 6. In many circumstances, however, a replication timing profile for only a segment or region of a chromosome or only a portion of a genome may be insufficient to accurately and reliably identify a population of cells and/or distinguish a population of cells from other cells.

Importantly, other groups have not explicitly suggested or even contemplated the potential use of high resolution replication timing profiles as an accurate and reliable means to determine the identity of a population of cells and/or to distinguish the identity of a population of cells from other cells or cell types, as proposed herein by embodiments of the present invention. At most, other groups have compared replication timing of cells only for purposes of study and not as a means to identify and/or distinguish the identity of a population of cells, determine replication timing fingerprints for a particular cell type, etc. In fact, the only published report to actually compare replication timing profiles of different cell types using high-density arrays concluded that the two cell types compared are remarkably similar (see White et al., “DNA replication-timing analysis of human chromosome 22 at high resolution and different developmental states,” PNAS USA 101:17771-76 (2004)), which suggests that high-resolution replication timing profiles may not be usable to identify cells and/or distinguish different populations of cells or cell types, determine replication timing fingerprints, etc. For example, it is described herein that as much as 20% of the genome changes replication timing upon neural differentiation of mouse embryonic stem cells (mESCs) into neural precursor cells (NPCs), while replication domain boundaries remain remarkably conserved between genetically polymorphic mESCs, thus indicating that replication timing profiles may serve as stable and reliable epigenetic signatures for different types of cells.

Embodiments of the present invention rely on the novel concept that replication timing profiles may be used to accurately and reliably identify a population of cells and/or distinguish a population of cells from others. Embodiments of the present invention are based at least partially on the underlying and fundamental discoveries described herein that the replication timing profile for a particular cell type or homogeneous population of cells is extremely stable and reproducible through generations of cell cycles and that such replication timing profiles differ among different cell types. Significantly, such replication timing profiles appear to be related to chromatin states of particular populations of cells and not directly related to or affected by transcription levels.

Embodiments of the present invention are based primarily on three discoveries described further herein. First, cells of the same type display nearly identical patterns of replication timing domains regardless of how individual cell lines of the same type are generated and/or maintained. For example, different mouse embryonic stem cell (mESC) lines generated according to different procedures and having different maintenance histories show remarkably similar patterns or profiles of replication timing domains. Indeed, a de-differentiated population of cells, called induced pluripotent stem (iPS) cells, also show remarkable similarity in their pattern of replication timing domains compared to ESCs.

Second, different types of cells, even cells from the same lineage at different stages of development, show divergent and distinguishable patterns or profiles of replication timing domains. For example, as described further below, neural precursor cells (NPCs) display different and distinguishable replication timing profiles than ESCs from which they derive.

Third, and as described hereafter, there is the highly useful insight that a comparative genomic hybridization (CGH) array having a resolution of about 6 kb (or higher) is sufficient to generate smooth and continuous replication timing profiles for a cell that is capable of identifying, distinguishing, etc., even small replication timing domains, including reliably discerning the exact positions, lengths, boundaries, etc., of such replication domains. As described below, an approximately 100 base pair resolution tiling array did not generate any greater saturation of information concerning the number and/or resolution of replication timing domain positions, lengths or boundaries. With existing technology, such insight provides the valuable advantage of conveniently and economically allowing the replication timing profile for the whole genome of a homogeneous population of cells to be queried on a single array, as opposed to multiple arrays as would be used for tiling arrays covering the whole genome.

According to embodiments of the present invention, methods are provided for identifying and/or distinguishing cells on the basis of their replication timing profiles. In a first step, the replication timing profile of a population of cells is determined based on information about the timing of replication (i.e., early S-phase versus late S-phase replication) occurring in the population of cells. In a second step, the replication timing test profile for the population of cells is compared to a replication timing reference profile (or a replication timing fingerprint) to identify the population of cells and/or distinguish the population of cells from other cells. As described further herein, replication timing profiles may be further used to generate replication timing fingerprints for distinct populations of cells or cell types.

### Step 1: Determining a Replication Timing Profile for a Population of Cells

According to a first step of embodiments of the present methods, a replication timing profile may be determined for a cell or population of cells according to embodiments of the present invention, methods for an entire genome, one or more chromosomes, or one or more segments of a chromosome or set of chromosomes depending upon the circumstances. According to some embodiments, for example, a replication timing profile for only a segment of a chromosome or for fewer than all chromosomes, such as a segment or segments containing a sufficient number of replication timing fingerprints for a particular cell type (see below), may be sufficient to identify and/or distinguish the population of cells from other cells. According to other embodiments, for example, generation of a replication timing profile for the entire genome of a population of cells may be required to identify and/or distinguish the population of cells from other cells. Due to the relative ease of generating a replication timing profile for the entire genome of a cell on a single array of sufficiently high resolution, embodiments of the present methods may determine the replication timing profile for the entire genome in the first step.

At a minimum, any array used to determine the replication timing profile for the population of cells should have a sufficient resolution to determine the positions, size, boundaries, etc., of early S-phase and late S-phase replication timing domains for at least a segment of the genome, if not the whole genome, for the population of cells. Therefore, for reasons explained further herein, embodiments of the present methods will generally rely on the use of genomic arrays having a resolution or density of about 6 kb or higher (i.e., an average probe spacing of about 6 kb or less) shown to have sufficient resolution to accurately and reliably determine the positions, lengths, boundaries, etc., of replication timing domains.

A population of cells that may be analyzed according to embodiments of the present methods may include any type of cell from any species that is capable of growing and dividing (i.e., proliferating) in a culture medium. Such a population of cells may include, for example, any cell line or any sample of primary cells, such as any cell or population of cells derived from a tissue, biopsy, blood, sputum, saliva, urine collections, etc., or obtained by a medical procedure. For example, such a population of cells may include any cells that are grown in suspension, as adherent cultures, as embryoid bodies, as tissue or organ cultures, etc. Such a population of cells may be derived from any organism. For example, such cell(s) or population of cells may be derived from a mammalian species, such as a human. A population of cells that may be analyzed according to embodiments of the present methods may further include embryonic cells, such as embryonic stem cells (ESCs) or other non-differentiated or precursor cells, or cells that have been de-differentiated from cells derived from somatic tissues or from a differentiated cell line, such as induced pluripotent stem (iPS) cells. Alternatively, such a population of cells may include differentiated cells. A cell(s) or population of cells that may be analyzed according to embodiments of the present methods may also include normal cells, diseased cells, cancerous cells, tumor cells, transformed cells, etc. To ensure accuracy and reliability in determining a replication timing profile for a population of cells, it may be necessary that the population of cells analyzed by embodiments of the present methods be derived from a single cell and/or be free of contamination of other cell types. Therefore, care may need to be taken in culturing cells to ensure the homogeneity or near-homogeneity of the cells.

The replication timing profile for a population of cells may be determined using any method that may accurately and reliably discern the positions, lengths, boundaries, etc., of replication timing domains. For example, a replication timing profile may be determined by: (i) an early/late S-phase method; (ii) a G1-phase/S-phase method; or (iii) a synchronization method. All embodiments of the present methods may be performed in replicate to improve statistical analysis and to allow the determination of average values and deviations as well as the removal of outliers and artifacts. In general, data obtained by embodiments of any of the present methods may also be normalized and subjected to polynomial (loess) smoothing to improve analysis and comparison. Furthermore, different methods and embodiments of the present invention described below may be used in combination to improve the accuracy and reliability of replication timing profiles.

### Early/Late S-phase Method for Determining Replication Timing

According to some embodiments of the present methods, an “Early/Late S-phase” method may be used to determine the replication timing profile for an asynchronous population of cells. Briefly, a population of cells may be cultured in a growth medium containing a modified nucleotide for a predetermined period of time. The modified nucleotide may be incorporated into regions of the genome of S-phase cells that happen to be undergoing DNA replication during that time. Next, the population of cells may be separated into a population of early S-phase cells and a population of late S-phase cells based on the amount of total DNA content per cell. Once early and late S-phase cells are separated, replicated DNA may be obtained from samples derived from both early and late S-phase cells on the basis of the incorporated modified nucleotide. To distinguish replicated DNA from each of the two cell populations, replicated DNA from early S-phase cells and replicated DNA from late S-phase cells may be differentially labeled with fluorescent labels. Finally, the differentially labeled samples of replicated DNA may be hybridized to a nucleic acid array to determine the relative amount of replication occurring at each genomic locus represented on the array in early versus late S-phase cells based on the strength of fluorescence. Once the amounts of replication occurring in each of the distinct populations of S-phase cells are determined, such data may be normalized and used to generate a smooth replication timing profile along the length of each chromosome queried.

For a description of related methods that may be useful in embodiments of the present methods, see, e.g., Hiratani et al., “Differentiation-induced replication-timing changes are restricted to AT-rich/long interspersed nuclear element (LINE)-rich isochors,” PNAS 101:16861-66 (2004); Schubeler et al., “Genome-wide DNA replication profile for Drosophila melanogaster: a link between transcription and replication timing,” Nat. Genet. 32:438-42 (2002); White et al., “DNA replication timing analysis of human chromosome 22 at high resolution and different developmental states,” PNAS USA 101:17771-76 (2004); and Hiratani et al., “Global Re-organization of replication domains during embryonic stem cell differentiation,” PLoS Biol., 6:2220-36 (2008), the entire contents and disclosures of which are incorporated herein by reference.

According to embodiments of the present methods, cells or populations of cells may be grown in a culture medium containing a modified nucleotide. For example, cells may be grown in suspension or as adherent cells or embryoid bodies. Any medium appropriate for growth of a particular population of cells may be used in present methods. Specific mediums that are appropriate for growth of particular populations of cells are known in the art may be used. Adherent cells may be trypsinized to detach them from the surface and allow their isolation into single-cell suspensions.

The modified nucleotide is capable of incorporating into regions of the genome of cells that are undergoing replication during the time of exposure. Only specific regions of the genome of S-phase cells that are undergoing replication during that time will incorporate the modified nucleotide. Depending upon the portion of S-phase that overlaps with the timing or window of exposure to the modified nucleotide, different regions of the genome may incorporate the modified nucleotide. Only those regions of the genome that happen to be undergoing replication during that time of exposure will incorporate the modified nucleotide. For example, early S-phase cells may have a different pattern of replication, and hence a different pattern of incorporation of the modified nucleotide, compared to late S-phase cells. By incorporating the modified nucleotide into sites of replication within the genome of a cell, these regions of replication may later be isolated and identified. The length of time for exposure to the modified nucleotide may be predetermined and may depend on various circumstances, such as the culturing conditions and/or type of cells being analyzed. For example, the timing or window of exposure may be modified according to the length of S-phase for a given cell or population of cells. Generally, it has been found that an exposure time of from about 1 to about 2 hours is effective; however, other exposure times may be used as needed for particular populations of cells, as the case may be.

The modified nucleotide placed in the culturing medium according to embodiments of the present methods may be any modified nucleotide that enables later detection, isolation, separation, analysis or identification. For example, the modified nucleotide may be chemically modified or labeled such that it is capable of being selectively bound by an antibody, another molecule, etc. Alternatively, for example, the modified nucleotide may be directly or covalently attached to a label, such as a fluorescent label. However, incorporation of fluorescently labeled nucleotides may require permeabilization of the cells. According to some embodiments, for example, the chemically modified nucleotide may include biotinylated nucleotides that may later be purified, isolated or extracted using avidin, Extravidin (Sigma), NeutrAvidin (Thermo Scientific), NeutraLite (Belovo) or strepavidin. However, while biotinylated nucleotides may be used successfully, they may have the drawback of requiring permeabilization of cells to allow their incorporation. According to some embodiments of the present methods, the modified nucleotide may be bromodeoxyuridine (BrdU). However, other modified deoxyuridine nucleotides may also be used, such as, for example, iododeoxyuridine (IdU), chlorodeoxyuridine (CldU), 5-ethynyl-2′-deoxyuridine (EdU), etc. See, e.g., Buck et al., “Detection of S-phase cell cycle progression using 5-ethynyl-2′-deoxyuridine incorporation with click chemistry, an alternative to using 5-bromo-2′-deoxyuridine antibodies,” Biotechniques 44(7):927-29 (2008), the entire contents and disclosure of which are incorporated herein by reference. According to some embodiments of the present methods, the concentration of BrdU may be varied or optimized depending on the culturing conditions and/or specific cell type. According to some embodiments, the concentration of BrdU in the growth culture medium may be approximately 50 μM BrdU.

According to some embodiments of the present methods, once the cells have been cultured in the presence of the modified nucleotide for a predetermined period of time, the cells may be sorted into separate populations of early S-phase and late S-phase cells on the basis of DNA content. Cells may be separated into early and late S-phase fractions by, for example, fluorescence-activated cell sorting (FACS). Other methods known in the art for separating or sorting cells into different fractions of early-replicating S-phase and late-replicating S-phase may also be used. For example, antibodies that bind target proteins expressed only during specific stages of the cell cycle may be used to selectively bind and elute cells in such stages of the cell cycle. See, e.g., Oliver et al., J. Oral Pathol. Med. 29(9):426-31 (2000). Alternatively, centrifugal elutriation may potentially be used, although it is cumbersome and expensive compared to FACS.

For FACS sorting, the cells may be washed, lightly fixed (e.g., by ethanol) and suspended in a solution, such as PBS, to achieve a desired concentration of cells (e.g., at least about 1.0×10⁶ cells/ml). For the early/late S-phase method, sorting may require starting populations of at least about 3 million cells for populations having about 30% or more cells in S-phase; greater numbers may be required for cell populations having lower percentages of cells in S-phase. For adherent cultures or masses of cells, such cells should first be detached from the substrate and from surrounding cells to allow their suspension, such as by trypsinization. To allow FACS analysis to separate populations of early and late S-phase cells based on the amount of DNA content, the population cells may first be labeled, for example, with a DNA-labeling fluorescent dye. Any fluorescent DNA-labeling dye known in the art potentially may be used. For example, the DNA-labeling fluorescent dye may be Hoechst, chromomycin, DAPI, propidium iodide (PI), mithramycin, etc. For example, cells may be stained with about 50 μg/ml PI for 30 minutes in the presence of RNAseA (0.5 mg/ml). Alternatively, for example, Hoechst staining has the advantage of being used with live cells rather than requiring fixation. Procedures for using flow cytometry or FACS to separate cells on the basis of cell cycle stage, such as early- and late-replicating S-phase cells, are known in the art. See, e.g., Gilbert et al., “Temporal order of replication of Xenopus laevis 5S ribosomal RNA genes in somatic cells,” PNAS 83:2924-28 (1986); Gilbert et al., “Bovine papilloma virus plasmids replicate randomly in mouse fibroblasts throughout S phase of the cell cycle,” Cell 50:59-68 (1987); and Hiratani et al., “Differentiation-induced replication-timing changes are restricted to AT-rich/long interspersed nuclear element (LINE)-rich isochores,” PNAS 101:16861-66 (2004), the entire contents and disclosures of which are incorporated herein by reference.

According to some embodiments of the present methods, the exact composition of cells that comprise the selected or sorted populations of early-replicating and late-replicating S-phase cells may be controlled to an extent by adjusting the gating limits for the two populations of cells. Such early and late S-phase fractions may include any range or fraction of S-phase cells as long as there is sufficient separation between the two fractions. According to some embodiments, the ranges for the two fractions may be approximately equal. For example, early-replicating S-phase cells and late-replicating S-phase cells may be selected by gating the lowest two-fifths and highest two-fifths of cells in S-phase, respectively, based on DNA-labeling fluorescent dye intensity. Alternatively, for example, early-replicating S-phase cells and late-replicating S-phase cells may be selected by gating the lowest one-third and highest one-third of cells in S-phase, respectively, based on DNA-labeling fluorescent dye intensity. In most cells, the total population of S-phase cells may be defined as greater than 2N but less than 4N DNA content per cell. However, some cell types may have different ranges due to having ploidy greater or less than 2N during interphase. Exact ranges of signal intensity that correspond to cells in S-phase may depend on the particular population of cells being analyzed and the labeling dye used. Such ranges may be established by any known methods or standards.

According to some embodiments, a two-dimensional FACS procedure may be used instead of relying on only one DNA-labeling fluorescent dye. According to this approach, cells may be sorted on the basis of both a DNA-labeling fluorescent dye (as described above) and a second label for the modified nucleotide incorporated into replicated DNA, such as with a fluorescently labeled antibody. Any two fluorescent labels may be used if they have sufficiently different emission wavelengths of light to ensure their independent analysis. For example, DNA content may be labeled with a red-fluorescing dye (e.g., propidium iodide), and the modified nucleotide (e.g., BrdU) may be labeled with a green-fluorescing dye (e.g., FITC-labeled antibody bound to anti-BrdU antibody). When these cells are subjected to two-dimensional FACS, cells are sorted on the basis of both labels. For example, G1-phase cells would be expected to generally have lower DNA-labeling fluorescent dye (e.g., propidium iodide) and little, if any, labeling of the modified nucleotide (e.g., labeled anti-BrdU). By contrast, early S-phase cells would be expected to generally have lower DNA-labeling fluorescent dye (e.g., propidium iodide) but higher amounts of labeling of the modified nucleotide (e.g., labeled anti-BrdU), while late S-phase cells would be expected to generally have higher DNA-labeling fluorescent dye (e.g., propidium iodide) as well as higher amounts of labeling of the modified nucleotide (e.g., labeled anti-BrdU). Finally, G2- and M-phase cells would be expected to generally have higher DNA-labeling fluorescent dye (e.g., propidium iodide), but lower amounts of labeling of the modified nucleotide (e.g., labeled anti-BrdU).

Therefore, the precision and/or accuracy of separation of early and late S-phase cells by two-dimensional FACS may be improved compared to one-dimensional FACS based on only a DNA-labeling dye. For example, G1-phase cells may have greater separation from early S-phase cells, and late S-phase cells may have greater separation from G2/M-phase cells. To further improve results using two-dimensional FACS, controls and standards (e.g., labeling only one or the other) may be performed to correct any skewing caused by spectral overlap that may occur between the two labeling dyes (e.g., by subtracting such overlap from the analysis), and the FACS settings may be set to optimize separation between the different fractions of cells (e.g., by adjusting gains for each fluorescence channel).

According to some embodiments of the present methods, after separation of cells into early-replicating and late-replicating S-phase fractions, it may be necessary to isolate DNA from the distinct populations of early and late S-phase cells. Methods for isolating DNA are known in the art. See, e.g., Hiratani et al., “Differentiation-induced replication-timing changes are restricted to AT-rich/long interspersed nuclear element (LINE)-rich isochors,” PNAS 101:16861-66 (2004); Hansen et al., “Association of fragile X syndrome with delayed replication of the FMR1 gene,” Cell 73:1403-09 (1993); and Cimbora et al., “Long-Distance Control of Origin Choice and Replication Timing in the Human β-Globin Locus Are Independent of the Locus Control Region,” Mol. Cell. Biol. 20:5581-91 (2000), the entire contents and disclosures of which are incorporated herein by reference. For example, the cells may be lysed in SDS-PK buffer (1M NaCl; 10 mM EDTA; 50 mM Tris-HCl, pH 8.0; 0.5% SDS; 0.2 mg/ml PK; 50 μg/ml glycogen), and the DNA may be extracted by phenol/chloroform extraction followed by ethanol precipitation.

According to some embodiments of the present methods, once total DNA is isolated from the distinct populations of early and late S-phase cells, DNA segments of the genome of cells that replicated during the time window of exposure to the modified nucleotide may be isolated. However, to allow separate analysis of replicated DNA apart from non-replicated DNA, it may be necessary to break up the genomes of cells into smaller fragments that may be selected and isolated from each other. The genome may be sufficiently fragmented to allow fine resolution of replication timing along the length of each chromosome. For example, the average size of DNA fragments may be about 2 kb or less. Alternatively, the average size of DNA fragments may be about 1 kb or less, or in some cases, in the range of from about 200 to about 800 bps. According to some embodiments, the isolated DNA from each population of cells may be fragmented by subjecting the isolated DNA to sonication for a period of time. Alternatively, other methods of fragmentation may be used, such as restriction digestion, physical shearing by syringe, etc. However, sonication may be an advantageous method, since it is relatively easy to use and is believed to generate a fairly uniform distribution of small fragments.

According to some embodiments of the present methods, once DNA is isolated from the distinct populations of early and late S-phase cells and fragmented into small segments of DNA, it may be necessary to isolate only those DNA fragments containing sequences that replicated during the period of exposure to the modified nucleotide. Such fragments of replicated DNA from each population of early and late S-phase cells may be isolated from the remaining DNA on the basis of incorporation of the modified nucleotide. Such an isolation of replicated DNA fragments may be achieved by any known method that selectively isolates DNA fragments on the basis of the modified nucleotide incorporated into regions of the genome corresponding to such fragments. For example, according to some embodiments, if the modified nucleotide is a biotinylated nucleotide, DNA fragments may be isolated from the non-replicated DNA by binding to another molecule, for example, avidin, streptavidin, etc., attached to a substrate, such as beads. According to other embodiments, an antibody for the modified nucleotide, such as an anti-BrdU antibody where BrdU is used as the modified nucleotide, may be used to isolate the replicated DNA fragments by immunoprecipitation. However, any method available in the art for isolating the replicated DNA based on the modified nucleotide incorporated into such replicated DNA may be used.

The following is an example of an embodiment of the present methods where an anti-BrdU antibody is used to isolate the BrdU-labeled replicated DNA fragments. The total mixture of DNA fragments from either population of early or late S-phase cells may be incubated for 20 minutes at room temperature with mouse IgG anti-BrdU antibody (e.g., commercially available anti-BrdU antibody from BD Biosciences) in 1× immunoprecipitation buffer (e.g., 10 mM sodium phosphate, pH 7.0; 0.14 M NaCl; 0.05% Triton X-100), then added to anti-mouse IgG for another 20-minute incubation. According to this method, replicated DNA fragments may be bound by the anti-BrdU antibody and secondary antibody. The replicated DNA may then be precipitated as a DNA-protein complex by centrifugation, washed once with 1× immunoprecipitation buffer, and resuspended in digestion buffer (e.g., 50 mM Tris-HCl, pH 8.0; 10 mM EDTA; 0.5% SDS; 0.25 mg/ml PK) for overnight protein digestion at 37° C. The immunoprecipitated DNA may be collected by ethanol precipitation and resuspended in Tris-EDTA at a concentration of, for example, at least about 250 cell equivalents/μl.

Depending on the type and number of cells as well as the culturing conditions, the amount of replicated DNA isolated from the early and late S-phase fractions of cells may not be enough for genomic array analysis. Therefore, according to some embodiments of the present invention, replicated DNA from both early and late S-phase cells may need to be amplified before introduction to the array. Since replicated DNA is isolated in previous steps, only replicated DNA may be amplified. One consideration is that the relative proportions of DNA fragments not be altered or biased as a result of amplification during this step. Methods for random or whole genome amplification (WGA) of DNA that may be used are known in the art. See, e.g., Hughes et al., “The use of whole genome amplification in the study of human disease,” Progress in Biophys. and Mol. Biol. 88(1):73-189 (2005); Lasken et al., “Whole genome amplification: abundant supplies of DNA from precious samples or clinical specimens,” Trends in Biotechnology 21(12):531-35 (2003); Hawkins et al., “Whole genome amplification—applications and advances,” Current Opinion in Biotechnology 13(1):65-67 (2002); and Kwoh et al., “Target amplification systems in nucleic acid-based diagnostic approaches,” Am. Biotechnol. Lab. 8(13):14-25 (1990), the entire contents and disclosures of which are incorporated herein by reference. For example, samples of replicated DNA may be subjected to wholegenome PCR amplification, such as the GenomePlex® whole genome amplification (WGA) method (Sigma).

In addition to PCR-based methods, other examples for amplification of DNA that may be used include, for example, a transcription-based amplification system (TAS), a self-sustained sequence replication system (3SR), ligation amplification reaction (LAR), ligase-based amplification system (LAS), a Q. beta RNA replication system and run-off transcription, etc. However, PCR is the method generally used for whole genome amplification (WGA) in embodiments of the present methods, since it faithfully amplifies the replicated DNA fragments in a uniform and non-biased fashion. One modified PCR procedure that may be used in embodiments of methods of the present invention is ligation-mediated PCR (LM-PCR). See, e.g., O'Geen et al., “Comparison of sample preparation methods for ChIP-chip assays,” Biotechniques 41(5):577-80 (2006), the entire contents and disclosure of which are incorporated herein by reference.

According to some embodiments of the present methods, the isolated (and optionally amplified) replicated DNA may be differentially labeled with fluorescent or photoluminescent dyes prior to hybridization to an array. Any fluorescent dye applicable to array technology may be used. For example, the replicated DNA from early and late S-phase cells may be differentially labeled with fluorescently labeled nucleotides. The labeling of the DNA may be performed according to any known or standard method available in the art. According to some embodiments, DNA may be labeled with fluorescently labeled nucleotides using either nick-translation or random priming methods. See, e.g., Lieu et al., “Development of a DNA-Labeling System for Array-based Comparative Genomic Hybridization,” J. Biomol. Tech. 16(2):104-11 (2005), the entire contents and disclosure of which are incorporated herein by reference. Alternatively, the DNA labeling step may be combined with the amplification step above by adding a modified or fluorescent nucleotide into the amplification reaction, which may theoretically bypass the need for a separate labeling step.

Any combination of photoluminescent labels or dyes, such as fluorophores or fluorescent labels/dyes, potentially may be used as long as there is sufficient separation in the wavelength for exciting and/or emitting light between the two or more fluorescent labels to allow separate analysis. Examples of fluorescent labels are known in the art. According to some embodiments, the fluorescent labeling dyes may be Cyanin-3 (Cy3) and Cyanin-5 (Cy5). For example, the fluorescent labeling dyes may be incorporated into the isolated replicated DNA fragments via Cy3- and Cy5-conjugated nucleotide, such as dUTP (Amersham). However, it is to be understood that any other fluorescent labels may be used, as long as the fluorescent labels have sufficiently different wavelengths of fluorescence that may be distinguished if simultaneously introduced to the same array. Kits for labeling the DNA with fluorescent dyes, such as Cy3 and Cy5 (e.g., Bioprime Labeling Kit from Invitrogen), and kits for isolating DNA labeled with these dyes (e.g., G50 spin column from Amersham Pharmacia) may also be used.

According to some embodiments of the present methods, early-replicating and late-replicating S-phase DNA may be reciprocally labeled in replicate (i.e., dye swap). In other words, in one test set, early-replicating S-phase DNA may be labeled with a first dye (such as Cy3), and the late-replicating S-phase DNA may be labeled with a second dye (such as Cy5). However, in a reciprocal test, early-replicating S-phase DNA may be labeled with the second dye (such as Cy5), and the late-replicating S-phase DNA may be labeled with the first dye (such as Cy3). By averaging any replication timing differences between the dye swapping data sets, any effects or artifacts caused by variations in labeling reactions for one dye versus the other may be minimized or eliminated.

According to an alternative approach for some embodiments of the present methods, the modified nucleotide may be a fluorescently labeled nucleotide introduced into the population of cells in culture. Generally, to incorporate the fluorescently labeled nucleotide into the genome of replicating cells, such cells may also need to be permeabilized according to known methods, such as by electroporation. Following sorting or separation of cells into early and late S-phase fractions, DNA may be isolated and fragmented as described above. Fluorescently labeled DNA fragments may correspond to regions of the genome replicating during S-phase for each of the early and late S-phase fractions. Therefore, such an approach may provide a short-cut method that may potentially allow direct analysis of replicated DNA on the array without the need for prior isolation or immunoprecipitation of replicated DNA as described above.

According to some embodiments of the present methods, after the replicated DNA has been isolated, amplified (if necessary), and labeled with photoluminescent or fluorescent labels/dyes, the labeled DNA may be hybridized to an array for measurement of replication timing as a function of chromosomal position. The array may be any hybridization array that provides sufficient information (i.e., sufficiently high resolution) regarding replication timing as a function of chromosomal position to identify and/or distinguish a population of cells. Array technology is generally known in the art and may be performed according to the relevant manufacturer's instructions.

According to some embodiments of the present methods, the array may be any genomic array querying at least a portion of the genome at a resolution of about 6 kb or greater. For example, the genomic array may be a whole genome array, such as a comparative genomic hybridization (CGH) array. Regardless of the exact resolution or density of probes on the array, it is advantageous that each of the probes be evenly spaced approximately along the length of each chromosome. Although uneven spacing may potentially be corrected by computer algorithm, evenly spaced array probes allow linear relationships between replication timing and chromosomal position coordinates to be more readily determined. According to some embodiments of the present methods, genomic arrays used in embodiments of the present invention may have a resolution or probe density of about 6 kb or higher (i.e., an average probe spacing of about 6 kb or less). For example, as described herein, CGH arrays having an average probe spacing or resolution of 5.8 kb are able to generate replication timing profiles that may identify the positions, lengths, boundaries, etc., as well as higher density arrays. According to some embodiments, the CGH array may be a Nimblegen array, an Agilent array, an Affymetrix array, etc.

According to other embodiments, the array may be a “tiling” array with a much higher probe density (e.g., a probe every 100 bp). Although a tiling array may have the advantage of generating a high-resolution replication timing map, it currently requires the use of multiple arrays to query the whole genome of higher organisms. By contrast, however, a CGH array generally provides sufficient resolution of replication timing and has the advantage of allowing a query of the whole genome on a single chip or array. Therefore, a CGH array having a resolution or probe density of about 6 kb or greater (i.e., an average probe spacing of about 6 kb or less) may be advantageous for embodiments of the present methods. However, it is to be understood that, according to some embodiments, the array may query replication timing for only a portion of the genome. For example, depending on the specific assay or application, replication timing profiles over only one or more chromosomes or one or more segments of chromosome(s) may be sufficient to identify and/or distinguish a population of cells. It is also to be understood that multiple arrays may also be used to determine replication timing profiles for a population of cells, even though using a single array may be generally advantageous.

According to some embodiments of the present methods, after binding differentially labeled early-replicating and late-replicating S-phase DNA to the array, the data may be analyzed using an array scanner. Examples of such scanners are known in the art and may include, for example, the GenePix Axon 4000B (Molecular Devices). Alternatively, DNAscope™ IV & V (Biomedical Photometrics) may also be used. However, any scanner having sufficient resolution could be used. As described above, once the amount of replication is quantified for early and late S-phase cells, a replication timing profile may be generated for the population of cells. For example, the replication timing profile may be represented by a ratio that may be calculated and plotted as log₂(early/late) for each chromosomal locus queried. The replication timing data obtained for early and late S-phase cells may be normalized, and the replication timing profile generated from such data may be plotted using a local polynomial smoothing algorithm to generate a loess-smoothed curve.

According to some embodiments of the present methods, once the amount of replication occurring separately in early and late S-phase cells is determined, a replication timing profile may be generated along the length of each chromosome or chromosomal segment tested. A replication timing profile may be generated according to any known and appropriate mathematical and/or statistical method to determine replication timing based on the amounts of DNA replication occurring at each genomic locus in both early and late S-phase cells. Data from individual replicates may be normalized and scaled to have the same median-absolute deviation using the Limma package (R/Bioconductor). Data sets may then be averaged and smoothed (e.g., by local polynomial (loess) smoothing).

Therefore, a replication timing profile for a population of cells may be generated from a series of replication timing ratios or differences for each genomic locus tested along a length of a chromosome. For example, replication timing ratios at genomic loci may be computed on a logarithmic scale, such as log₂(early/late), where “early” and “late” are the amount of signal intensity for a given locus from early S-phase and late S-phase cells, respectively. Such replication timing profile composed of replication timing ratios may be further subjected to loess polynomial smoothing to help eliminate outliers and artifacts. On the logarithmic scale, replication timing ratios having a positive number are earlier replicating, while negative replication timing ratios are later replicating. Of course, these relationships would be reversed if the logarithmic scale is computed as log₂(late/early). As an alternative approach, a replication timing profile may be computed as a difference between early and late S-phase replication along the length of each chromosome. Once a replication timing profile is determined for a population of cells, the data may be used to identify the positions, lengths, boundaries, etc., of replication domains for the population of cells.

### G1-Phase/S-Phase Method for Determining Replication Timing

According to other embodiments of the present methods, the replication timing profile may be determined by a “G1-phase/S-phase” method. Briefly, an asynchronously dividing population of cells may be labeled with a DNA-binding dye and sorted into G1-phase and S-phase fractions. (Two-dimensional FACS may also be used to improve separation of G1-phase and S-phase cell fractions.) DNA from the G1-phase and S-phase fractions may be separately isolated and differentially labeled with fluorescent labels. Finally, the differentially labeled G1- and S-phase DNA samples may be hybridized to a high-density genomic array, such as a 6 kb or higher resolution genomic array. Many of the steps, such as DNA isolation, labeling and array hybridization, may be performed similarly or identically to procedures and embodiments described above for the early/late S-phase method where appropriate. For a further explanation and description of the G1/S-phase method to determine the replication timing profile for a population of cells that may be used in some embodiments of the present methods, see, e.g., Woodfine et al., “Replication timing of the human genome,” Hum. Mol. Genet. 13:191-202 (2004); and Woodfine et al., “Replication Timing of Human Chromosome 6,” Cell Cycle 4:172-76 (2005), the entire contents and disclosures of which are incorporated herein by reference. Again, embodiments of the present methods using the G1/S-phase method may be performed in replicate and may implement dye-swap experiments to control for labeling effects and conditions. In addition, raw data obtained from the genomic array may be normalized, and replication timing profiles may be subjected to local polynomial (loess) smoothing according to embodiments of the present methods.

The proportion of cells in the unsynchronized S-phase fraction that have replicated a particular sequence of the genome will be proportional to the time at which such sequence replicates in S-phase. Therefore, the ratio of S:G1 phase signal intensity reported for each sequence from the array represents the average sequence copy number in the unsynchronized S-phase fraction with the G1-phase fraction providing a baseline. Thus, sequences with ratios closer to about 2:1 represent loci that replicate earlier during S-phase, while, conversely, sequences with ratios closer to about 1:1 represent sequences that replicate later during S-phase.

### Synchronization Method for Determining Replication Timing

According to other embodiments of the present methods, the replication timing profile may be determined by a “synchronization” method. Any method known in the art for producing a synchronous population of cells in culture may be used. For example, such methods may rely on the use of any compound known to achieve reversible arrest at a defined point in the cell cycle, such as nocodazole, aphidicolin, hydroxyurea, double-thymidine block, etc., followed by release of cells in unison or by removing a compound required for proliferation, such as by starvation, followed by re-addition. Other possibilities may include, for example, elutriation by cell size or mitotic shake-off, as is known in the art. In cases in which the cells have become successfully arrested at a particular cell cycle stage, the cells may be released from the arrest either by removal or addition of a compound to produce a population of synchronously dividing cells. Depending on the starting point in the cell cycle for the newly generated synchronous population of cells as well as the types of cells in question, the cell cycle stage of the synchronous population of cells may be known over time based on the amount of time that has expired since their generation, selection or release.

Therefore, a population of cells may be separated into different cultures or sub-populations and synchronized according to some embodiments of the present methods. Each identical sub-population of separately synchronized cells may then be exposed to a modified nucleotide at different times corresponding to different portions of the cell cycle. For example, one of the identical sub-population of cells may be exposed to (or pulse-labeled with) BrdU at a time corresponding to early S-phase, while the other identical sub-population of cells may be pulse-labeled with BrdU at a different time corresponding to late S-phase. These cells may then be separately harvested, their DNA isolated and fragmented, and replicated DNA purified from each sub-population of cells on the basis of the modified nucleotide, such as by immunoprecipitation with an anti-BrdU antibody. Once the samples of replicated DNA from early and late S-phase cells have been purified, they may be differentially labeled with a photoluminescent (e.g., fluorescent) label or dye and subjected to analysis by hybridization to a genomic array to generate a replication timing profile in a manner similar to that described above.

DNA isolation, purification, labeling and array hybridization steps may be performed similarly or identically to procedures and embodiments described above for the early/late S-phase method where appropriate. For a further explanation and description of the synchronization method to determine the replication timing profile for a population of cells that may be used in some embodiments of the present methods, see, e.g., MacAlpine et al., “Coordination of replication and transcription along a Drosophila chromosome,” Genes Dev. 18:3094-3105 (2004), the entire contents and disclosure of which are incorporated herein by reference. According to some embodiments, the replication timing profile for a population of cells may be determined according to methods similar to the early/late S-phase method. For example, replication timing ratios may be determined as a ratio of early S-phase to late S-phase replication at a given genomic locus, such as log₂(early/late), with a positive value indicating earlier S-phase replication timing and a negative value indicating later S-phase replication timing.

According to alternative embodiments, a single population of synchronized cells may be labeled with one modified nucleotide during early S-phase and a different modified nucleotide during late S-phase. Subsequently, early and late S-phase replicating DNA may be separated by immunoprecipitation with different antibodies to take advantage of the different modified nucleotides, and the different samples of early- and late-replicating DNA may be differentially labeled with fluorescent labels and hybridized to a genomic array.

### Sequencing Methods for Determining Replication Timing

According to other embodiments of the present methods, the replication timing profile may be determined by using a sequencing method. For example, instead of scanning and quantifying fluorescently labeled DNA by hybridizing to an array, total or replicated DNA (e.g., corresponding to S-phase vs. G1-phase DNA or early S-phase vs. late S-phase DNA, respectively, as described above) may be sequenced to determine its identity and location in a genome by comparison to known genomic sequences of an organism. The amount of replication occurring for any given region may be quantified by the number of sequence reads for such a region. In other words, the more abundantly a particular region of a genome is represented in a sample, the greater the number of sequences corresponding to such regions of the genome will be generated. Therefore, the sequencing step may be used to quantify the amount of replication occurring in a fraction of cells used to make the sample. Such quantities may then be used to create a replication timing profile for a population of cells in a manner similar to that described above.

Alternatively, according to some embodiments, what is referred to hereafter as a “sequence capture” method may be used. According to this approach, total or replicated DNA samples (e.g., corresponding to S-phase vs. G1-phase DNA or early S-phase vs. late S-phase DNA, respectively, isolated from a population of cells as described above) may be subjected to an additional step to further isolate only those fragments or sequences corresponding to particular segments or regions of interest within a genome. For example, total or replicated DNA from a fraction of cells may be immobilized on a capture array (or column) containing sequences corresponding to the particular segments or regions of interest within the genome and subsequently eluted after separation from the rest of the unbound DNA in the sample. Such segments or portions of interest may correspond, for example, to replication timing fingerprint(s) or informative segments of replication timing fingerprint(s) for the genome of a particular type of cells. Once these DNA fragments or sequences of interest have been isolated from the sample, they may be subjected to sequencing to identify their location in the genome and quantified as described above. Again, such quantities may then be used to create a replication timing profile for the population of cells, as described above.

Embodiments of present methods may use any sequencing method known in the art. Generally speaking, any potential sequencing bias in carrying out sequencing reactions may be avoided, and sequencing may be performed at random to achieve sequencing of most or every DNA molecule present in a sample. For example, randomized primers may be used, or a sequence corresponding to one or more primer sequence(s) may be ligated to each DNA molecule. In addition, the degree of resolution for the replication timing profile is generally proportional to how “deep” the sequencing reactions are performed. In general, the more overlapping sequence information obtained from a DNA sample derived from a population of cells, the higher the resolution will be for determining the quantity of DNA (and hence DNA replication) present in the sample over smaller segments, portions, regions, etc., of chromosome(s) of a genome of the population of cells. The number and extent of sequencing reactions would need to be sufficiently “deep” to allow for resolution capable of accurately and reliably determining the positions, lengths, boundaries, etc., of replication timing domains from such replication timing profile. A number of improved “deep sequencing” methods have recently emerged for generating large amounts of DNA sequence information in less time, making the sequencing approach for generating a replication timing profile an increasingly feasible option.

Step 2: Identifying and/or Distinguishing the Population of Cells on the Basis of their Replication Timing Profile

During a second step for embodiments of the present methods, the identity of a population of cells, as well as its species of origin, may be determined on the basis of its replication timing test profile by comparison to another replication timing reference profile that may be simultaneously or previously determined. Alternatively, a replication timing profile for a population of cells may be used to distinguish the population of cells from others, such as from other types of cells and/or possibly from cells from different species. According to some embodiments, the replication timing profile may be compared to a known replication timing profile or set of known replication timing profiles, which may also be a part of a database of known replication timing profiles, to thereby identify such population of cells and/or distinguish such population of cells from others. Alternatively, the replication timing profile may be compared to another replication timing profile that may be simultaneously or previously determined. According to embodiments of the present methods, a population of cells may be identified and/or distinguished from all other types of cells or only from a group of candidate cell types or cells of interest.

According to some embodiments of the present methods, once a replication timing profile has been determined for a population of cells based on any of the methods described in the first step, the positions, lengths, boundaries and/or other characteristics of replication timing domains may be determined. Where replication timing is plotted on a y-axis versus chromosomal coordinates along an x-axis, replication domains may be identified as regions of fairly uniform y-axis values separated by sharp transitions. On the basis of a replication timing profile for a population of cells, for example, replication domains and their properties (e.g., chromosomal position, length, boundaries, etc.) may be identified and characterized according to a segmentation algorithm operating with the assistance of a computer, such as DNAcopy (R/Bioconductor) based on analysis of DNA copy number data. This computerized program may provide a circular binary segmentation method for the analysis of array-based DNA copy number data (see, e.g., Olshen et al., “Circular binary segmentation for the analysis of array-based DNA copy number data,” Biostatistics 5(4):557-72 (2004), the entire contents and disclosure of which are incorporated herein by reference). For identification of replication timing domains, such segmentation algorithms or programs may potentially be applied directly to raw data sets or mean replication timing ratios without any smoothing. However, according to some embodiments, a replication timing profile for a population of cells or an average profile for a group of related cells or replicates will be subjected to normalization and polynomial (loess) smoothing to improve results and remove outliers prior to analysis or comparison. Once chromosomal regions corresponding to individual early or late replication timing domains have been determined, characteristics of such domains may be easily deduced by directly measuring the positions, lengths, strengths and boundaries of each domain.

As stated above, once a replication timing profile is determined for a population of cells, such population of cells may be identified and/or distinguished in relation to other replication timing profiles. According to some embodiments of the present methods, such an analysis may be performed qualitatively by eye to determine whether or not there is a match between two or more replication timing profiles, for example, where only an anecdotal determination is sought or where there are obvious differences in replication timing such that statistical analysis is not necessary. According to other embodiments, however, identifying and/or distinguishing a population of cells may be performed accurately and reliably only by statistical analysis, such as with the aid of a computer and associated software.

Such computer software may operate on the basis of an algorithm and/or software program that interprets, compares, etc., replication timing profiles originating from different sources (e.g., by comparing the relative positions, lengths and boundaries of early and/or late replication timing domains). According to some embodiments, the same computer and/or software may perform all aspects of reading and interpreting the data. For example, the computer and associated software may read the data from the scanner, compute the replication timing profile(s) and/or positions, lengths, boundaries, etc., of early and late replication domains, and statistically compare or determine whether a replication timing profile of a population of cells is the same or different from other replication timing profiles, replication timing fingerprints, and/or informative segments of replication timing fingerprints, each of which may be contained in a database. Such computer and associated software may further output such results or determinations on a screen or in hard copy to a user and express such results or determinations either qualitatively, categorically or in terms of various probabilities or confidence levels, such as by providing numerical values of similarities and/or differences between two or more replication timing profiles compared, such as a percent match or a probability match.

To identify and/or distinguish a population of cells from others according to embodiments of the present invention, any acceptable mathematical or statistical technique may be used. Generally speaking, a replication timing test profile generated according to the first step of an embodiment of the present methods may be compared to a separately derived replication timing profile or an average profile for two or more separately derived replication timing profiles, which may be simultaneously or previously determined and/or may be part of a database of replication timing profiles or average profiles. Such a comparison may be made on either the probe or domain level. For example, the degree of correlation (or lack thereof) between a test profile for a population of cells and other replication timing profiles or average profiles for a distinct group of cell populations may be calculated in terms of a correlation coefficient (R) or a coefficient of determination (R²). The correlation coefficient (R) corresponds to the degree of proportionality between the two data sets (e.g., R=1 means there is perfect positive correlation, whereas R=−1 means there is a perfectly inverse correlation). According to other embodiments of the present methods, replication timing data may be compared on the basis of the characteristics of replication timing domains by noting differences in the positions, lengths, boundaries, etc., of replication domains and determining if there is a significant difference.

According to some embodiments, a replication timing profile for a population of cells may be considered a “match” to another replication timing profile or average profile if the degree of correlation is above a predetermined threshold or level. Replication timing profiles that do not reach such correlation threshold may be considered indeterminate or not a match. For example, such a correlation coefficient may be calculated based on a comparison of replication timing ratios along the length of each chromosome and expressed as an average correlation of all such comparisons. According to some embodiments of the present methods, a correlation coefficient (R) of about 0.85 or greater may indicate a match; alternatively, a correlation coefficient (R) of about 0.9 or greater may indicate a match. According to other embodiments of the present methods, a correlation coefficient (R) of less than about 0.8 may indicate that there is not a match.

According to an alternative approach of the present methods, the comparison may be made between all loess-smoothed values, such as a logarithmic replication timing ratio, for each probe on the length of each chromosome. Between replicates of the same population of cells or experiments using different cells of the same type, at least about 95% (e.g., 95-99%) of loess-smoothed replication timing ratios would be expected to differ by less than about 0.5 along the length of each chromosome. In other words, a population of cells may be identified as being the same cell type as another population of cells (i.e., a match) if: (1) their respective profiles or average profiles have at least about 95% (e.g., 95-99%) of loess-smoothed replication timing ratio values differing by less than about 0.5; or (2) only about 5% or less (e.g., 1-5%) of loess-smoothed replication timing ratio values differ by more than about 0.5. On the other hand, it is expected that a population of cells may be distinguished from another population of cells or another cell type (i.e., not a match) if greater than about 10% of their respective loess-smoothed replication timing ratio values differ by about 0.5 or greater. For example, from about 10% to about 20% of their respective loess-smoothed replication timing ratio values may differ by about 0.5 or greater. However, to distinguish closely related cell types (e.g., slightly different differentiating states), it may be necessary that a population of cells be distinguished from another closely related population of cells or cell type (i.e., not a match) by using a standard where greater than about 7% of their respective loess-smoothed replication timing ratio values differ by about 0.5 or greater.

According to some embodiments of the present methods, instead of comparing an assorted, diverse, unrelated, etc., collection of replication timing profiles from individual replicate experiments from individual populations of cells, a replication timing test profile for a population of cells may be compared to an average of replication timing profiles for a group of related cells or a group of distinct populations of cells of the same type, which may be simultaneously or previously determined and/or a part of a database. In other words, such average replication timing profile may be determined from multiple replication timing experiments for either a single population of cells or for a collection of different populations of cells of the same type. For example, an average replication timing profile may be generated from replicate experiments using the same cell line or homogeneous population of cells, or alternatively, an average replication timing profile may be generated from multiple replication timing experiments in different cells or cell lines of the same type, such as, for example, different cell lines derived from the same tissue or cell type of a particular organism. Each replication timing profile from each replicate or experiment may preferably be normalized and/or subjected to loess polynomial smoothing to improve the data prior to averaging.

The advantage of comparing a replication timing test profile for a population of cells to two or more replication timing profiles or an average replication timing profile is that it allows a more accurate and reliable assignment of a replication timing profile to a particular cell type. Since average replication timing profiles may be derived from a plurality of experiments or replicates, the mean values may be expressed at various confidence levels in terms of their standard deviation. Therefore, differences in replication timing ratios between the replication timing test profile and the average replication timing reference profile for a particular cell type over particular regions of chromosomes may be analyzed to determine if those differences are within various degrees of standard deviation that may be used to indicate a match. Conversely, if the replication timing test profile over particular regions of chromosomes falls outside of one or more standard deviations for the average profile, then the population of cells may not be considered a match and may represent a different cell type than represented by the average profile. For example, if such differences are within one, two or three standard deviations across the entire genome, then the population of cells may be considered a match, whereas if such differences fall outside one, two or three standard deviations for a significant portion or length of the genome, then the population of cells may be considered not a match.

According to some embodiments, the replication timing test profile for a population of cells may be compared to another replication timing profile for a distinct population of cells or an average replication timing profile from a group of related populations of cells by subtracting the other replication timing profile or average profile from the test profile to produce a replication timing differential plotted along the length of each chromosome. If the replication timing profiles for a given chromosomal location are the same, the difference would be expected to be approximately zero. However, if there are significant differences in replication timing between the two profiles for a given chromosomal position or region, then a positive or negative number that deviates from zero may be expected. Since early and late replication timing domains are separated by sharp transitions, if domain boundaries do not align between the test profile and another replication profile or average profile used for comparison, then a significantly positive or negative differential may be expected over such regions.

A segmentation algorithm, such as a DNAcopy (R/Bioconductor) program, may be used to identify regions having significantly non-zero replication timing differentials. By determining the number, length and extent of such non-zero replication timing differential regions along each of the chromosomes, a determination may be made whether or not the test profile is a match to another replication timing profile or average profile. Differentials having strongly positive or negative values over a significant length or portion of the genome in one or more locations may indicate that there is not a match between the profiles being compared, and thus the two respective cell types are not the same. By contrast, cells of the same type may be expected to display very few, if any, differences (i.e., significantly positive or negative differential values) over any appreciable length(s) of the genome. In general, the longer the chromosomal length over which there is a significantly positive or negative differential value, the lower that differential value needs to be to indicate that there is not a match.

According to some embodiments of the present methods, a replication timing profile may be compared instead to a “replication timing fingerprint.” A replication timing fingerprint for a particular cell type may be determined from either several replicates of the same population of cells or from separate experiments conducted on a group of related populations of cells of the same type (i.e., having the same differentiation state and derived from the same organism (and tissue type if differentiated)). By comparing the different replicates or experiments for cells of the same type, a combined replication timing profile that accurately conforms to each of the replication timing profiles from each of the replicates or experiments may be generated. Regions that show little variation between replicates and/or experiments may be assigned a mean value and a high degree of confidence, whereas regions that show variation may be assigned lower confidence and may be excluded from further fingerprint analysis.

Subsequently, by comparing such a combined replication timing profile to replication timing profiles of different cell types, consistent differences in replication timing may be observed. For example, a series of replication timing differential values between replication timing ratios from one cell type and those from another cell type may be plotted over the length of each chromosome (in a manner similar to that described above). Regions of chromosomes that are routinely different (i.e., have consistent differential values) for a particular type of cell compared to all other cell types tested or known may be used to help define a replication timing fingerprint for that cell type and may be referred to as an “informative segment” of the genome for purposes of the replication timing fingerprint, whereas regions that do not differ in replication timing or that lack consistency among cells of the same type may be considered “uninformative segments.” The collection of all such informative segments for cells of a particular cell type may be used to define the “replication timing fingerprint” for such cell type, which may be used as a basis for comparison. In general, these “fingerprints” for a particular cell type will include only those informative segments of high confidence that show very significant differentials in replication timing over a substantial length of a chromosome when compared to all other cell types. However, a replication timing fingerprint for a particular cell type may further include one or more informative segment(s) having replication timing profiles that may be shared among two or more cell types if a population of cells of the particular cell type having such informative segment(s) is being compared only to other candidate cell types that do not have the same replication timing profile over such informative segment(s) of the genome. As an example of the present methods used to determine a replication timing fingerprint, the nearest-neighbor statistical approach may be used to group and classify replication timing profiles for distinct populations of cells and cell types in relation to one another.

According to some embodiments of the present methods, a replication timing profile over a segment of a genome may be defined as the collection of all informative segments of the genome for a population of cells, with any given region or segment of a genome defined as an informative segment for a particular cell type if two conditions are met: (1) the region covers at least about 50 kilobases (kb) of genomic DNA; and (2) the region has at least about a 0.5 replication timing ratio differential across such length compared to all other cell types, or at least all other relevant cell types compared. The requirement for at least about a 50 kilobase (kb) region is derived from the fact that such distance corresponds to about 9 or more consecutive probes (assuming about 5.8 kb resolution) and the smallest known replicon (i.e., the smallest unit of differential that would be expected biologically). By including at least about 9 probes, the vast majority of differences due to probe-level noise will be excluded. The requirement of at least about 0.5 replication timing differential provides a practical cutoff and is fairly close to two standard deviations of separation that would define the top 5% of differences as being eligible for the replication timing fingerprint.

By using replication timing fingerprints (i.e., unique regions of differential replication timing for a particular cell type) for one or more populations of cells, comparison to other replication timing profiles may be facilitated because the analysis may be focused on only those informative segments that comprise the replication timing fingerprint. Therefore, according to present embodiments, a replication timing test profile for a population of cells may be compared to replication timing fingerprints for a variety of cell types, which may be contained in a database, to identify the population of cells and/or distinguish the population of cells from others. Therefore, a population of cells displaying a replication timing profile having most or all of the characteristics of a replication timing fingerprint for a particular cell type may be identified as being such cell type. Conversely, a population of cells displaying a replication timing profile lacking the characteristics of a replication timing fingerprint of a particular cell type may be distinguished from such cell type.

According to some embodiments of the present methods, a population of cells displaying a replication timing profile that is similar or substantially the same as most or all of the informative segments of a replication timing fingerprint for a particular cell type may be identified as being the same cell type. By contrast, according to other embodiments, a population of cells displaying a replication timing profile that is substantially different than one or more of the informative segments of a replication timing fingerprint for a particular cell type may be distinguished from such cell type.

For example, according to some embodiments, a population of cells may be identified as being a particular cell type if the replication timing profile has replication timing ratio differentials of about 1.0 or less across the length of most or all informative segments of a replication timing fingerprint for the particular cell type. Alternatively, for example, a population of cells may be identified as being a particular cell type if the replication timing profile has replication timing differentials of about 2.0 or less across the length of most or all informative segments of a replication timing fingerprint for the particular cell type. However, a population of cells may be identified as being a particular cell type even if the replication timing profile has replication timing differentials of greater than about 2.0 across the length of one or more informative segments of a replication timing fingerprint for the particular cell type as long as the number and/or length of such segments is sufficiently small.

Conversely, according to other embodiments, for example, a population of cells may be distinguished from a particular cell type if the replication timing profile has replication timing ratio differentials of about 4.0 or greater across the length of one or more informative segments of the replication timing fingerprint for the particular cell type. However, a population of cells may be distinguished from a particular cell type even if the replication timing profile has replication timing ratio differentials of less than about 4.0 across the length of one or more informative segments of the replication timing fingerprint for the particular cell type as long as the number and/or length of such segments is sufficiently small.

The ability to use replication timing profiles to identify and/or distinguish cells may provide enormous utility in a variety of contexts. For example, a replication timing profile for a population of cells determined by some embodiments of the present methods may be used to determine whether the population of cells is pure or homogeneous depending on how perfectly the replication timing profile for such population of cells conforms to its known or expected replication timing profile or fingerprint. For example, reductions in the relative prominence of certain features or fingerprints of a replication timing profile of a population of cells that are expected for a particular cell type, which may be expressed as a reduced probability or percent match, may be used to indicate less than full purity or homogeneity.

According to some embodiments of the present methods, the replication timing profile for a population of cells may also be used to determine whether a population of cells is normal or diseased. For example, some embodiments of the present methods may be used as a means for diagnosing whether an individual has an inherited disease or whether an individual has cancerous cells in his or her body. Embodiments of the present methods may be used to determine whether a cell or population of cells has become transformed (i.e., whether or not cells are cancerous or tumorigenic). For example, transformed cells generally have altered gene expression and often suffer from genetic instability. Therefore, transformed cells may experience changes in their replication timing profiles due to changes in chromatin structure and/or expression of genes, thus allowing some embodiments of the present methods to identify and/or distinguish such population of cells and determine whether they are diseased, transformed, etc. Cells that have become transformed, cancerous, or tumorigenic cells, therefore, may have different replication timing profiles compared to normal cells of the same tissue type or from which they originated.

Embodiments of the present methods may also be used to diagnose whether a population of cells suffers from other types of disease, such as a developmental or inherited disease. Furthermore, embodiments of the present methods may potentially be used to distinguish subtly different but related types of disease. Being able to characterize a population of cells molecularly may have the advantage of allowing a person, such as a physician or veterinarian, to diagnose disease and tailor treatments for an individual. For example, a biopsy or sample containing a population of cells in question may be extracted or removed from an individual, cultured, and the replication timing profiles of the population of cells may be determined. The replication timing profile for the cells in question may then be used for comparison to other replication timing profiles and/or fingerprints corresponding to normal and/or diseased cells to determine whether the cells in question are normal or diseased.

Embodiments of the present methods may be used to determine the stage of development of a cell or population of cells. Some embodiments of the present methods may be used to determine the extent of differentiation of a population of cells into a particular cell type and whether such differentiation is proceeding normally. For example, embodiments of the present methods may be used to determine whether a population of cells are stem cells, other precursor cells, partially or fully differentiated cells, etc. Alternatively, embodiments of the present methods may be used to determine whether a cell or population of cells has been successfully de-differentiated into a precursor or stem cell, such as, for example, whether an induced pluripotent stem (iPS) cell has become fully reverted.

Such applications may arise in the context of tissue engineering, where cells are being designed for use in an individual. Before administering engineered cells to an individual, it may be necessary for purposes of safety and effectiveness to verify that the cells of a population of cells are what they are purported to be. Therefore, embodiments of the present methods may be used to determine the homogeneity and identity of cells that may be used for therapy. Recent advances in de-differentiating somatic cells to a pluripotent state have opened up possibilities for using an individual's own cells to create a variety of cell types that may be used for treatment of the same individual without the complications of non-self immune reactions or rejection. Therefore, embodiments of the present methods may be used to investigate the chromatin state of cells as evidenced by their replication timing profile to determine whether a population of cells has in fact assumed their purported identity prior to their use in treatment. For example, where stem cells are being differentiated into precursors or specific cell types, embodiments of the present methods may be performed to ensure that cells are differentiating properly and acquiring the desired state of differentiation prior to their use in therapy or treatment.

### General Methods

General molecular biological techniques, biochemical techniques and microorganism techniques that may be used in embodiments of the present invention are described in, for example, Innis, M. A. et al., PCR Strategies (Academic Press, 1995); Ausubel, F. M., Short Protocols in Molecular Biology: A Compendium of Methods from Current Protocols in Molecular Biology (Wiley & Sons, 5^{th} Ed., 2002); Sninsky, J. J. et al., PCR Applications: Protocols for Functional Genomics (Academic Press, 1999); Sambrook J. et al., Molecular Cloning: A Laboratory Manual (3^{rd} Ed., Cold Spring Harbor Laboratory Press, Cold Spring Harbor, N.Y., 2001); Freshney, R. I., Culture of Animal Cells: A Manual of Basic Techniques (4^{th} Ed., 2000); Spector, D. L., Cells: A Laboratory Manual, Culture and Biochemical Analysis of Cells (Cold Spring Harbor Press, 1998), the entire contents and disclosures of which are incorporated herein by reference. Gene introduction may be confirmed by any standard method known in the art, such as those described herein, including, e.g., Northern blotting analysis and Western blotting analysis, or other known or common techniques. Any technique may be used herein for introduction of a nucleic acid molecule into cells, including, for example, transformation, transduction, transfection, etc. Such nucleic acid molecule introduction techniques are known in the art and commonly used.

Having described the many embodiments of the present invention in detail, it will be apparent that modifications and variations are possible without departing from the scope of the invention defined in the appended claims. Furthermore, it should be appreciated that all examples in the present disclosure, while illustrating many embodiments of the invention, are provided as nonlimiting examples and are, therefore, not to be taken as limiting the various aspects so illustrated.

### EXAMPLES

The following nonlimiting examples are provided to further illustrate embodiments of the present invention. It should be appreciated by those of skill in the art that the techniques disclosed in the examples that follow represent approaches that have found function in the practice of these embodiments and thus can be considered to constitute examples of modes for its practice. However, those skilled in the art, in light of the present disclosure, should appreciate that many changes can be made in the specific embodiments that are disclosed herein and still obtain the same or similar result without departing from the spirit and scope of the present invention. The following section provides examples for determining replication timing profiles based on the early/late method described above. However, this should not be construed as a limitation, since it should be understood that the present invention may rely on other methods described herein for determining replication timing profiles for a population of cells.

### Example 1

### Materials and Methods

### ESC Culture, Neural Differentiation and BrdU-Labeling

D3 cells (see, e.g., Doetschman et al., “The in vitro development of blastocyst-derived embryonic stem cell lines: formation of visceral yolk sac, blood islands and myocardium,” J. Embryol. Exp. Morphol. 87:27-45 (1985), the entire contents and disclosure of which are incorporated herein by reference), 46C cells (see, e.g., Ying et al., “Conversion of embryonic stem cells into neuroectodermal precursors in adherent monoculture,” Nat. Biotechnol. 21:183-86 (2003), the entire contents and disclosure of which are incorporated herein by reference), and TT2 cells (see, e.g., Yagi et al., “A novel ES cell line, TT2, with high germline-differentiating potency,” Anal. Biochem. 214:70-76 (1993), the entire contents and disclosure of which are incorporated herein by reference) are male ESC lines with a normal karyotype that are cultured in the presence of LIF (leukemia inhibitory factor) as described in, for example, Rathjen et al., “Lineage specific differentiation of mouse ES cells: formation and differentiation of early primitive ectoderm-like (EPL) cells,” Methods Enzymol. 365:3-25 (2003), the entire contents and disclosure of which are incorporated herein by reference. D3 ESCs are differentiated as embryoid bodies in a conditioned medium (as described in, for example, Rathjen (2003), supra), and NPC samples are collected after 9 days of differentiation. The 46C and TT2 ESCs are differentiated in adherent monolayer culture as described (see, e.g., Ying et al. (2003), supra), and NPC samples are collected after 6 days (46C) or 8 days (TT2) of differentiation. For BrdU-labeling, cells are incubated in the presence of 50 μM BrdU for 1 or 2 hr, washed twice with ice-cold PBS, trypsinized and fixed in 75% ethanol as described in, for example, Hiratani et al., “Differentiation-induced replication-timing changes are restricted to AT-rich/long interspersed nuclear element (LINE)-rich isochores,” PNAS 101:16861-66 (2004), the entire contents and disclosure of which are incorporated herein by reference.

### Cell Cycle Fractionation and Isolation of BrdU-Labeled DNA

BrdU-labeled, fixed cells are resuspended in PBS containing 1% FBS (2-3×106 cells/ml), stained with propidium iodide (50 μg/ml) for 30 min in the presence of RNaseA (0.5 mg/ml), and then sorted into two cell cycle fractions (early and late S) by flow cytometry (as described in, for example, Hiratani et al. (2004), supra). Isolation of BrdU-labeled DNA has been described in, for example, Hiratani et al. (2004), supra.

### Replication Timing Analysis by Microarrays

To obtain sufficient target DNA for microarray hybridization, immunoprecipitated DNA samples are amplified by whole genome amplification (WGA) (Sigma, GenomePlex®) (as described in, for example, O'Geen et al., “Comparison of sample preparation methods for ChIP-chip assays.” Biotechniques 41:577-80 (2006), the entire contents and disclosure of which are incorporated herein by reference). The maintenance of relative enrichment of several known early- and late-replicating genes before and after WGA is confirmed. Sample labeling, hybridization and data extraction are performed according to standard procedures by NimbleGen Systems using a 5.8 kb resolution mouse whole-genome microarray (Nimblegen Systems, 2006-07-26_MM8_WG_CGH). For all except 46C NPCs, two independent biological replicates are analyzed, for which early- and late-replicating DNA were labeled reciprocally with Cy3 and Cy5 (=dye switch). For comparison of different probe density, a 100 bp resolution microarray covering portions of mouse chromosome 6 and 7 (Nimblegen Systems, 2006-07-17_MM8Tiling_Set15) is hybridized with D3 ESC samples in duplicate.

Quality control PCR experiments are performed to validate microarray experiments. Pairs of immunoprecipitated BrdU DNA samples from early and late S fractions are subject to PCR, and mean % early S-phase values [=(intensity of early fraction)/(intensity of early and late fractions combined)] from 6-7 pairs of DNA samples are calculated, as previously described. Genes above and below 50% are classified as early- (E) and late-replicating (L), respectively. From microarray data, replication timing ratios of genes are obtained from the loess-smoothed curve at the transcription start sites. Replication timing ratios above and below 0 are classified as early- (E) and late-replicating (L), respectively.

### Microarray Data Normalization and Replication Timing Ratio Calculation

Normalization procedures are carried out using R/Bioconductor (http://www.r-project.org), while various data analyses are carried out using either R/Bioconductor, Excel (Microsoft) or Spotfire DecisionSite (Spotfire, Inc). For each experiment, raw data sets are loess-normalized to remove signal intensity-dependent bias and scaled to have the same median-absolute deviation using a limma package (R/Bioconductor). From two replicates, the mean replication timing ratios for each probe are calculated. Mean ratios are used to generate a smoothed profile using local polynomial smoothing (loess) for each chromosome [span=300000/(chromosome size)]. Replication timing ratios of 18,679 RefSeq genes are obtained as follows. Briefly, redundancy is removed from a list of 20,509 RefSeq genes (mm8 assembly refflat.txt file from UCSC Genome Browser; http://genome.ucsc.edu) to generate a list of 18,702 non-redundant RefSeq genes on non-chrN_random chromosomes. Loess-smoothed replication timing ratios of these genes at their transcription start sites are obtained using an R/Bioconductor script. Twenty-three genes that resided within large gaps in probes (>0.65 kb) are excluded to generate the final list of 18,679 RefSeq genes with replication timing ratios matched. Complete replication timing data sets for all (384,849) probes may be found at http://www.replicationdomain.org.

### Transcription Analysis by Microarrays

Total cellular RNA is isolated from D3 ESCs or NPCs (three biological replicates per cell state), and steady-state transcript levels are determined by Affymetrix GeneChip® microarrays (Mouse Genome 430 2.0), which are highly reproducible (R²>0.98 between all replicates). After quality control tests (see, e.g., Bolstad B. M., “Quality Assessment of Affymetrix GeneChip Data,” in Gentleman et al., Bioinformatics and Computational Biology Solutions using R and Bioconductor (New York, N.Y., Springer, 2005, pp. 33-48), the entire contents and disclosure of which are incorporated herein by reference), data sets are subjected to normalization by the Probe Logarithmic Intensity Error algorithm (PLIER) developed by Affymetrix for calculating probe signals. For each Affymetrix “probe set,” the signal intensities of the three biological replicates are averaged (=average intensity). Genes may be represented by multiple probe sets. In such cases, the one with the highest total intensity (i.e., sum of ESC and NPC average intensity) is defined as the representative probe set, and the other probe sets are not used. The highest intensity probe sets are used because these sets are empirically the most consistent with reverse transcriptase (RT)-PCR analysis and may be defined in an objective way. Present (transcriptionally active) and absent (inactive) calls are generated by MAS5.0 (Affymetrix) per replicate per probe set, which results in multiple present-absent calls for a given gene [=3×(total number of probe sets for a gene)]. “Present” genes are defined as those with more than 50% of all probe set calls being “present.” The 15,143 (81%) of the 18,679 RefSeq genes, for which replication timing ratios are obtained, are represented on the Affymetrix GeneChip® microarrays and are assigned transcription levels and present-absent calls. Validation of transcription array results is evident from previously published transcription analysis under the same condition (see, e.g., Rathjen et al., “Directed differentiation of pluripotent cells to neural lineages: homogeneous formation and differentiation of a neurectoderm population,” Development 129:2649-61 (2002), the entire contents and disclosure of which are incorporated herein by reference).

Identification of Replication Domains and Domains that Change Replication Timing

DNAcopy (R/Bioconductor) is a segmentation algorithm for the analysis of microarray-based DNA copy number data (see, e.g., Venkatraman et al., “A faster circular binary segmentation algorithm for the analysis of array CGH data,” Bioinformatics 23:657-63 (2007), the entire contents and disclosure of which are incorporated herein by reference). For identification of replication domains, this method is applied directly to data sets containing mean replication timing ratios for all probes before loess smoothing. The parameters, nperm (number of permutation) and alpha (the significance level for the test to accept change-points), are set at 10,000 and 1×10-15, respectively, which are empirically determined based on how well the resultant segmentation profile traced the loess-smoothed profile. Once determined, these parameters are fixed and used for objective segmentation of all data sets. A segmentation is run for each chromosome. The same strategy is used to identify chromosomal domains that change replication timing, except in this case, data sets consisting of replication timing ratio differential (=NPC ratio−ESC ratio) for all probes are used for segmentation. Among the resultant 2,042 segments, 102 EtoL, 102 LtoE, 232 EtoE and 96 LtoL domains are selected based on the criteria described herein.

### Analysis of Transitions Between Replication Domains

Three chromosomes are analyzed for transitions between domains, identifying 25 from each of the following regions: chr2:40,000,000-75,000,000; chr11:40,000,000-68,000,000; and chr16:40,000,000-65,000,000. Transition regions are defined as regions with large and unidirectional changes in replication timing along the chromosomes on the loess-smoothed curve. The positions at which this unidirectionality stops are defined as the two “ledges” of a transition region.

### GC and LINE-1 Content Calculation

GC and LINE-1 content is calculated based on the UCSC Genome Browser database (gc5base.txt and chrN_rmsk.txt, mm8 assembly; http://genome.ucsc.edu) using the Table Browser function of the UCSC Genome Browser as well as an R/Bioconductor script.

### DNA-FISH

DNA-FISH is performed essentially as described in, for example, Li et al., “The replication timing program of the Chinese hamster beta-globin locus is established coincident with its repositioning near peripheral heterochromatin in early G1 phase,” J. Cell Biol. 154:283-92 (2001), the entire contents and disclosure of which are incorporated herein by reference, with some modifications. Briefly, preparation and fixation of cells are done as described in, for example, Solovei et al., “FISH on three-dimensionally preserved nuclei,” in: Beatty, B. et al., Editors, FISH: Practical Approach (Oxford: Oxford Univ. Press., 2002), the entire contents and disclosure of which are incorporated herein by reference, to preserve 3D structure. BAC probes are used for all genes tested, with some genes additionally tested by PCR probes of 8.9-10.2 kb. DIG-labeled probes are generated using the DIG-nick translation mix (Roche, Cat#11745816910). Primary and secondary antibodies used to detect the DIG-labeled probes are sheep anti-DIG-fluorescein (Roche Applied Science, Cat#11207741910) and rabbit fluorescein anti-sheep IgG (Vector, Cat#FI-6000), respectively. Images are captured with a DeltaVision Image Restoration Microscope System (Applied Precision) attached to an Olympus IX-71 fluorescence microscope equipped with an Olympus PlanApo 100×1.42NA oil objective lens. Optical sections are taken with 0.2 mm spacing and are subsequently enhanced using a constrained iterative deconvolution process by softWoRx software (Applied Precision). The radius of each nucleus is defined as one-half of the largest diameter of DAPI staining and measures the distance from FISH signals to the nearest nuclear periphery.

### RNA-FISH

LINE-1 RNA-FISH is performed essentially as described in, for example, Wijgerde et al., “Transcription complex stability and chromatin dynamics in vivo,” Nature 377:209-13 (1995), the entire contents and disclosure of which are incorporated herein by reference. LINE-1 primer sequences are 5′-TAATACGACTCACTATAGGGGGCTCAGAACTGAACAAAGA-3′ (forward; underline, T7 promoter) and 5′-GCTCATAATGTTGTTCCACCT-3′ (reverse), which amplifies a 1041-bp fragment of LINE-1 corresponding to portions of ORF2 and the 3′-UTR (L1MdA2; accession, M13002; 7713 bp). Importantly, this sequence is conserved in other subfamilies of LINE-1. Genomic DNA is used for PCR, and the amplified DNA fragment is purified and used for in vitro transcription followed by reverse transcription to generate a digoxigenin (DIG)-labeled, single-stranded DNA probe.

### Example 2

### Replication Domain Structure in Embryonic Stem Cells

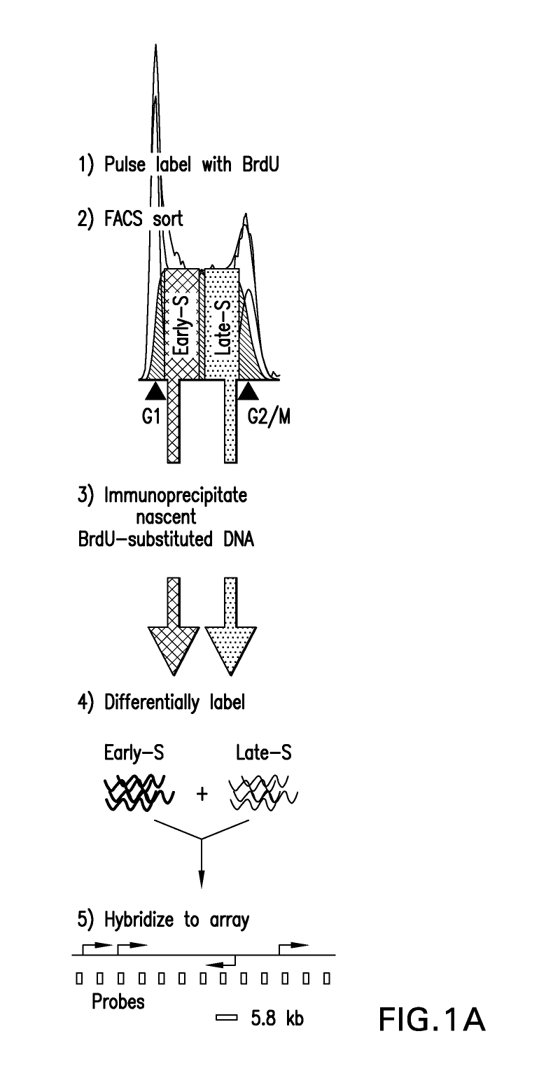

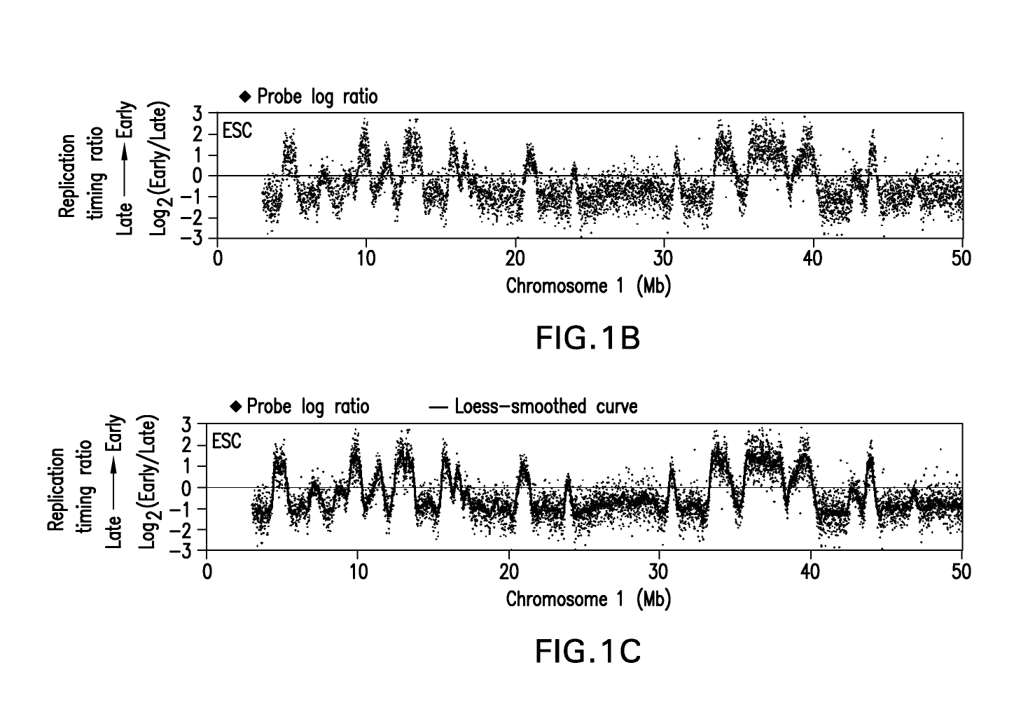

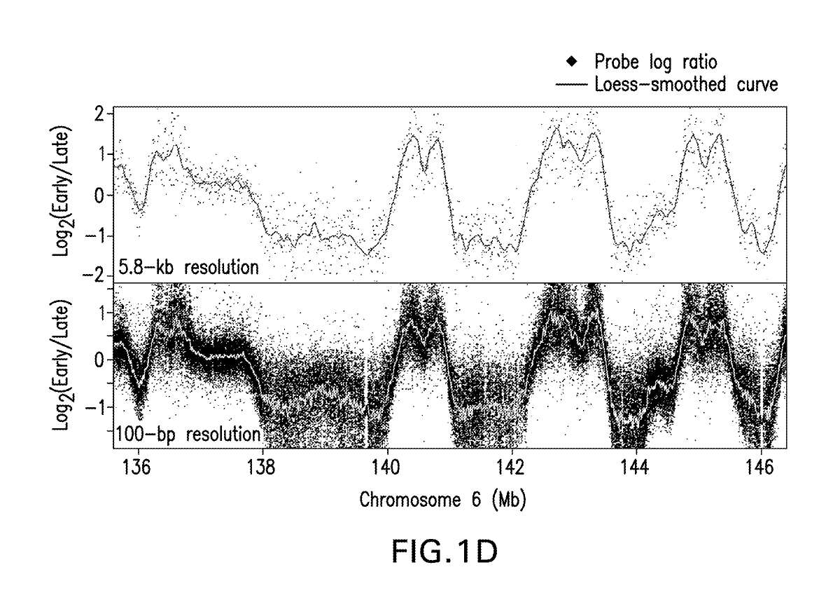

Replication timing is mapped in mESCs using high-density oligonucleotide arrays, adapting a previously developed retroactive synchronization method. See, e.g., Schubeler et al., “Genome-wide DNA replication profile for Drosophila melanogaster: a link between transcription and replication timing,” Nat. Genet. 32:438-42 (2002); and Gilbert DM, “Temporal order of replication of Xenopus laevis 5S ribosomal RNA genes in somatic cells,” PNAS USA 83:2924-28 (1986), the entire contents and disclosures of which are incorporated herein by reference. ESCs are chosen because they provide the opportunity to directly evaluate dynamic changes in the replication program in response to changes in growth conditions (see, e.g., Hiratani et al., “Differentiation-induced replication-timing changes are restricted to AT-rich/long interspersed nuclear element (LINE)-rich isochores,” PNAS USA 101:16861-66 (2004); and Perry et al., “A dynamic switch in the replication timing of key regulator genes in embryonic stem cells upon neural induction,” Cell Cycle 3:1645-50 (2004), the entire contents and disclosures of which are incorporated herein by reference), in contrast to comparisons of separately isolated cell lines that may harbor genetic differences or long-term epigenetic adaptations. Cells are pulse labeled with BrdU and separated into early and late S-phase fractions by flow cytometry. BrdU-substituted DNA from each fraction is immunoprecipitated with an anti-BrdU antibody, differentially labeled and co-hybridized to a mouse whole-genome oligonucleotide microarray (Nimblegen Systems) (see FIG. 1A). The ratio of the abundance of each probe in the early and late fraction [“replication timing ratio”=log₂(Early/Late)] is then used to generate a replication timing profile for the entire genome at 5.8 kb resolution. Replicate experiments in which early- and late-replicating DNA are reciprocally labeled (“dye-switch”) show a high degree of correlation, and results are averaged (R² values ranged between 0.86 and 0.95 after loess smoothing).

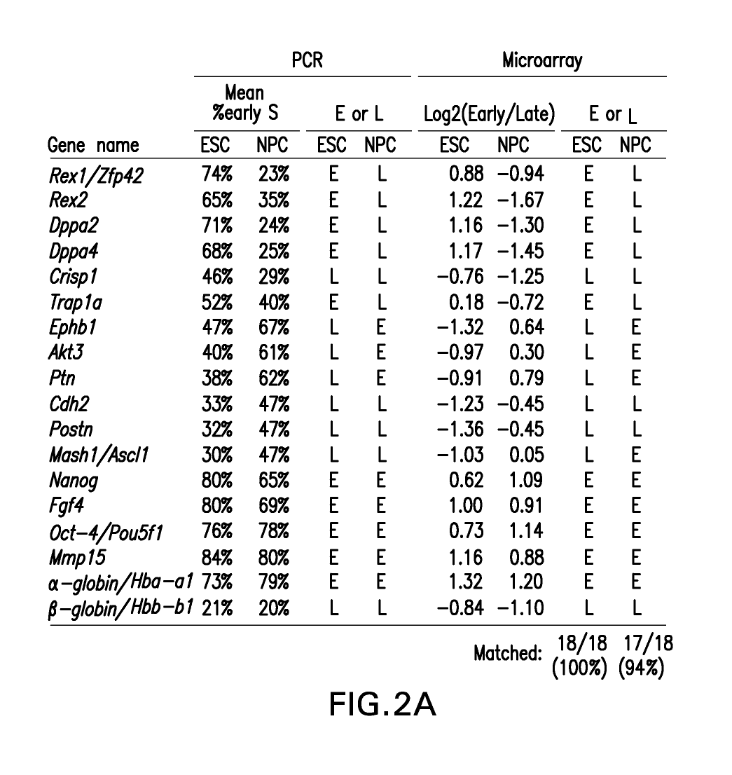

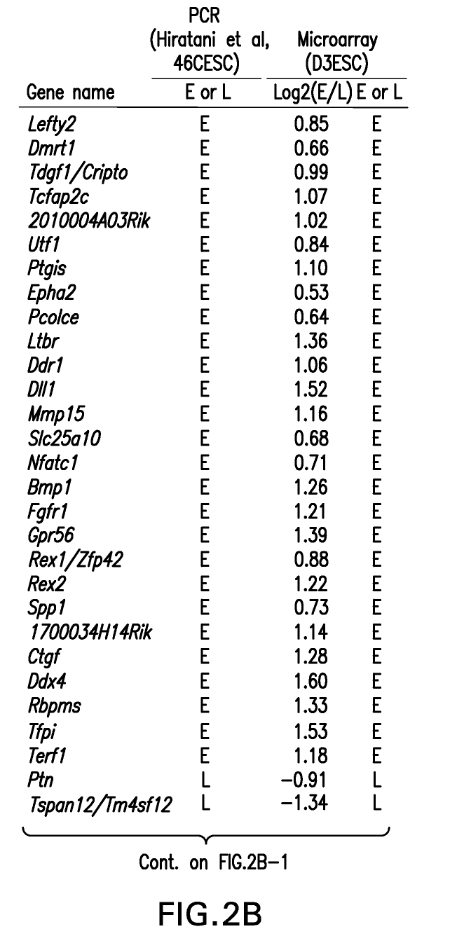

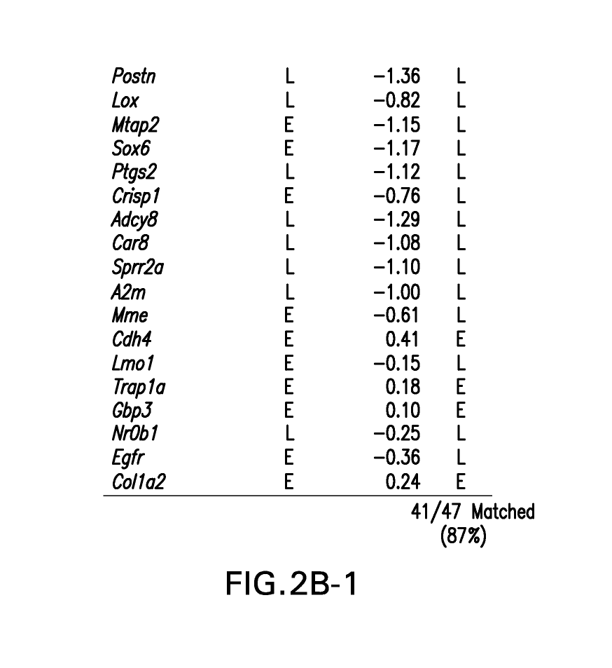

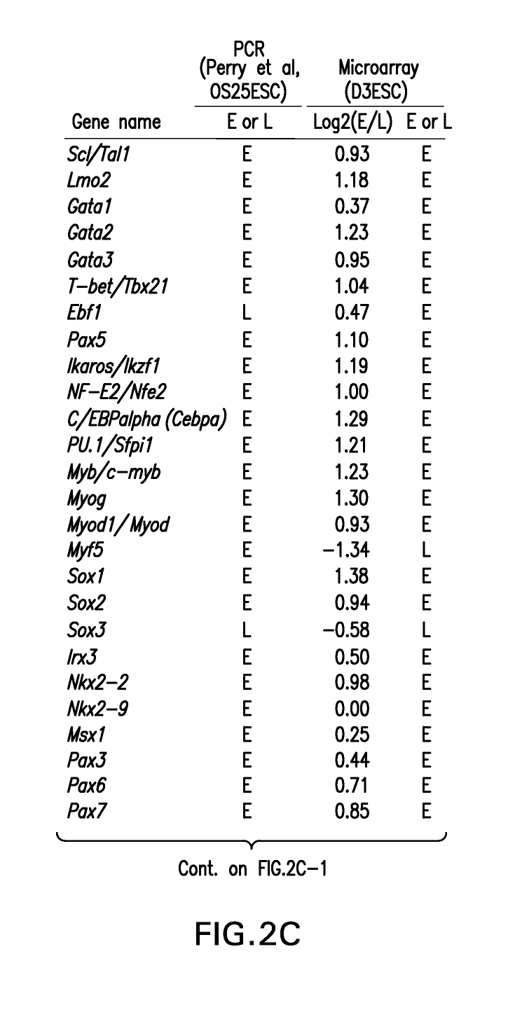

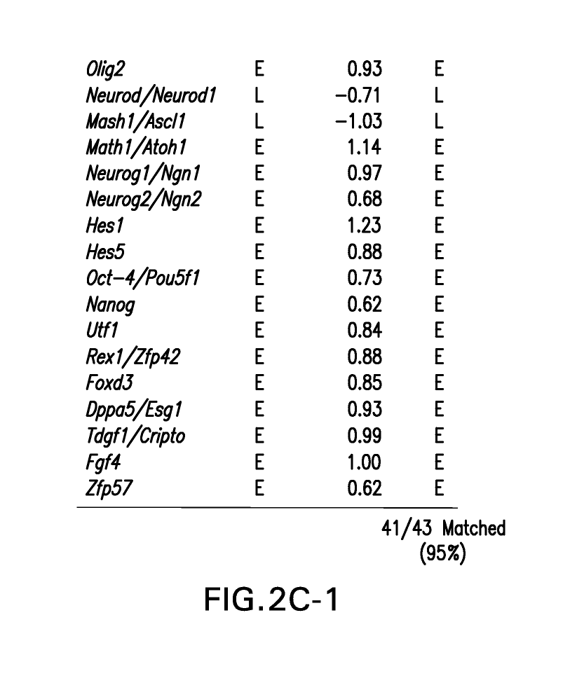

Data sets are confirmed by PCR analysis of 18 genes (100% consistent (18/18) in ESCs; 94% consistent (17/18) in NPCs) and by comparison to two previously published replication timing analyses of 90 individual genes in mESCs (91% consistent (82/90) with the PCR results of the two studies combined) (see, e.g., Hiratani et al. (2004), supra; and Perry et al. (2004), supra). See FIGS. 2A, 2B and 2C. For example, PCR experiments confirm enrichment of α-globin and β-globin DNA sequences in the expected fractions of immunoprecipitated early and late S-phase DNA samples, respectively. In addition, PCR experiments confirm the expected enrichment of mitochondrial DNA sequences in immunoprecipitated DNA samples from both early and late S-phase (not shown). It is noted that the binary classification of PCR results forces some genes that actually change replication timing to not be classified as such, as with, for example, Crispl (later shift), Cdh2, Postn and Mash1 (earlier shift). See FIG. 2A. However, even such subtle changes are detected on the microarray, as shown by the changes in replication timing ratios from ESCs to NPCs.

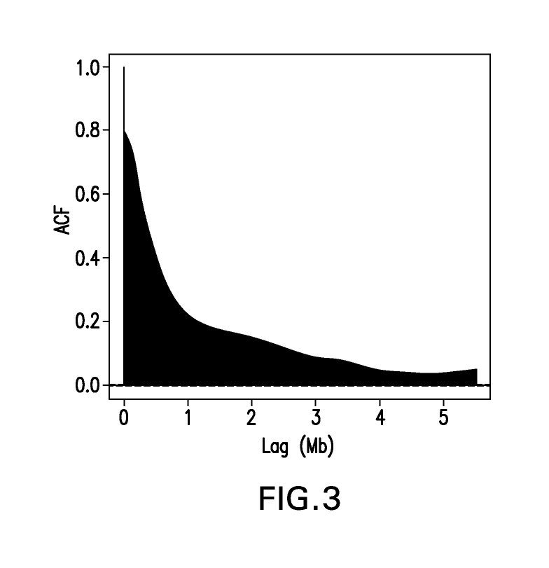

FIG. 1B shows the mean replication timing ratio for each probe plotted as a function of chromosomal coordinate for an exemplary 50 Mb segment of chromosome 1, and FIG. 1C shows a loess-smoothed curve fit for the same region. This profile reveals a surprisingly clear demarcation between regions of coordinate replication that is heretofore referred to as “replication domains.” To address whether 5.8 kb resolution is sufficient to provide a complete profile of replication domains, the same duplicate preparations of replication intermediates are hybridized to tiling microarrays (one probe every 100 bp) of chromosome 6 and 7. Despite the nearly 60-fold higher probe density, results show an almost indistinguishable smoothed profile (see FIG. 1D). This is consistent with known properties of DNA replication; a 2 hour BrdU pulse is expected to label 200-400 kb stretches of DNA (fork rate 1-2 Kb/min). See, e.g., Jackson et al., “Replicon clusters are stable units of chromosome structure: evidence that nuclear organization contributes to the efficient activation and propagation of S phase in human cells,” J. Cell Biol. 140:1285-95 (1998); Norio et al., “Progressive activation of DNA replication initiation in large domains of the immunoglobulin heavy chain locus during B cell development,” Mol Cell 20:575-87 (2005); and Takebayashi et al., “Regulation of replication at the R/G chromosomal band boundary and pericentromeric heterochromatin of mammalian cells,” Exp. Cell Res. 304:162-74 (2005), the entire contents and disclosures of which are incorporated herein by reference. Since multiple replicons across hundreds of kilobases fire synchronously (reviewed in, e.g., Gilbert et al., “Nuclear Structure and DNA Replication,” in: DePamphilis M L, Editor DNA Replication and Human Disease (Cold Spring Harbor Press, Cold Spring Harbor, N.Y.: 2006)), probes spaced 5.8 kb apart would be expected to replicate at very similar times. Indeed, high autocorrelation of replication timing is observed between neighboring probes (see FIG. 3). Hence, replication timing across the entire genome may be reliably profiled on a single oligonucleotide chip. Replication profiles for all chromosomes may be found at http://www.replicationdomain.org.

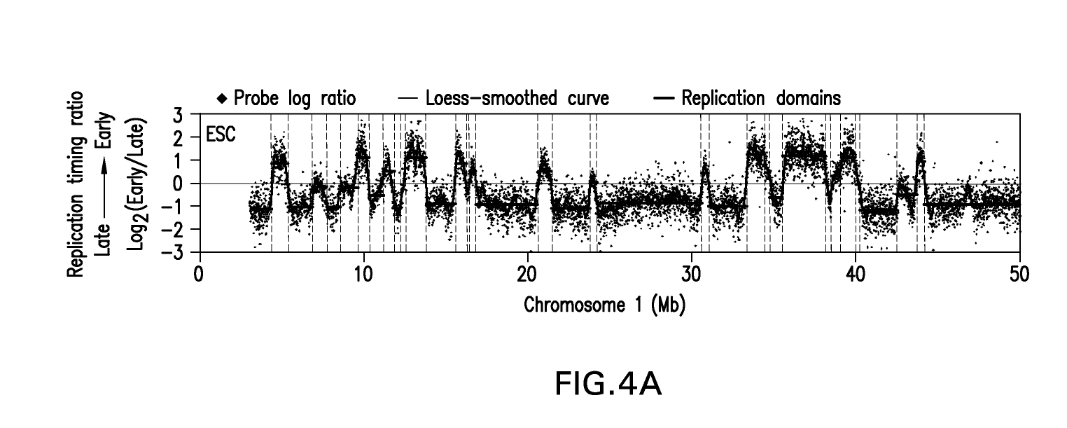

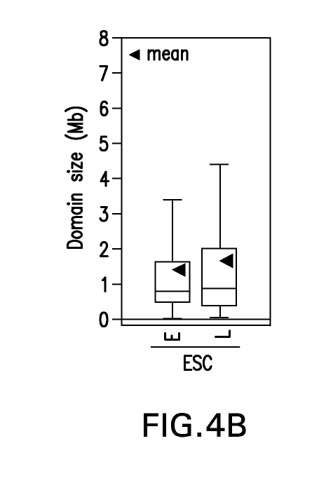

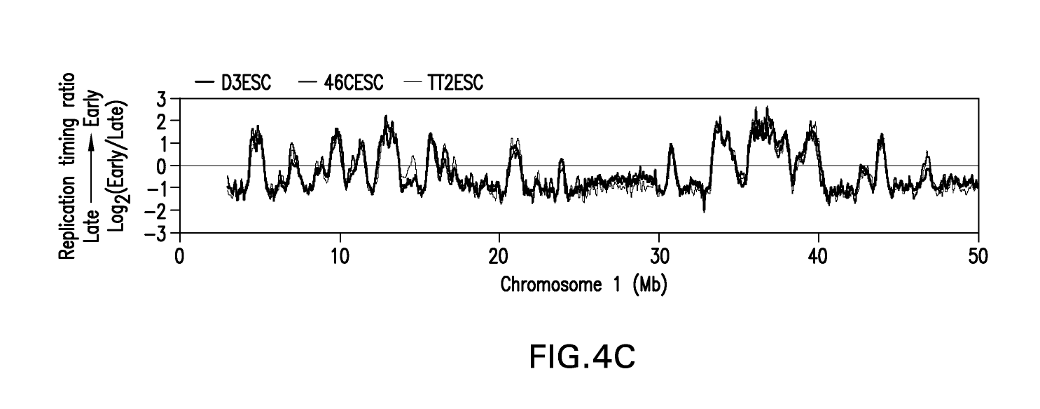

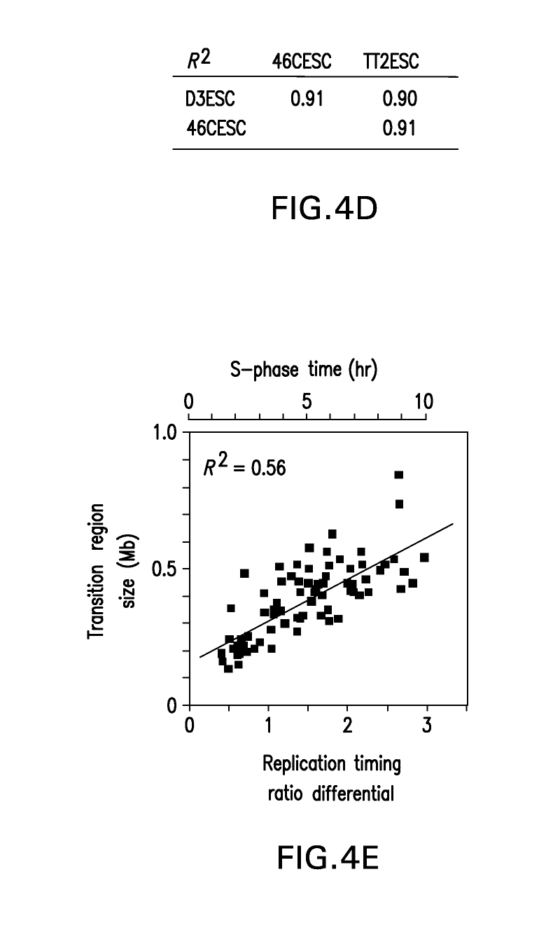

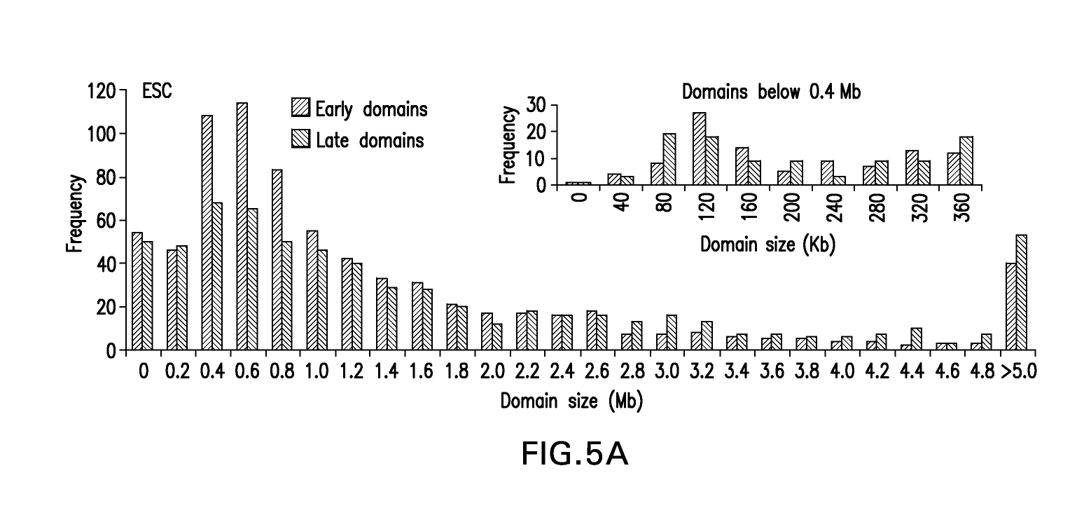

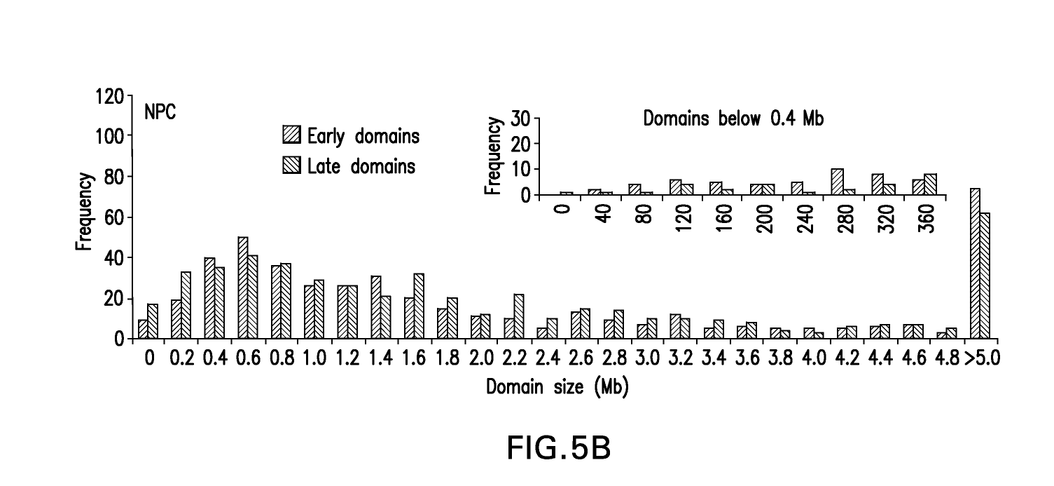

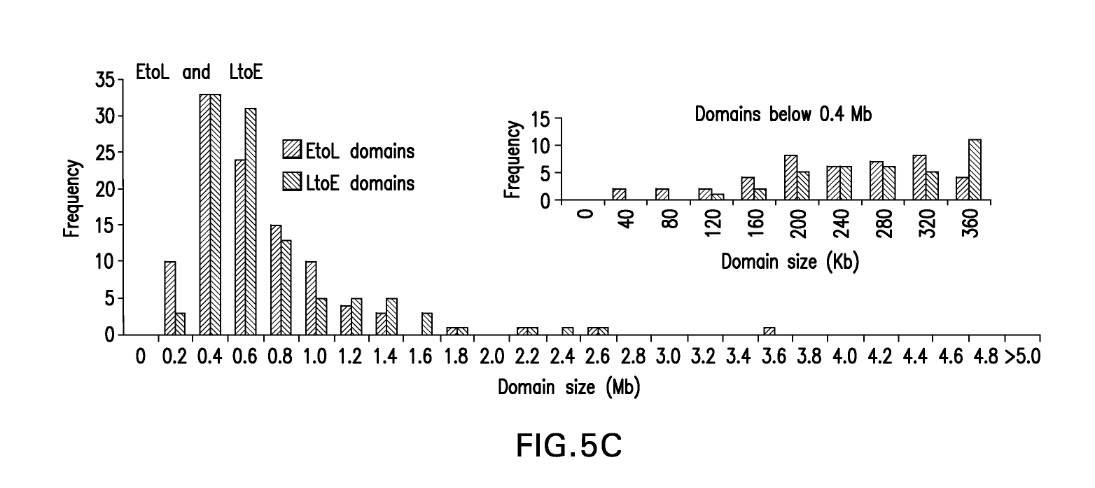

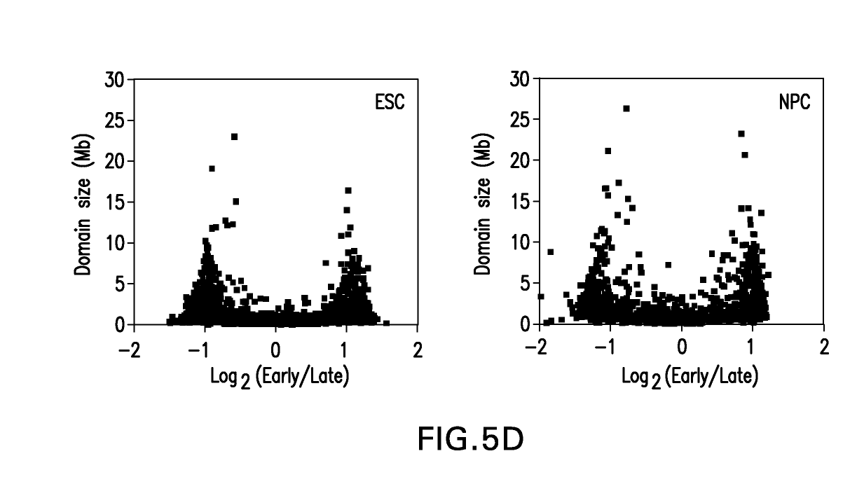

To quantify the numbers and positions of replication domains and their boundaries genome-wide, a segmentation algorithm—originally developed to identify copy number differences for comparative genomic hybridization (see, e.g., Venkatraman et al., “A faster circular binary segmentation algorithm for the analysis of array CGH data,” Bioinformatics 23:657-63 (2007), the entire contents and disclosure of which are incorporated herein by reference)—is adapted to identify regions of uniform y-axis values (i.e., replication domains), which are illustrated in FIG. 4A. This algorithm generates a data set consisting of the nucleotide map positions for the boundaries of each replication domain. Domain sizes ranged from 200 kb to 2 Mb, with some considerably larger domains (see FIGS. 4B and 5A). These domain sizes may explain why existing ENCODE replication timing data for HeLa cells (see, e.g., Birney et al., “Identification and analysis of functional elements in 1% of the human genome by the ENCODE pilot project,” Nature 447:799-816 (2007), incorporated herein by reference) do not reveal replication domains. The ENCODE regions cover 1% of the genome and consist primarily of scattered 500 kb genomic segments, which may be too small to discern replication domain level chromosome organization. Domains are found to replicate at all times during S-phase; however, domains larger than 2.5 Mb are either very early- or very late-replicating, suggesting that coordinately replicating regions larger than a certain threshold size tend to replicate at one extreme or another of S-phase (see FIG. 5D). These results are not an artifact of probe density, segmentation algorithm or synchronization method, since similar distributions are obtained at 100 bp resolution, using different segmentation parameters, and using an alternative protocol that determines replication timing by probe copy number in S-phase vs. G1-phase without fractionation of S-phase (see, e.g., Woodfine et al. (2004), supra). Similar results may also be obtained with human ESCs.

### Example 3

### Domain Structure is Conserved Between Independent mESC Lines

The results described above demonstrate that coordinately replicated regions (replication domains) constitute functional units of chromosomes whose boundaries may be molecularly defined. The fact that replication domain boundaries may be so precisely mapped in populations of cells demonstrates that their positions are highly stable from cell cycle to cell cycle. To evaluate whether these boundaries are a conserved property of chromosomes in multiple mESCs, three mESC lines from two independently established mouse inbred strains are compared. Lines D3 and 46C are both derived from the 129 mouse strain and so are nearly identical genetically, but they are separated by more than 20 years in cell culture, while TT2 was derived 15 years ago from a C57BL/6xCBA hybrid mouse and is therefore genetically polymorphic (see, e.g., Doetschman et al. (1985), supra; Yagi, et al. (1993), supra; and Ying et al. (2003), supra). Despite the disparate genetic and temporal histories of these three cell lines, their replication profiles are virtually identical (see FIGS. 4C and 4D). This demonstrates that replication domain structure is a highly conserved property of mESCs. Moreover, the recent demonstration that mESCs display considerable cell-to-cell heterogeneity in the expression of certain pluripotency-specific marker genes such as Nanog and Rex1 (see, e.g., Silva et al., “Capturing pluripotency,” Cell 132:532-36 (2008); and Toyooka et al. (2008), supra, the entire contents and disclosures of which are incorporated herein by reference) indicates that replication timing profiles are a substantially more stable and homogeneous property of ESCs than transcription profiles.

### Example 4

### Transitions Between Replication Domains are Consistent with Large Origin-Less Regions of Unidirectional Replication

These results demonstrate that replication timing is regulated at the level of large domains that replicate coordinately, separated by noticeable transition regions. These transition regions resemble the origin-less transition between early- and late-replicating segments of the immunoglobulin IgH locus (see, e.g., Norio et al. (2005), supra), where a unidirectional replication fork travels 450 kb. If such transition regions throughout the genome represent unidirectional forks, which in mammalian cells travel at the rate of 1-2 kb per minute (see, e.g., Jackson et al. (1998), supra; Norio et al. (2005), supra; and Takebayashi et al. (2005), supra), then it is expected that there is a linear relationship between the time and distance between each replication domain. The transitions between 25 such replication domain boundaries each from chromosomes 2, 11 and 16 (total of 75) are examined. For each of these boundaries, both the replication timing ratio difference and the kilobase distance from the distal “ledge” of one domain to the proximal “ledge” of the next (see Example 1 above) is scored and plotted relative to each other (see FIG. 4E). Indeed, there is a strong positive linear correlation between the distance and time between replication domains. Since the replication timing ratios for the entire data set ranged from approximately −1.5 to +1.5, which represents an approximately 10 hour S-phase, it is estimated that a unidirectional fork may need to travel 1.4 kb/min on average (ranging from 0.8 to 3.5 kb/minute), which is consistent with mammalian replication fork speeds. Given this linear relationship and the uniform slope of each transition region, this data strongly suggests that the boundaries between replication domains define origin-less regions of unidirectional replication throughout the genome. Regions in which individual replication forks need to travel long distances may delineate genomic regions that are particularly vulnerable to DNA damage since stalled forks can form reactive recombination intermediates that lead to chromosome rearrangements. See, e.g., Labib et al., “Replication fork barriers: pausing for a break or stalling for time?” EMBO Rep. 8:346-353 (2007), the entire contents and disclosure of which are incorporated herein by reference. In fact, a survey of a few such boundaries correlates them with genes that are frequently disrupted in cancer. See, e.g., Watanabe et al., “Amplicons on human chromosome 11q are located in the early/late-switch regions of replication timing,” Genomics 84:796-805 (2004); and Watanabe et al., “Chromosome-wide assessment of replication timing for human chromosomes 11q and 21q: disease related genes in timing-switch regions,” Hum. Mol. Genet. 11:13-21 (2002), the entire contents and disclosures of which are incorporated herein by reference.

### Example 5

### Replication Domain Profiles Change in a Characteristic Way During Neural Differentiation

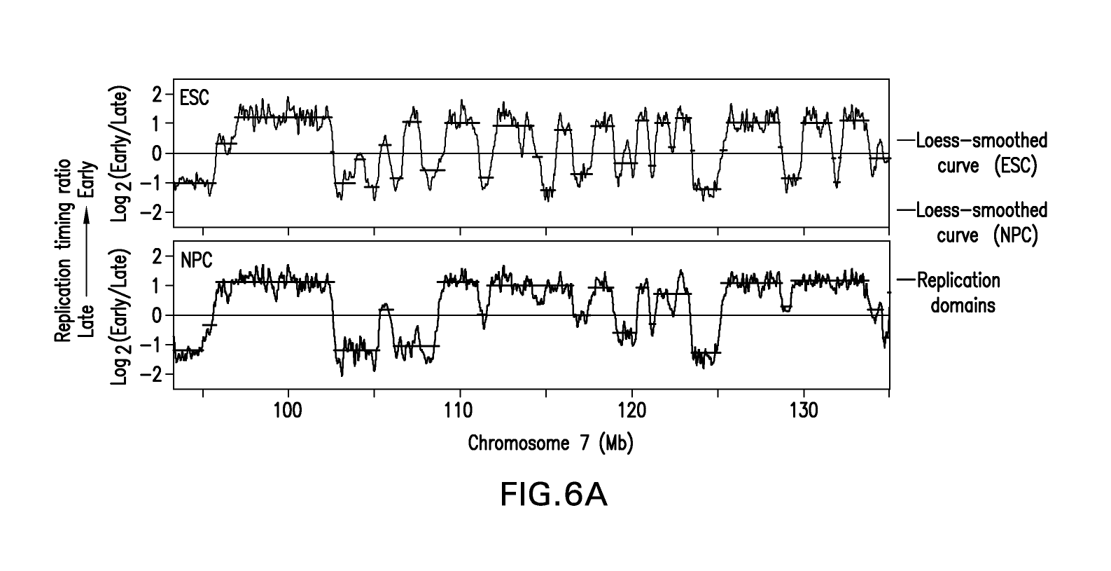

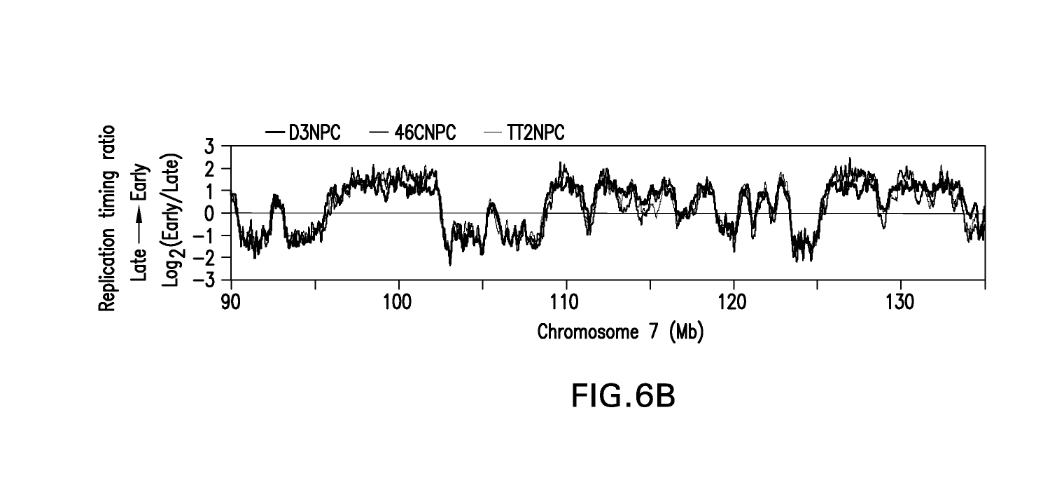

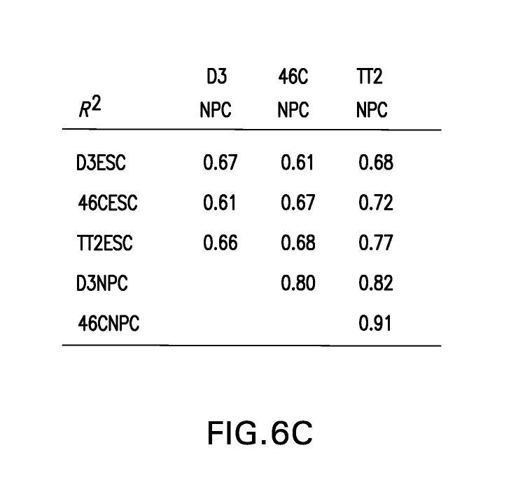

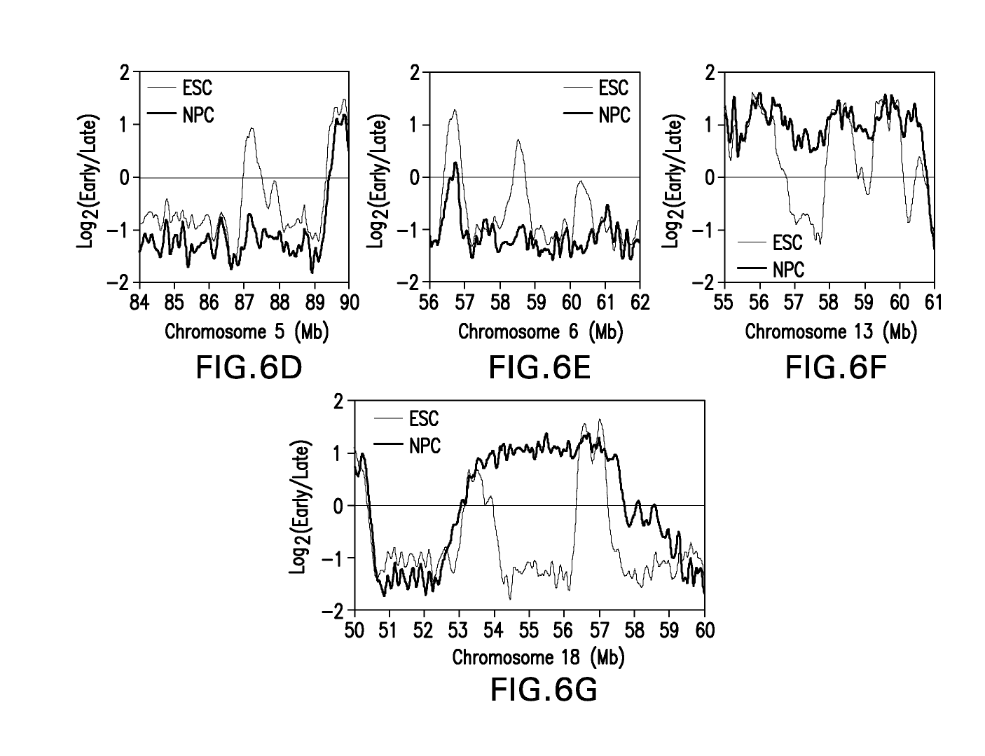

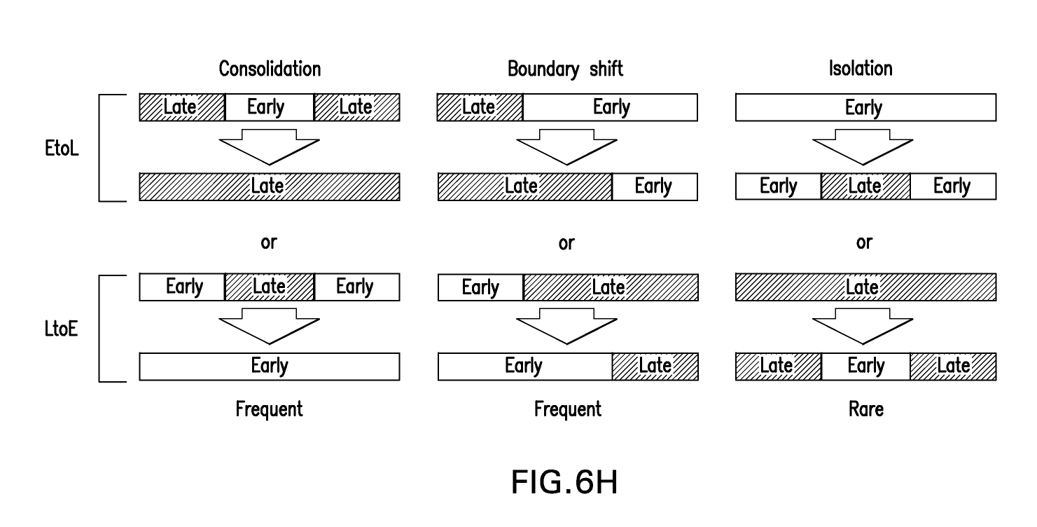

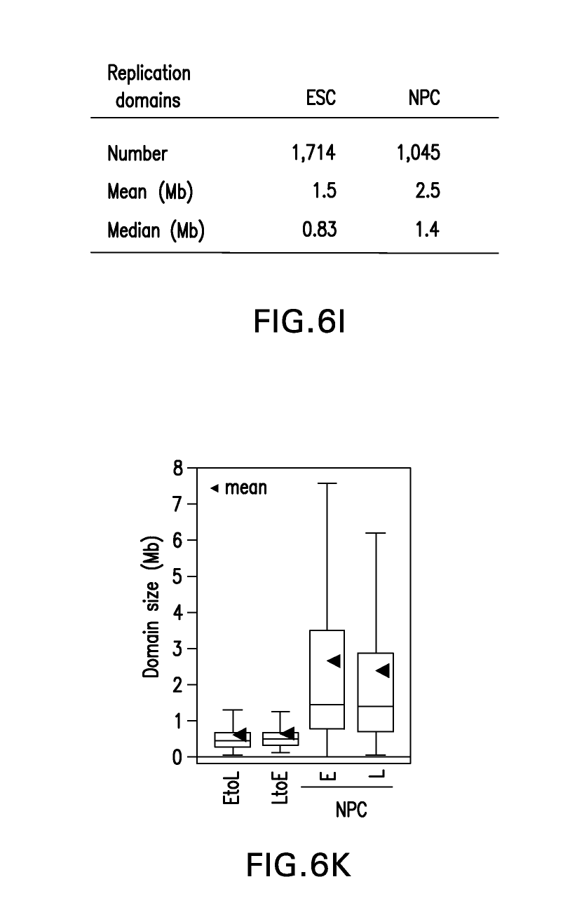

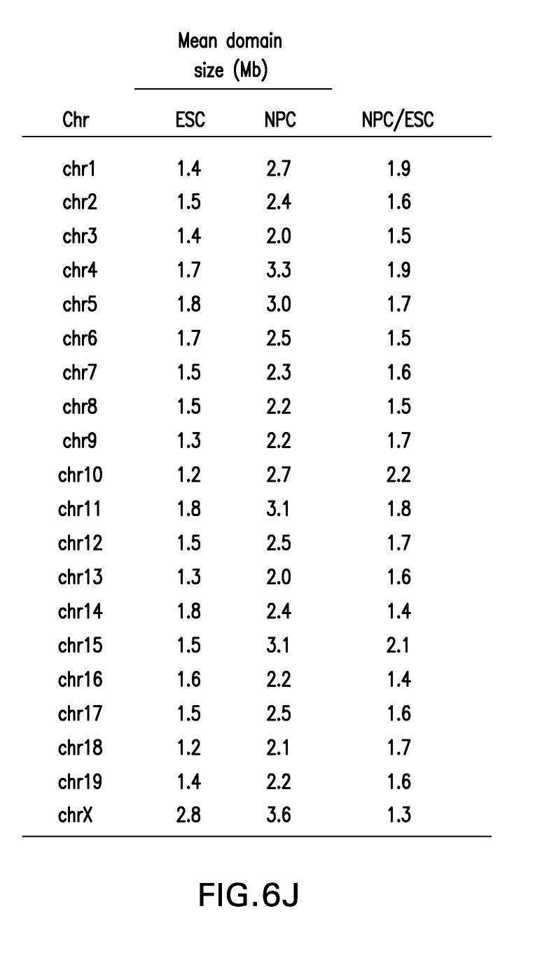

If replication timing is regulated during development but is stable within a particular cell type, then replication domain maps may represent cell-type specific “epigenetic signatures.” The extent to which replication timing may differ in different cell types is currently not clear, and some studies have concluded that there are few if any differences between cell types. See, e.g., White et al., “DNA replication timing analysis of human chromosome 22 at high resolution and different developmental states,” PNAS USA 101:17771-76 (2004); Grasser et al., “Replication timing-correlated spatial chromatin arrangements in cancer and in primate interphase nuclei,” J. Cell Sci. 121(11):1876-86 (2008); and Costantini et al., “Replication timing, chromosomal bands, and isochores,” PNAS USA 105:3433-37 (2008), the entire contents and disclosures of which are incorporated herein by reference. To directly address the extent to which replication timing changes occur during the course of differentiation, replication timing profiles are generated following differentiation of ESCs to neural precursors (NPCs) using two different neural differentiation protocols: one that uses a conditioned medium to differentiate D3 ESCs as embryoid bodies (see, e.g., Rathjen et al. (2003), supra), and one that uses a chemically defined medium to differentiate 46C and TT2 ESCs in adherent monolayers (see, e.g., Ying et al. (2003), supra). Results reveal substantial changes in the replication profile (see FIG. 6A). Even after excluding regional differences of less than 9 consecutive probes (52 kb), 20% of probes show a log ratio change of more than 0.5, as compared to 3% of probes showing differences either between ESC lines or between neural differentiation protocols. Importantly, replication profiles for NPCs are similar regardless of the ESC line or neural differentiation protocol employed (see FIGS. 6B and 6C) and despite differences in the levels of certain gene expression markers between the differentiated cell populations produced by these two protocols (not shown). This demonstrates that the observed changes are characteristic of NPCs rather than having been elicited by conditions associated with a particular neural differentiation protocol (albeit that there are more differences between NPCs than between ESCs). It is concluded that specific changes in replication timing take place during the course of neural differentiation to generate a novel replication profile that is characteristic of NPCs, suggesting that replication timing profiles are stable within particular cell lineages but change significantly in response to major cell fate decisions. Low R² values for pair-wise comparisons of ESCs and NPCs confirm that substantial changes in replication timing occur upon differentiation (see FIG. 6C).

### Example 6

### Global Re-Organization of Replication Domains During Differentiation

Unexpectedly, it is found that replication timing changes induced by differentiation resulted in a dramatic change in the number and sizes of replication domains (see FIG. 6A). Small domains that were replicated at different times in ESCs frequently merge to become one larger coordinately replicated domain (see FIGS. 6D, 6E, 6F and 6G). This reorganization is referred to as domain “consolidation” (see FIG. 6H). Also frequent are events in which the positions of boundaries shifted (referred to as a “boundary shift”). Boundary shifts occur equally through the encroachment of late domains into early domains and vice versa, so they do not affect the overall size or number of replication domains. In rare cases, the emergence of new smaller domains from within a larger domain (referred to as “isolation”) is observed (see FIG. 6H). Visual inspection of 46 domains that changed replication timing [22 LtoE (Late in ESCs to Early in NPCs) and 24 EtoL (Early-to-Late)] confirms that “consolidation” and “boundary shift” events are equally frequent (43% and 50%, respectively), while “isolation” events are rare (7%). Domain consolidation is significant with a 40% reduction in the number of domains and a corresponding increase in the size of domains (see FIG. 6I and FIGS. 5A and 5B) in NPCs compared to ESCs. Importantly, consolidation is widespread, occurring on all chromosomes (see FIG. 6J). Interestingly, domains that switched replication timing (EtoL and LtoE) are smaller and more uniform in size (400-800 kb) than the distribution of domains as a whole (see FIG. 6K and FIG. 5C). EtoL and LtoE domains show smaller and tighter distribution than domains in general from NPCs (see FIG. 6K) or ESCs (see FIG. 4B). This size range (400-800 kb) is very close to cytogenetic estimates of the amount of DNA within individual replication foci. See, e.g., Ma et al., “Spatial and temporal dynamics of DNA replication sites in mammalian cells,” J. Cell Biol. 143:1415-25 (1998), the entire contents and disclosure of which are incorporated herein by reference. Together, this data suggests that replication domains are made up of smaller units that may correspond to replication foci or “replicon clusters” and that replication timing changes may occur at the level of these smaller units.

### Example 7

### Consolidation Aligns Replication Domains to Isochore GC Content

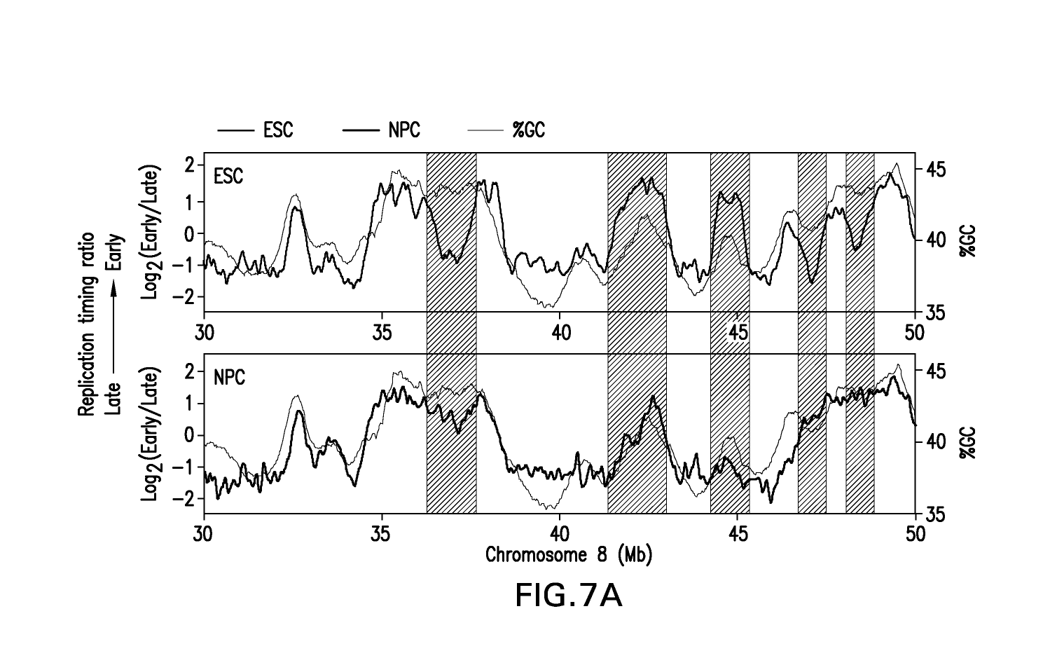

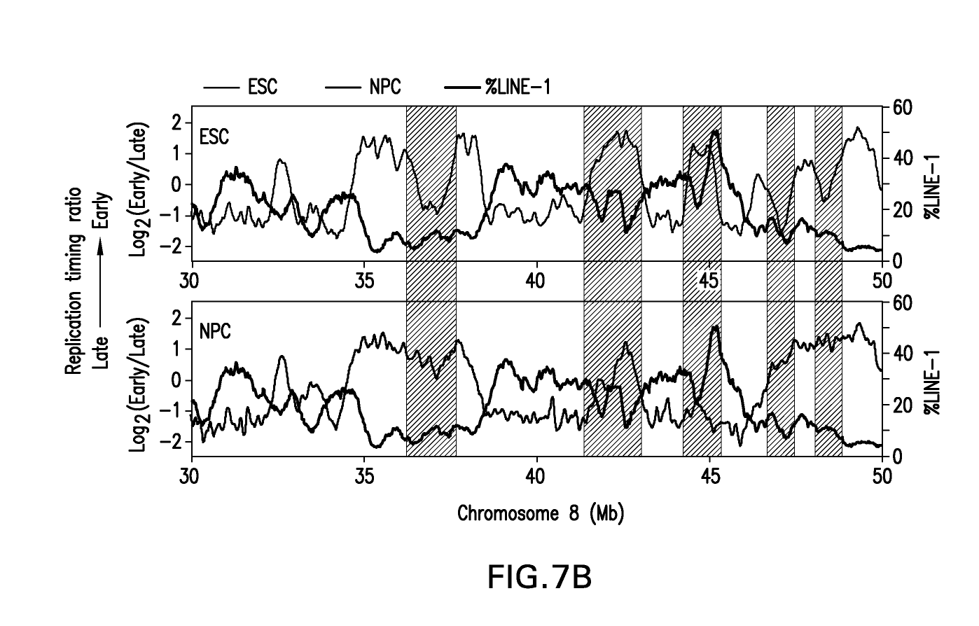

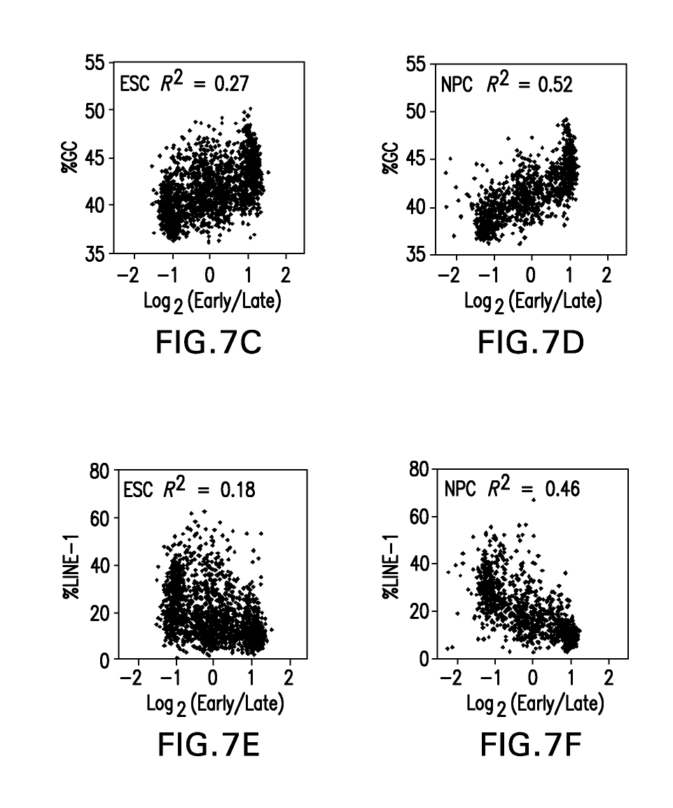

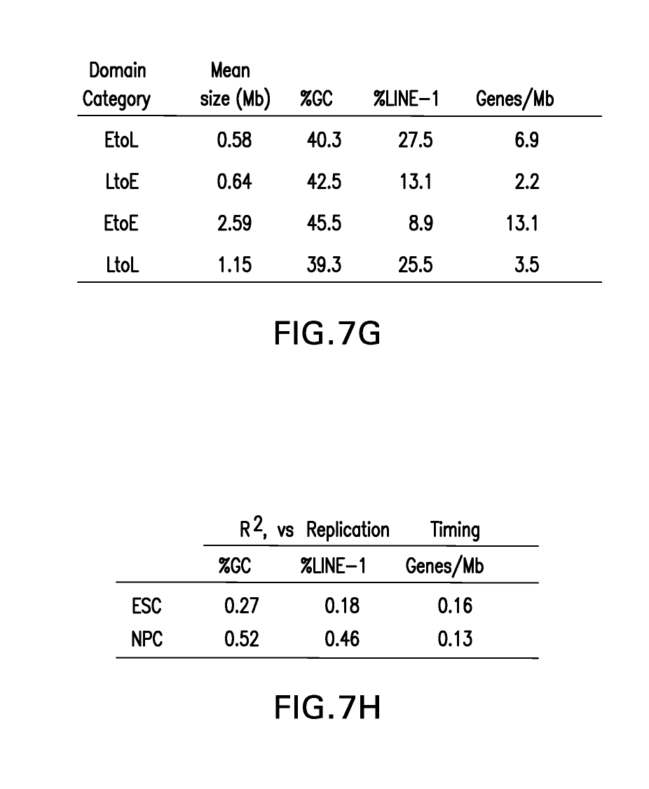

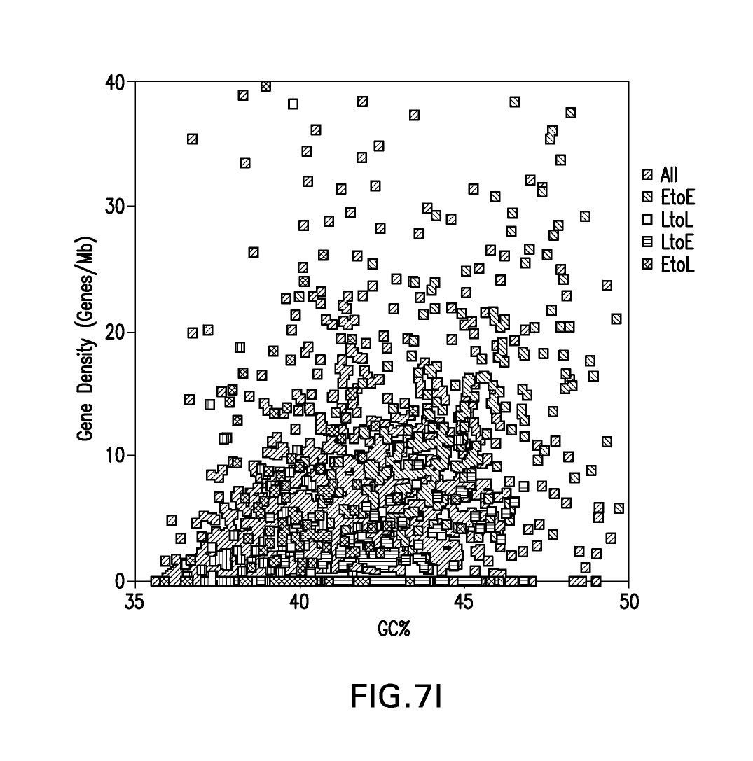

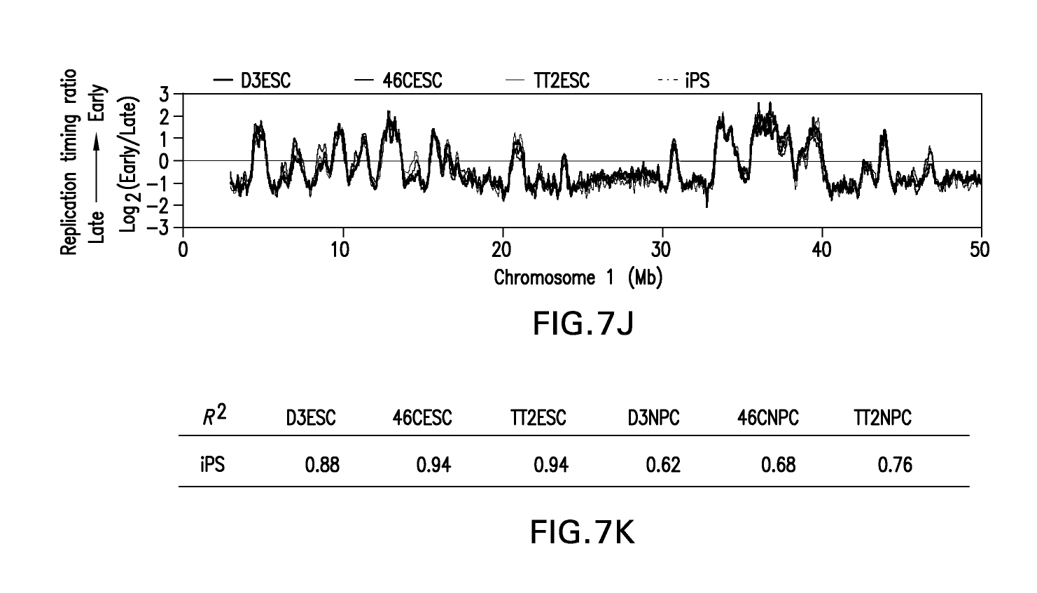

Mammalian chromosomes are organized into alternating AT- and GC-rich stretches of sequences called isochores, which are rich and poor in LINE-1 transposable elements, respectively. See, e.g., Bernardi G, “Isochores and the evolutionary genomics of vertebrates,” Gene 241:3-17 (2000). Prior studies evaluating replication timing of various segments of the human genome have reported a strong positive correlation between GC content and early replication. See, e.g., Woodfine et al. (2004), supra; Schmegner et al., “Isochores and replication time zones: a perfect match,” Cytogenet. Genome Res. 116:167-72 (2007); Costantini et al. (2008), supra; and Watanabe et al. (2002), supra, the entire contents and disclosures of which are incorporated herein by reference. Such a correlation is also detected herein (see FIG. 7), but the degree of this correlation is not static. In fact, the correlation between replication domains and isochores is not impressively strong in mESCs but improves substantially during differentiation. This is evident by visual comparison of replication profiles to GC and LINE-1 density in ESCs vs. NPCs (see FIGS. 7A and 7B). To confirm this alignment genome wide, the GC or LINE-1 content of the DNA sequences within the boundaries of each replication domain is plotted vs. the replication time of each domain. For both sequence properties, the correlation becomes much stronger in NPCs than in ESCs (see FIGS. 7C, 7D, 7E and 7F). Moreover, domains that change replication timing usually acquire a temporal profile in line with their isochore sequence composition. In other words, EtoL (Early-to-Late) domains are low in GC and high in LINE-1 density and resemble LtoL (Late-to-Late) domains, while LtoE (Late-to-Early) domains have an intermediate GC content and a relatively low LINE-1 density and resemble EtoE (Early-to-Early) domains (see FIG. 7G).

### Example 8

### Domains that Change Replication Timing have Unusual Sequence Composition

GC vs. AT rich isochores are also known to be gene-rich vs. gene-poor. See, e.g., Costantini et al., “An isochore map of human chromosomes,” Genome Res 16:536-541 (2006), the entire contents and disclosure of which are incorporated herein by reference. As expected, gene density within replication domains largely follows the rules of isochore replication timing: in both ESCs and NPCs, domains that have a high density of genes are early replicating and, for the most part, GC-rich. In fact, 75% of genes replicate early in both cell types (i.e., positive replication timing ratios) and, as expected, EtoE and LtoL domains are GC-rich/gene-rich and GC-poor/gene-poor, respectively (see FIG. 7G). Surprisingly, although the alignment to isochore GC/LINE-1 density increases during differentiation, the correlation between gene density and early replication does not (see FIG. 7H). This is due to the fact that LtoE and EtoL domains exhibit the unusual properties of being GC-rich/gene-poor and GC-poor/gene-rich, respectively (see FIGS. 7G and 7I). Thus, GC/LINE-1 density and gene density are properties of isochores that may be uncoupled. Moreover, these results demonstrate that replication timing is not a simple reflection of either local gene density or isochore GC content, as has been proposed by others. See, e.g., Grasser et al. (2008), supra; and Costantini et al. (2008), supra. Without being bound by any theory, it is believed that segments that change replication timing have an unusual combination of GC content and gene density, providing a potential means to predict chromosome domains that change replication timing.

### Example 9

### Replication Domain Structure of Induced Pluripotent Stem (iPS) Cells Matches that of ESCs

The results described above suggest that replication timing profiles in ESCs may provide a unique signature for identification of the pluripotent state. A prediction of this hypothesis is that induced pluripotent stem (iPS) cells, in which an adult differentiated cell has been reverted back to the pluripotent state, should share replication profiles with ESCs. To address this prediction, replication profiles for iPS cells (see, e.g., Takahashi et al., “Induction of pluripotent stem cells from mouse embryonic and adult fibroblast cultures by defined factors.” Cell 126:663-76 (2006), the entire contents and disclosure of which are incorporated herein by reference, are generated, which are re-programmed from tail-tip fibroblasts derived from a 129xBL-6 hybrid strain of mice as described in, for example, Hanna et al., “Treatment of sickle cell anemia mouse model with iPS cells generated from autologous skin,” Science 318:1920-23 (2007), the entire contents and disclosure of which are incorporated herein by reference. Indeed, iPS cells show a profile that is virtually indistinguishable from other ESCs (see FIGS. 7J and 7K). These results provide additional evidence that iPS cells are indeed very similar to ESCs and that the property of smaller replication domains that disrupt the alignment of replication timing to isochores is a novel characteristic of the pluripotent state. Moreover, these results suggest a means to profile or identify cell types, including pluripotent cell types, based on replication domain organization, which appears to be considerably more stable than transcription profiles.

### Example 10

### Replication Timing and Transcription Changes During Differentiation

### Correlation Between Early Replication and Transcription in ESCs and NPCs

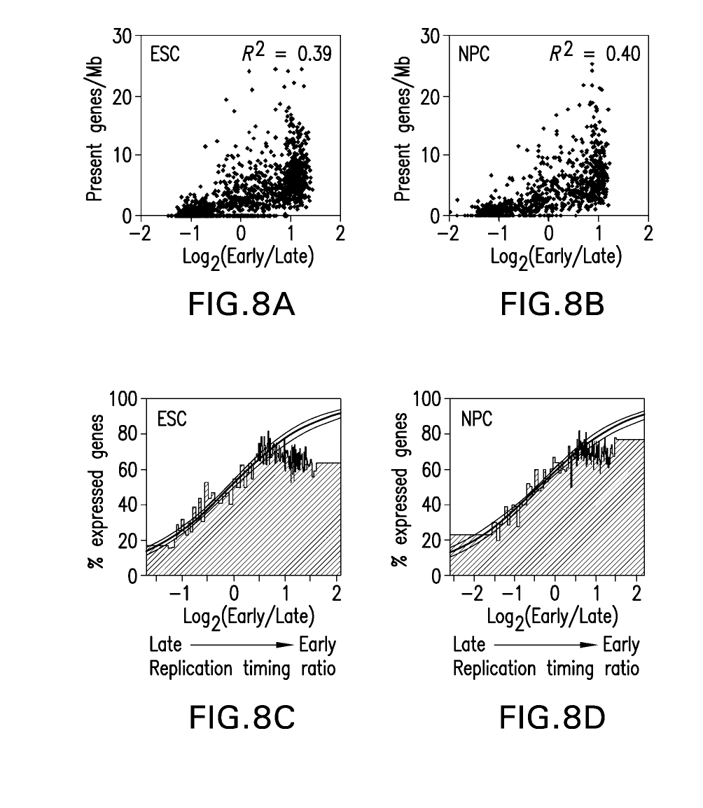

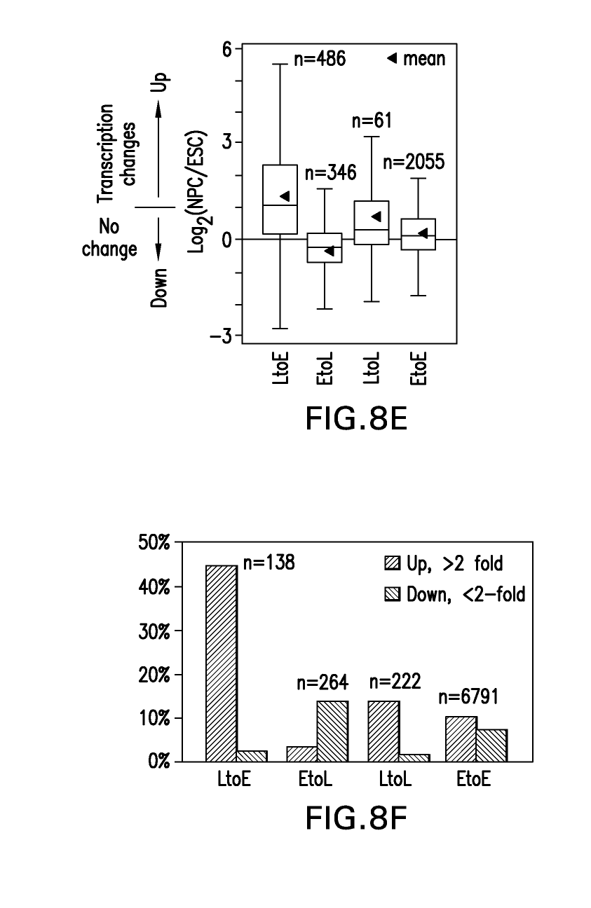

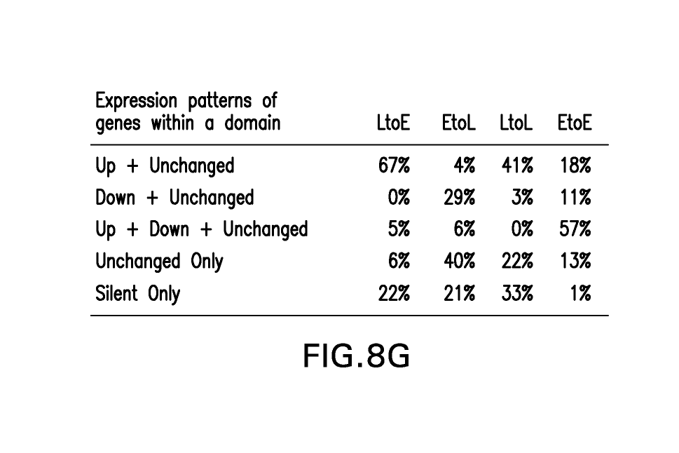

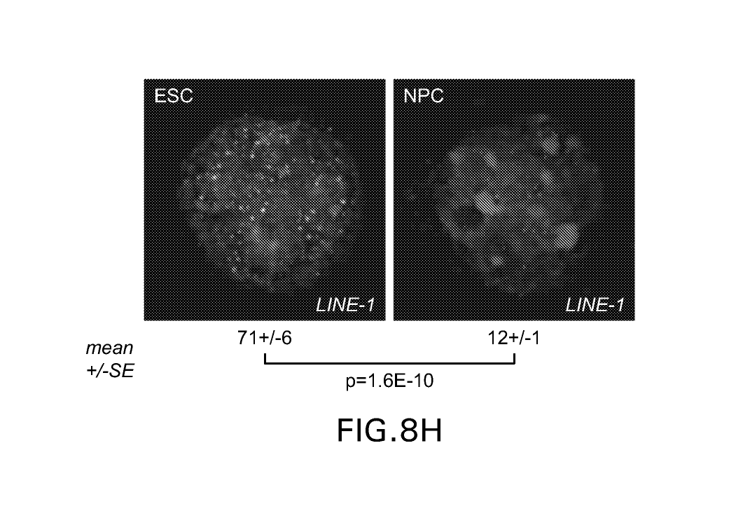

Genes that are transcribed are generally early replicating, while genes that are late-replicating are almost always silent. However, exceptions to this rule have been described. See, e.g., Gilbert DM, “Replication timing and transcriptional control: beyond cause and effect,” Curr. Opin. Cell Biol. 14:377-83 (2002); Goren et al., “Replicating by the clock,” Nat. Rev. Mol. Cell Biol. 4:25-32 (2003); and Schwaiger et al., “A question of timing: emerging links between transcription and replication,” Curr. Opin. Genet. Dev. 16:177-83 (2006). No study has comprehensively examined the changes in gene expression as they relate to changes in replication timing. To address this issue, the steady-state levels of annotated gene transcripts are analyzed before and after differentiation to NPCs using Affymetrix GeneChips. Regardless of whether levels, density or number of active genes are examined, either at the level of domains (see FIGS. 8A and 8B) or individual genes (see FIGS. 8C and 8D), both differentiation states show a strong and similar positive correlation between early replication and transcription. Logistic regression (inner line) and 95% confidence intervals (outer lines) reveal a strong correlation in both ESCs (see FIG. 8C) and NPCs (see FIG. 8D). By the Likelihood Ratio test (a goodness-of-fit test), the fitted model is significantly different (p<2×10-16 for both ESCs and NPCs) from that of a null hypothesis in which replication timing has no effect on transcription.

Consistent with previous findings across a portion of the Drosophila genome (see, e.g., MacAlpine et al., “Coordination of replication and transcription along a Drosophila chromosome,” Genes Dev. 18:3094-3105 (2004)), this positive correlation is greater when integrated over large regions (approximately 600 kb for ESCs and NPCs vs. 180 kb in Drosophila). The maintenance of this statistical relationship during differentiation may be accounted for by the directionality of transcriptional changes within each domain (see FIGS. 8E and 8F). At the level of individual genes, LtoE genes are mostly upregulated, while EtoL genes showed a weak tendency to be downregulated. At the level of domains, amongst those domains that contain at least one RefS eq gene (NCBI annotation at http://www.ncbi.nlm.nih.gov/RefSeq/), the majority of LtoE domains contain only upregulated genes, while EtoL domains contain mostly downregulated or unchanged genes (see FIG. 8G).

However, there are many exceptional genes, including classes of genes that are upregulated within EtoL or LtoL domains. In fact, a weak association of gene activation is detected within LtoL domains (see FIGS. 8E, 8F and 8G) that leads to a higher probability of very late genes being expressed after differentiation (see FIG. 8C vs. FIG. 8D). Moreover, these results demonstrate that there is little or no relationship between replication timing and the probability of transcription for genes replicated throughout nearly the entire first half of S-phase (see FIGS. 8C and 8D). Genes with >0.5 replication timing ratios have an equal probability of transcription, while those with negative replication timing values have a very strong correlation between their replication time and their probability of being expressed. It should be noted that these analyses are limited by the fact that non-coding and transposon transcription is not taken into account and is difficult to accurately assess. See, e.g., Efroni et al., “Global transcription in pluripotent embryonic stem cells,” Cell Stem Cell 2:437-47 (2008). In fact, it is found that LINE-1 transposons are expressed in mESCs, as recently shown for hESCs (see, e.g., Garcia-Perez et al., “LINE-1 retrotransposition in human embryonic stem cells,” Hum. Mol. Genet. 16:1569-77 (2007)), and that these active LINE-1 elements are then repressed during the course of differentiation (see FIG. 8H), consistent with a recent report (see, e.g., Efroni et al. (2008), supra). Since EtoL domains are exceptionally enriched for LINE-1 elements (see FIG. 8G), it is possible that LINE-1 silencing takes place within the EtoL domains, something that is currently impossible to verify since the elements are so highly repetitive and widespread. In short, while there is a general trend for replication timing and transcription to change coordinately, given the number of exceptional examples, it is highly unlikely that there is a direct relationship between replication timing and transcription.

Replication Timing Correlates with Active, but not Repressive, Histone Marks

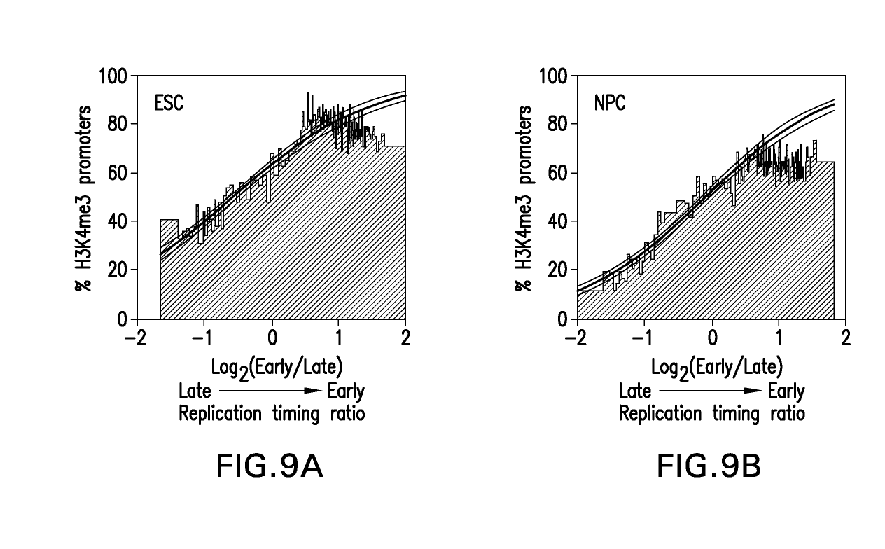

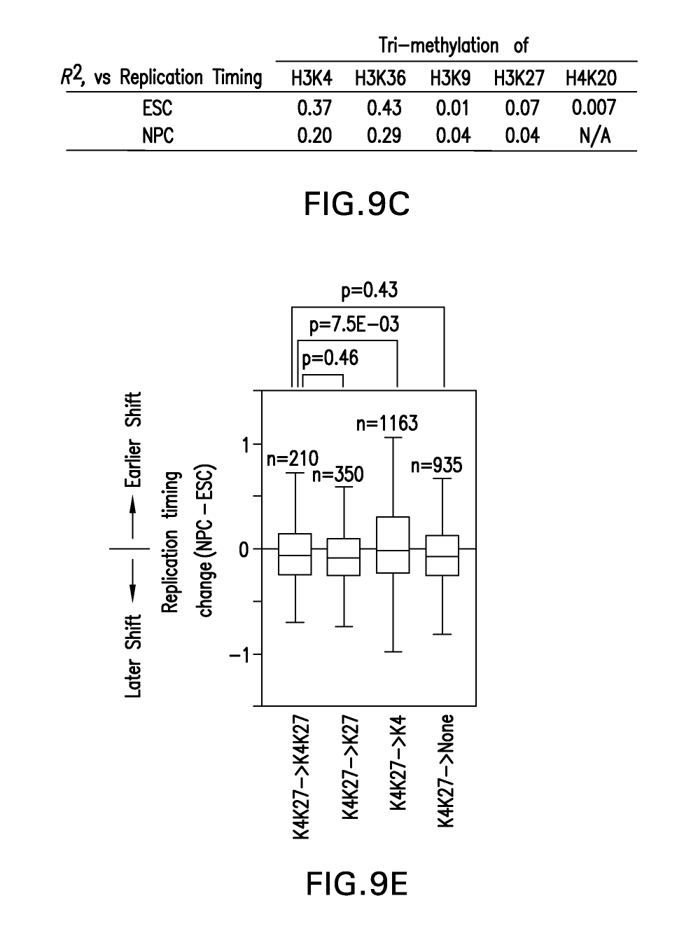

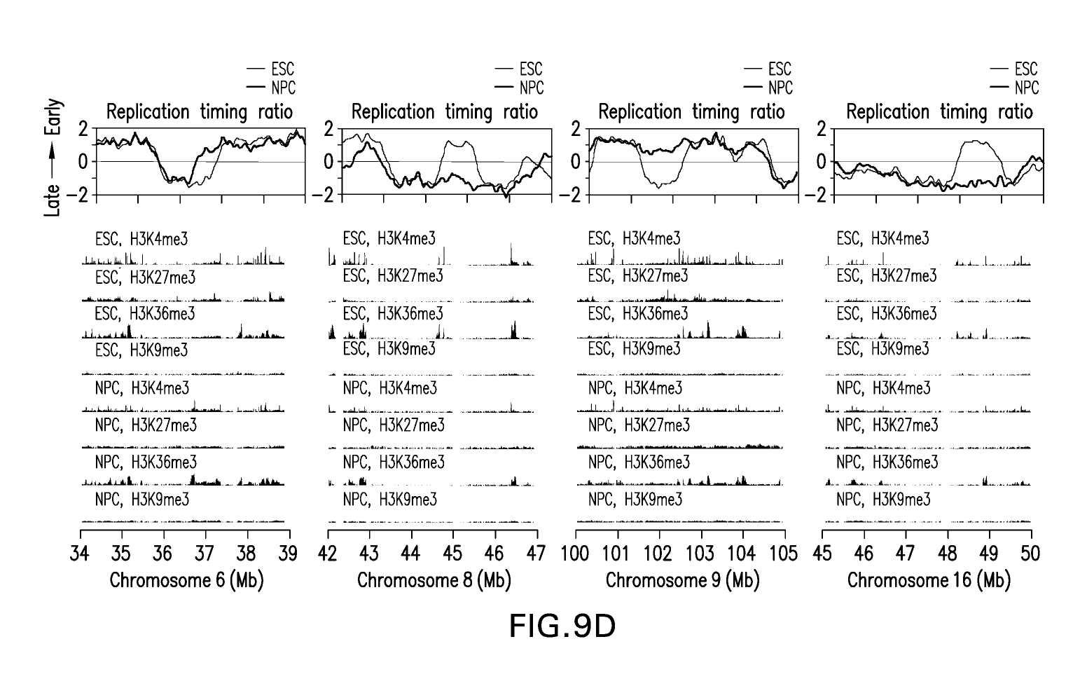

The relationship between replication timing and other epigenetic marks that have been analyzed in mESCs and NPCs (see, e.g., Mikkelsen et al., “Genome-wide maps of chromatin state in pluripotent and lineage-committed cells,” Nature 448:553-60 (2007), the entire contents and disclosure of which are incorporated herein by reference) is also examined. A strong positive correlation is found, resembling the correlation to transcription, between early replication and both lysine 4 tri-methylation of histone H3 (H3K4me3) near promoters and H3K36me3 throughout the bodies of genes. This correlation is observed both at the level of individual genes (see FIGS. 9A and 9B) and when the density of these marks is integrated within the boundaries of each replication domain (see FIG. 9C). Similar to transcription, a positive correlation is maintained during differentiation. Logistic regression (inner line) and 95% confidence intervals (outer lines) reveal a strong correlation in both ESCs (see FIG. 9A) and NPCs (see FIG. 9B) (p<2×10-16 by the Likelihood Ratio test). This may be expected due to the association of these chromatin marks with transcription. See, e.g., Li et al., “The role of chromatin during transcription,” Cell 128:707-19 (2007). However, there is a significant decrease in the positive correlation to these marks during differentiation (see FIG. 9C), as well as the overall number of H3K4me3 promoters (see FIGS. 9A and 9B), which is consistent with the finding that there is more overall coding and non-coding transcription in ESCs vs. NPCs (see, e.g., Efroni et al. (2008), supra). In contrast, there is no significant relationship between late replication and the repressive marks H3K27me3, H3K9me3 or H4K20me3 (see FIG. 9C). This finding is also evident from visual inspection of representative genomic regions (see FIG. 9D). Strikingly, a large fraction of genes that change replication timing during differentiation do not contain any of these marks at their promoters, which is also true for genes that remained late-replicating in both differentiation states. It is concluded that replication timing correlates with annotated chromatin marks that reflect active transcription but not repression.

This finding contradicts a report that found a strong correlation between late replication and H3K27me3 in HeLa cells for the 1% of the genome covered by ENCODE. See, e.g., Thurman et al., “Identification of higher-order functional domains in the human ENCODE regions,” Genome Res 17:917-27 (2007). However, the conclusions described herein are supported by several other observations. First, 87% of promoters marked by H3K27me3 in ESCs are early replicating. Second, disruption of the Eed gene, a subunit of the Polycomb complex PRC2, eliminates H3K27me3 in ESCs but does not affect replication timing of several tested genes. See, e.g., Jorgensen et al., “The impact of chromatin modifiers on the timing of locus replication in mouse embryonic stem cells,” Genome Biol. 8:R169 (2007), the entire contents and disclosure of which are incorporated herein by reference. Third, LINE-1 elements, which are highly enriched in late-replicating DNA, are not enriched for either H3K27me3 or H3K9me3 in ESCs. See, e.g., Martens et al., “The profile of repeat-associated histone lysine methylation states in the mouse epigenome,” EMBO J. 24:800-12 (2005), the entire contents and disclosure of which are incorporated herein by reference. Differences in the findings described herein could be due to the small fraction of the genome queried by ENCODE regions or to biological differences between ESCs vs. HeLa cells.

### Replication Timing Changes are Unrelated to the Resolution of “Bivalency”

Approximately 2,500 silent, developmentally regulated promoters in ESCs are characterized by a “bivalent” state co-occupied by active (H3K4me3) and repressive (H3K27me3) histone modifications. See, e.g., Mikkelsen et al., “Genome-wide maps of chromatin state in pluripotent and lineage-committed cells,” Nature 448:553-60 (2007); Azuara et al., “Chromatin signatures of pluripotent cell lines,” Nat. Cell Biol. 8:532-38 (2006); and Bernstein et al., “A bivalent chromatin structure marks key developmental genes in embryonic stem cells,” Cell 125:315-26 (2006), the entire contents and disclosures of which are incorporated herein by reference. Many (not all) of these promoters resolve to harbor only one of the two modifications upon differentiation, with activated genes harboring H3K4me3, while those remaining silent harbor H3K27me3. To determine whether replication timing changes reflect the resolution of bivalency, the list of “bivalent” genes in ESCs is surveyed. The majority of “bivalent” genes replicated in the first half of S-phase in both states (not shown), and there is no obvious relationship between changes in these modifications and replication timing changes (see FIG. 9E), demonstrating that resolution of bivalency is not related to replication timing changes observed upon differentiation.

### High and Low CpG Density Promoters are Differentially Influenced by Late Replication

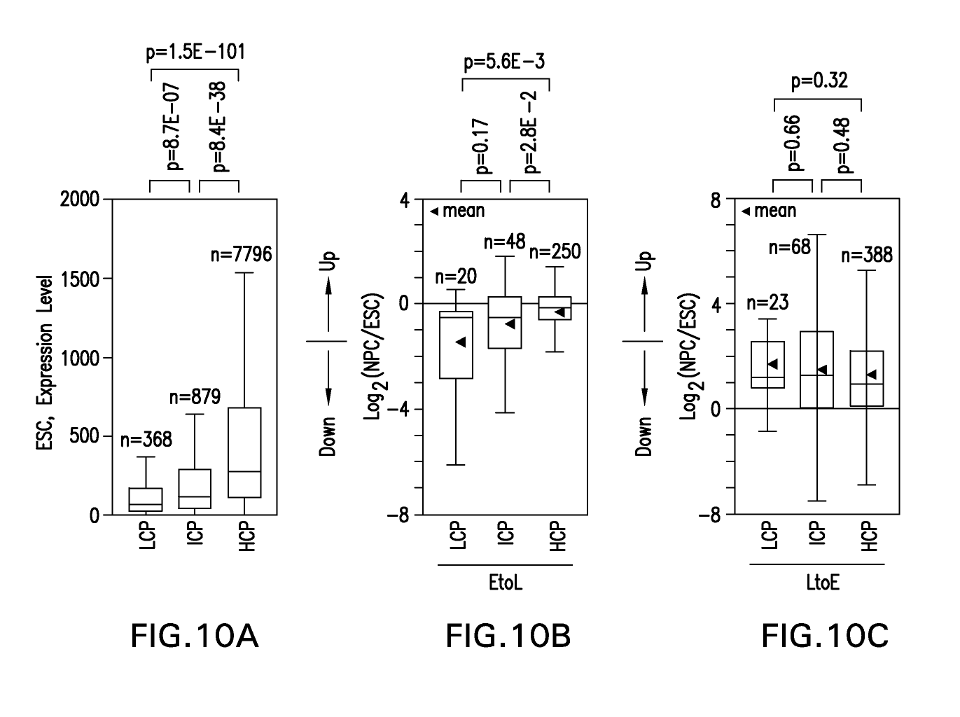

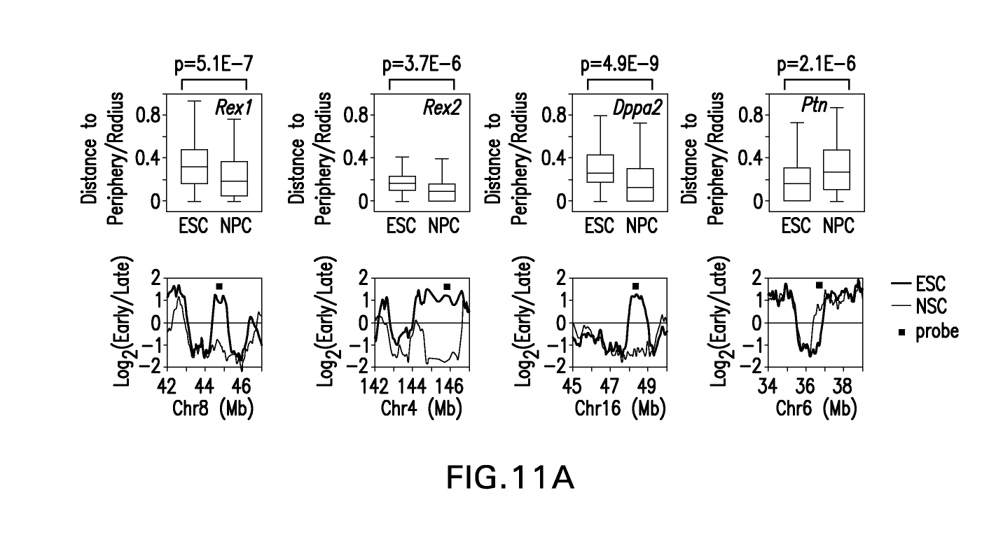

Given the presence of genes that are not affected by replication timing, specific classes of promoters are distinguished by how they are influenced by changes in replication time. Mammalian promoters may be classified based on their CpG density as high, intermediate and low CpG-containing promoters (HCP, ICP and LCP, respectively), which are subject to different modes of regulation. See, e.g., Mikkelson et al. (2007), supra; and Weber et al., “Distribution, silencing potential and evolutionary impact of promoter DNA methylation in the human genome,” Nat. Genet. 39:457-66 (2007), the entire contents and disclosure of which are incorporated herein by reference. In fact, among active genes, those with HCP, ICP, and LCPs have the highest, intermediate and lowest transcript levels, respectively, indicating that HCPs are more strongly expressed than ICP or LCPs (see FIG. 10A). Interestingly, it is found that LCP and ICP genes are generally repressed when residing within EtoL domains, whereas HCP genes are not significantly affected (see FIG. 10B). On the other hand, gene activation occurs regardless of promoter CpG density for genes within LtoE domains (see FIG. 10C), consistent with the switch to early replication creating a generally permissive environment for transcription. Moreover, activation of genes within LtoL domains is significantly biased toward HCP genes (not shown). These results suggest that the transcription of CpG-rich, strongly expressed promoters is not significantly affected by entering a late-replicating environment.

### Example 11

### Temporal Re-Organization Reflects Spatial Re-Organization

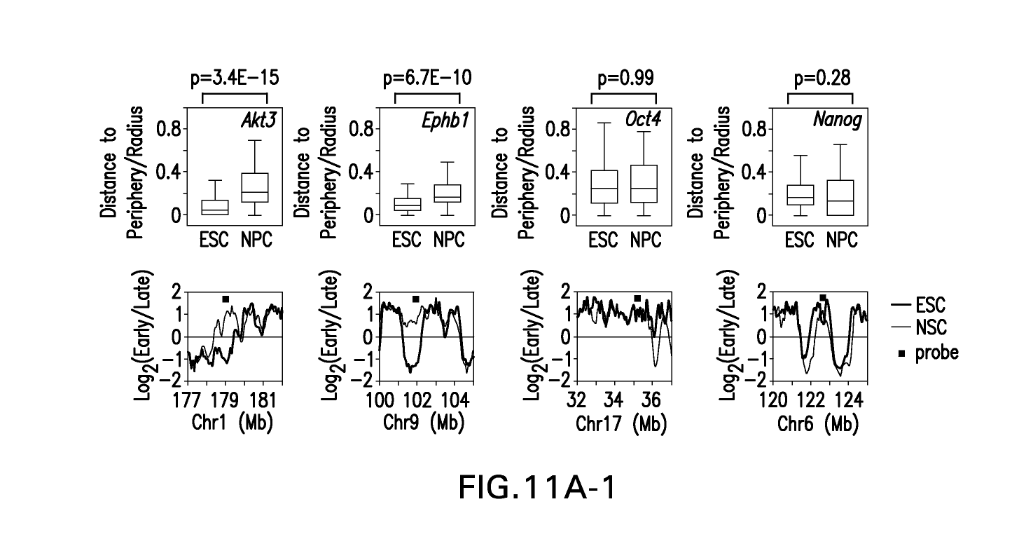

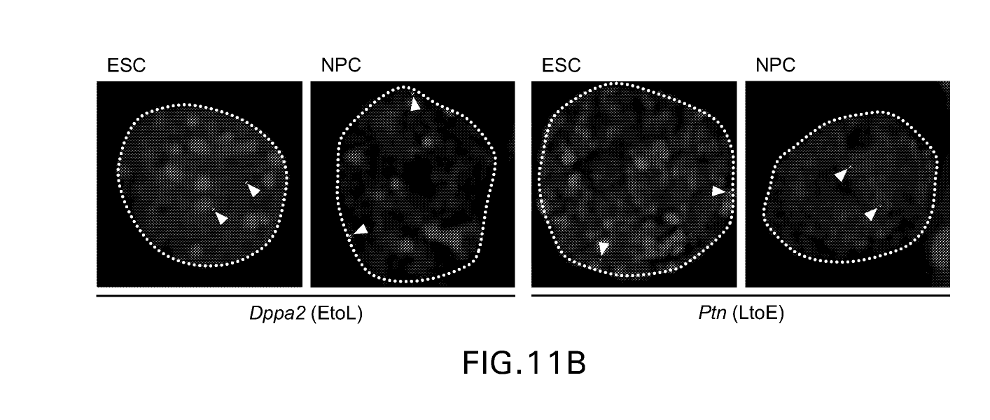

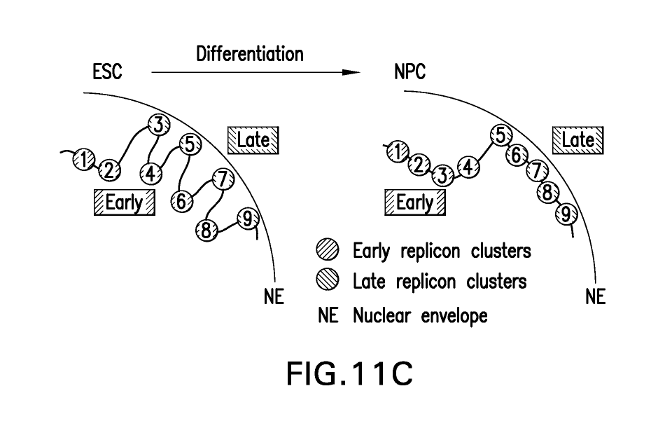

Early replication generally takes place in the interior of the nucleus, whereas the nuclear periphery is a late-replicating compartment. See, e.g., Dimitrova et al., “The spatial position and replication timing of chromosomal domains are both established in early G1-phase,” Mol. Cell. 4:983-93 (1999); and O'Keefe et al., “Dynamic organization of DNA replication in mammalian cell nuclei—spatially and temporally defined replication of Chromosome-Specific alpha-Satellite DNA sequences,” J. Cell Biol. 116:1095-1110 (1992), the entire contents and disclosures of which are incorporated herein by reference. This spatio-temporal organization of replication is thought to be similar in ESCs and differentiated cells. See, e.g., Panning et al., “Spatio-temporal organization of DNA replication in murine embryonic stem, primary, and immortalized cells,” J. Cell Biochem. 95:74-82 (2005); and Wu et al., “Differential subnuclear localization and replication timing of histone H3 lysine 9 methylation states,” Mol. Biol. Cell 16:2872-81 (2005), the entire contents and disclosures of which are incorporated herein by reference. Hence, the radial sub-nuclear position (distance to the nuclear periphery) of 8 individual genes is investigated before and after differentiation, using 3-dimensional (3D) fluorescence in situ hybridization (FISH) to preserve nuclear morphology. Results (see FIGS. 11A and 11B) reveal that genes within EtoL and LtoE domains move toward or away from the nuclear periphery, respectively, during differentiation. For example, three genes within EtoL domains (Rex1, Rex2 and Dppa2 domains) and three genes within LtoE domains (Ptn, Akt3 and Ephb1 domains) move toward and away from the nuclear periphery, respectively, upon neural differentiation, while two genes within EtoE domains (Oct4 and Nanog) do not change subnuclear positioning. Comparable results are obtained from 2-4 biological replicates and the sum of all experiments is shown, and 90-234 alleles are measured per state. Sub-nuclear position changes occur regardless of whether the replication timing changes are involved in domain ‘consolidation’ (Rex1, Rex2, Dppa2, Ephb1), “boundary shift” (Ptn) or “isolation” (Akt3). In contrast, two control EtoE down-regulated genes (Oct4 and Nanog) remain in the nuclear interior during differentiation.

These results strongly suggest that the global temporal re-organization of replication domains reflects global 3D spatial re-organization of chromosomes in the nucleus (see FIG. 11C). According to this model, there is an increased influence of isochore sequence features on replication timing, resulting in the temporal consolidation of domains to align replication timing to isochores, possibly accompanied by spatial re-organization. Therefore, it is predicted that the generation of replication maps for various tissues may be used to create a database of chromosome segments that undergo large changes in 3D organization during differentiation.

### Example 12

### Protocol for Genome-Scale Analysis of Replication Timing

### Introduction

Replication timing profiles are cell type-specific and reflect genome organization changes upon differentiation. The protocol of this example provides a description of how to analyze replication timing genome-wide in mammalian cells. Asynchronously cycling cells are pulse labeled with the nucleotide analog 5-bromo-2-deoxyuridine (BrdU) and sorted into S-phase fractions based on DNA content using flow cytometry. BrdU-labeled DNA from each fraction is immunoprecipitated, amplified, differentially labeled and co-hybridized to a whole genome CGH microarray, which is currently more cost effective than high-throughput sequencing and equally capable of resolving features at the biologically relevant level of tens to hundreds of kilobases. Also presented in this example is a guide to analyzing the resulting data sets. Subjects include normalization, scaling, and data quality measures, loess (local polynomial) smoothing of replication timing values, segmentation of data into domains and assignment of timing values to gene promoters. Finally, this example describes clustering methods and means to relate changes in the replication program to gene expression and other genetic and epigenetic data sets. Some experience with R or similar programming languages is assumed. Altogether, the protocol may take approximately 3 weeks to complete.

Although the mechanisms that specify the timing and placement of origin firing in higher eukaryotes remain a mystery, all eukaryotes have a defined RT program that is largely conserved between closely related species,¹ including humans and mice.^{2,3} Analyses of RT in various cell types have yielded insights into genome organization and repackaging events during development, suggesting an important role for the timing program itself or for 3D genome organization in regulating developmental gene expression.^{1,2,4} In this protocol, approaches for measuring genome-wide RT are described. As data processing and analysis often cause a bottleneck in these studies, the protocol also covers methods used routinely in our laboratory for downstream analysis.^{3,5,6} Although this protocol emphasizes mammalian cells, as applied to analyze RT changes in various mouse and human cell types,^{3,5,6} it can be adapted to any proliferating cell type; such variations have been used to analyze RT in Drosophila,^{7,8,9} Arabidopsis¹⁰ and budding yeast.¹¹

### Overview of the Procedure: Generating Experimental Data (Steps 1-61)

The first portion of the protocol describes how to derive raw data for genome-wide RT analysis. Given that the protocol measures the timing of events during the cell cycle, some form of synchronization is required. Synchronization can be achieved either prospectively, before cell collection, or retroactively, after the cells have been collected. In yeasts, prospective synchrony methods are well established, and in many cases, the same method can be used to compare different strains.^{12,13} However, most synchronization schemes for multicellular organisms are cumbersome and optimized for specific cell lines,^{14,15,16} and most require the use of metabolic inhibitors that can interfere with normal regulation of replication.^{17,18} By contrast, retroactive synchronization using fluorescence-activated cell sorting (FACS) to select cells based on the increase in DNA content during S phase can be applied to any proliferating cell population without the need for any previous manipulation beyond dissociation of cells into a single-cell suspension.¹⁹ Moreover, most prospective synchronization regimes for studying RT verify the quality of synchronization by FACS analysis of DNA content; as DNA content defines S-phase interval, selection of cells for DNA content is the most direct means to the desired end. The resolution of S-phase intervals is determined by the fineness of DNA content windows selected. The only situations in which prospective synchronization alternatives may need to be considered are for cells that are very difficult to dissociate or those that are severely aneuploid, such that DNA content does not reflect the time during S phase.

In the original method,^{20,21} cells were labeled with BrdU for a fraction of S-phase and sorted into several different time points during S-phase. BrdU-substituted DNA could then be isolated either on the basis of its increased density or by using BrdU-specific antibodies, and specific loci could be examined by hybridization or PCR.^{20,21,22} With microarray analysis, replication of the entire genome can be queried in a single-array hybridization by limiting the analysis to two differentially labeled samples, allowing all probes to be assigned one internally normalized relative RT value and rapid comparison of many samples.^{3,5,6,23,24} One limitation of assigning one RT value per map position is that it cannot distinguish cases in which homologous loci replicate asynchronously, a situation that is estimated to occur in a small percentage of the genome.¹⁹ However, the protocol can be adapted for analysis of these genomic segments by dividing and sorting S-phase into finer fractions.¹⁹

The two most popular variations of retroactive synchronization by FACS are described in the Procedure section below. In the first method, BrdU-labeled cells are divided into early and late S-phase fractions, and BrdU-labeled DNA synthesized either early or late can then be labeled and hybridized onto a microarray. This method produces a high signal-to-noise ratio, as immunoprecipitation (BrdU-IP) substantially enriches DNA synthesized in each half of S-phase. However, BrdU-IP efficacy can fluctuate and must be closely monitored. In the second method, unlabeled cells are sorted into total S-phase versus G1-phase populations, and DNA from these stages is differentially labeled and used as the target. This obviates BrdU-IP, but the dynamic range is limited to the twofold copy number increase during S-phase. Both methods yield similar results, evidenced by a direct comparison in the same cell line in one study.⁶ In both methods, DNA from each fraction is differentially labeled with Cy3 and Cy5 dyes and then co-hybridized to a whole-genome oligonucleotide microarray. The ratio of the abundance of each probe in each fraction is then used to generate an RT profile.

### Overview of the Procedure: Normalization and Computational Analysis of RT Data Sets (Steps 62-88)

In this section of the protocol, methods are described that are specifically useful for RT analysis using whole-genome comparative genomic hybridization (CGH) microarrays,²⁵ and that have been used to investigate the type, degree and mechanism of RT changes in mouse and human cell lines.^{3,5,6,23,24} General methods for normalizing and analyzing microarray experiments for chromatin modifications or transcription at gene promoters have been described in detail in other works.^{26,27,28,29} Similar to two-color microarray designs comparing an experimental sample with a reference, our RT experiments use a two-channel design comparing early versus late fraction enrichment for each target. Two dye-swap replicates per sample may be included to address bias due to dye-specific effects, such as more rapid photobleaching of Cy5 dye than Cy3. A goal of this protocol is to minimize the number of transformations applied to the data and to apply only minimally invasive global methods for removing bias and scaling data sets to allow comparisons between them.

All the analysis described here uses the R framework for statistical computing.³⁰⁻³² Through user-submitted packages that facilitate a wide variety of methods, R has become an indispensible tool for many common computational tasks. Although R has an initially steep learning curve due to its command-line interface, help is available in many locations and forms, including books,^{33,34,35} online manuals and mailing lists aggregated in the R mailing lists archive. Help can also be found within R itself; the command str( ) is often helpful for viewing the structure of variables and data sets, and the ? operator (e.g., ?data.frame( )) provides a help page for the corresponding function. One software package that may be used for normalization and scaling is the R package LIMMA (linear models for microarray data), also available with a user interface through the limmaGUI package.^{27,36} The steps for this process are straightforward and are illustrated using two biological replicate data sets of mouse L1210 lymphoblast cells; these data sets are available in raw form in Supplementary Data 1, 2, 3 and 4 available online with the HTML version of the article Ryba et al., “Genome-scale analysis of replication timing: from bench to bioinformatics,” Nature Protocol, 6(6), 871-95, 871-95 (2011), and the entire contents and disclosures of this article and supplementary material are incorporated herein by reference. These data sets are available after normalization and smoothing at http://www.ReplicationDomain.org/.

Provided in this section is a verified route for extracting information from the microarray experiments described in the Main Procedure; however, users with sufficient experience with R or having different requirements for their data are free to modify the analysis as needed, and a wide array of alternative and additional methods are available through Bioconductor.³¹ Although our methods for downstream analyses were tested primarily with NimbleGen CGH microarrays, most are applicable to any data format containing chromosome, genomic position and RT information for each probe.

### Experimental Design

### BrdU Incorporation

The nucleotide analog BrdU can be used to pulse-label newly synthesized DNA during the S-phase. For mammalian cell types that have 8- to 12-h S-phases, incubation with BrdU for 2 h has been empirically determined to provide sufficient incorporation to ensure successful BrdU-IP in subsequent steps, yet the incubation time is long enough to identify even subtle differences in RT, such as between female cells with one versus two early replicating X chromosomes.⁵ Success has also been achieved with BrdU labeling times as short as 1 h, but subsequent BrdU-IP can be problematic, as there is very little substituted DNA relative to the background of unsubstituted DNA that will contribute to noise in the BrdU-IP6. The BrdU-labeling times for cells with S-phase lengths substantially different from mammalian cells, such as amphibian²⁰ or fly⁸ cells, should be adjusted appropriately.

### FACS Sorting Fractions of S-Phase

For inexperienced users, it is recommend that at least 5×106 cells be used; however, with experience and a sufficient fraction of S-phase cells, fewer than 0.5×106 starting cells can be successfully profiled. The important parameter is to obtain 20,000-30,000 cells in each of the early and late S-phase fractions. As described in PROCEDURE Step 1A, ethanol-fixed cells can be stained with propidium iodide (PI) and sorted on the basis of DNA content. Alternative fluorochromes that do not require RNase digestion, such as chromomycin A3, can also be used with ethanol-fixed cells.^{20,21} Some cell types tend to clump or produce a lot of cellular debris when fixed in ethanol. For these cell types, the fixation step can be skipped, and DNA can be stained with DAPI (4,6-diamidino-2-phenylindole) in permeabilized cells, as described in PROCEDURE Step 1B. The advantage of the method described in Step 1A is that cells fixed in ethanol can be stored at −20° C. (empirically determined to be the optimal temperature) or shipped to collaborators. The cells should be placed on dry ice during shipping, with a partition between the tube and the dry ice to prevent cell freezing. All steps, particularly storage, should be done in the dark, as BrdU-substituted DNA is light sensitive.

During FACS analysis, forward and side-scatter analyses should be used to select an appropriate population of cells free of doublets or cell debris, both of which can hinder accurate sorting of desired populations. Lasers used in this protocol include 488-nm blue to detect PI or 407-nm violet to detect DAPI in cells that have been stained for DNA content. Two separate fractions of S-phase, early and late, are typically chosen for collection, but more can be collected if desired.^{20,21}

### Immunoprecipitation of BrdU-Labeled DNA

DNA from BrdU-labeled cells should be sonicated into fragments ranging from 250 bp to 2 kb and then immunoprecipitated using a BrdU-specific antibody. Sonication into fragments of this size helps eliminate IP of DNA that has not been labeled with BrdU. If samples have been stored at −20° C. before beginning the IP, thaw them in a 56° C. water bath to completely dissolve SDS, and then add 200 μl of SDS-PK buffer, prewarmed to 56° C. with 0.05 mg ml⁻¹ glycogen, to each sample before performing the phenol-chloroform extraction in Procedure Step 13.

### Quality Control Check of S-Phase DNA

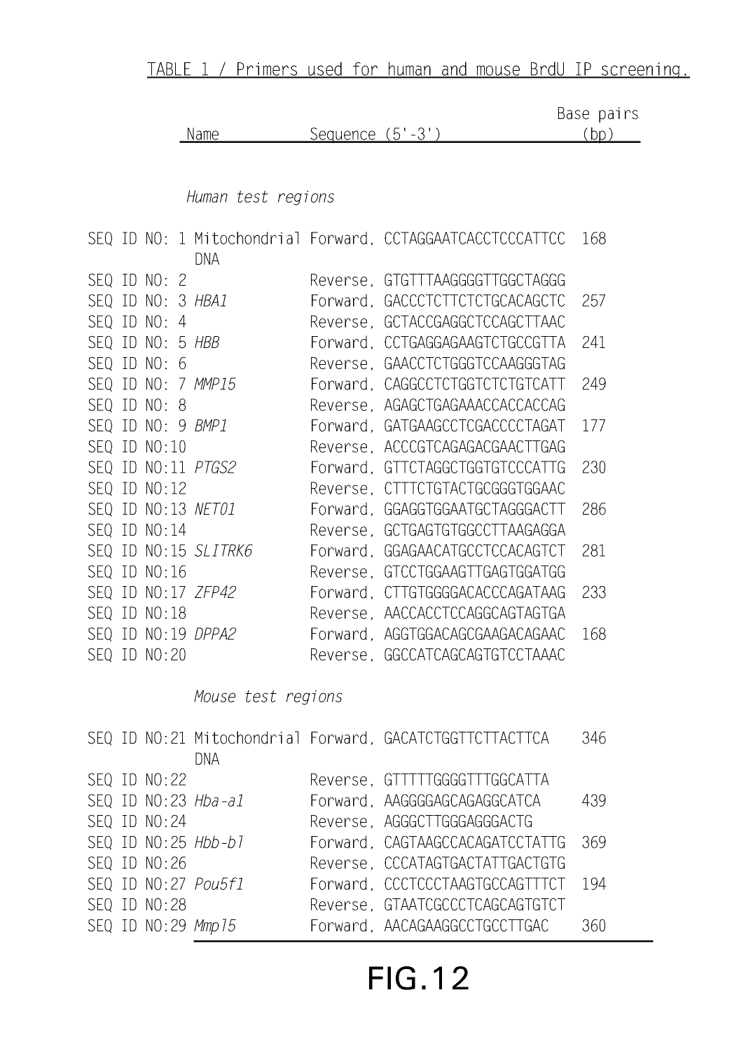

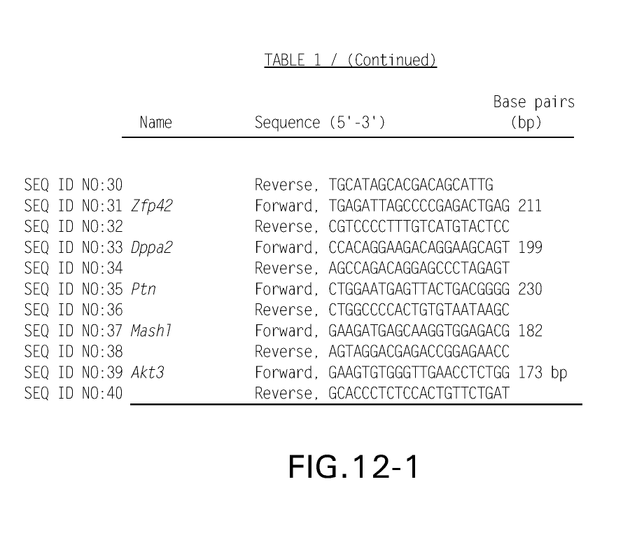

Because of the sensitivity and large number of steps involved, BrdU-IP is one of the trickiest parts of the protocol. To ensure quality, screen BrdU-IPs by PCR amplification, using primers specific to DNA markers of known relative replication time (i.e., early or late phase). Although real-time PCR can be performed, gel electrophoresis may be sufficient to evaluate enrichment of DNA in each IP sample. Importantly, as PCR results can vary between aliquots of the same sample and RT can vary between cell types,^{3,5} consistency across multiple samples from the same cell type is the best way to verify quality. Use the primer sets listed in Table 1 of FIG. 12 for mouse or human cell types, or substitute suitable alternatives to screen several IPs from both early and late S-phase fractions.

### Amplification Methods for Immunoprecipitated Single-Stranded DNA

Once purified by IP and screened for sample quality, BrdU-incorporated DNA must be amplified to obtain sufficient amounts for array hybridization. If multiple samples pass PCR screening, pool DNA from parallel IPs to use as the starting material for whole-genome amplification (WGA); otherwise, use a single-screen IP. Perform WGA as desired (the GenomePlex Complete Whole Genome Amplification and Reamplification Kits from Sigma may be used), load amplified samples onto a gel to determine size range, and screen once more with PCR to ensure that no bias was introduced during amplification.

### Labeling and Hybridization of Amplified Samples

The specific steps required in this section will largely depend on the chosen array platform. Although this example describes the use of NimbleGen products to avoid the ambiguity inherent in generalized methods, the products can be applied successfully to other platforms,^{8,9} including deep sequencing of BrdU-IP DNA.³⁷ Currently, mammalian RT data generated from microarray hybridization and deep sequencing are of equal quality,^{3,6} whereas the microarray method remains more cost effective and the bioinformatics are considerably less demanding for the typical laboratory. Future advances reducing BrdU-labeling times and sequencing limitations may make this method more cost effective and accessible.³⁸ Once a platform is chosen, the labeling and hybridization steps are fairly straightforward. Briefly, 1 μg of early- or late-replicating DNA may be labeled with either Cy5 or Cy3 random 9-mer dyes by Klenow reaction, precipitated with isopropanol and resuspended and quantified in nuclease-free water. Finally, equal quantities of labeled early- and late-fraction DNA should be combined (specific quantity will depend on array design).

### Array Design

Array design is also an important consideration, and the nature of the study being conducted should be a guide in selecting between the variety of available standard and custom designs. For many genome-wide studies in both mouse and human cell lines, 385K- and 3×720K-feature CGH tiling arrays have sufficient probe densities, showing no disadvantage compared with high-density 2.1M CGH tiling arrays,^{5,6} but they have considerable cost and convenience advantages. Tiling designs with roughly evenly spaced probes also facilitate the interpretation and analysis of genetic features.

### Array Scanning

Scanning is carried out according to the manufacturer's recommendations, avoiding unnecessary laser exposure. Take care to align channels with respect to signal intensity frequencies, although minor differences between channels usually do not impact smoothed timing profiles after normalization.

### Quality Control of Microarray Data

Before analysis, the overall quality of a microarray experiment should be examined from several angles. In general, there are six qualities that are important for reliable results of RT analyses on CGH arrays that should be verified at the corresponding PROCEDURE steps:

(1) Comparable signal intensity distributions for red and green channels (Step 74).

(2) Unbiased signal ratios with respect to signal intensity (Step 75).

(3) Comparable timing value distributions between experiments (Step 76).

(4) A high overall signal-to-noise ratio of the experiment (Step 84).

(5) Lack of artifacts in raw and false-color microarray images (Step 85).

(6) High correlations between replicate experiments (Step 86B).

### Downstream Analysis

When comparing the timing program with other genetic and epigenetic properties, differences should be noted in formats between chromatin immunoprecipitation (ChIP)-on-chip, ChIP-seq and other approaches will require some care in processing, and even data sets from similar platforms often have idiosyncrasies that must be accounted for. In particular, take care to ensure that RT and other data types are compared in compatible genomic builds and equivalent cell types; use a method of quantification consistent with the methods and goals of the studies involved.

### Materials

### Reagents

All solutions are prepared with ddH₂O and stored at room temperature (22° C.) unless otherwise indicated.
Cells of interest: Cultures can be grown in a cell culture dish of any size, but they must be in an actively dividing state for use in this protocol. A minimum of 50,000 S-phase cells is required for the protocol. However, it is recommend that cultures with at least 120,000 S-phase cells be used.
BrdU (5-bromo-2′-deoxyuridine; Sigma Aldrich, cat. no. B5002). Prepare stock solutions of 10 mg ml⁻¹ and 1 mg ml⁻¹ in ddH₂O, and store at −20° C.
Cell culture medium appropriate for cell type
Trypsin-EDTA (1×; Mediatech, cat. no. 25-053-C1)
Accutase (Innovative Cell Technologies, cat. no. AT104). For long-term storage, store at −20° C. Thaw overnight at 4° C. before use. Once thawed, store at 4° C. for up to 2 months. Warm to room temperature before each use.
PBS (see Reagent Setup below)
FBS (GIBCO, cat. no. 16000). Prepare 1% (vol/vol) in PBS, and store at 4° C.
DAPI (BioChemika, cat. no. 32670). Dissolve stock in ddH₂O to a final concentration of 10 mg ml⁻¹. Store at −20° C. protected from light.
PI (Sigma, cat. no. P4179-100MG; see Reagent setup below)
RNase A (10 mg ml⁻¹; Sigma, cat. no. R6513; store at −20° C.)
Proteinase K (20 mg ml⁻¹; Amresco, cat. no. E195; store at −20° C.)
Glycogen (20 mg ml⁻¹; Fermentas, cat. no. RO561; store at −20° C.)
Isopropanol (Sigma, cat. no. 59304)
Ethanol (100%; Sigma, cat. no. E7023)
Ethanol (70% (vol/vol); Sigma, cat. no. E7023)
Tris base (Fisher Scientific, cat. no. BP152-5)
HCl (EMD, cat. no. HX0603P-5)
NaCl (Fisher Scientific, cat. no. BP358-1)
KCl (Sigma, cat. no. P3911-500G)
Na₂HPO₄ (Sigma, cat. no. 53264-500G)
KH₂PO₄ (Fisher Scientific, cat. no. P380-500)
SDS (Invitrogen, cat. no. 15525-017)
EDTA (Invitrogen, cat. no. 15576-028)
SDS-PK buffer (see Reagent Setup below)
Tris-saturated Phenol (Fisher, cat. no. BP226-500; store at −20° C.). It is caustic and harmful if inhaled or ingested. Wear gloves and other appropriate protective equipment. Use adequate ventilation. Store at −20° C.
Chloroform (Sigma, cat. no. 34854). It is a probable carcinogen and is harmful if inhaled or ingested. Wear gloves and other appropriate protective equipment. Use adequate ventilation.
BrdU-specific antibody (BD Biosciences Pharmingen, cat. no. 555627). Store at 4° C.
Ammonium acetate (Fisher Scientific, cat. no. A639-500; see Reagent Setup below). It is an irritant and is harmful if swallowed. Wear gloves and other appropriate protective equipment. Use adequate ventilation. Store at room temperature.
Rabbit anti-mouse IgG (Sigma, cat. no. M-7023). Store at 4° C.
Anti-Mouse IgG-AlexaFluor488 (Invitrogen/Molecular Probes, cat. no. A-11029). Store at 4° C.
Taq DNA Polymerase with ThermoPol Buffer (New England BioLabs, cat. no. MO267)
dNTPs (10 μM; Bioline, cat. no. BIO-39025)
Ethidium bromide (10 mg ml⁻¹; Fisher, cat. no. BP102-5)
Agarose (OmniPur, cat. no. 2125)
PCR primers for BrdU-IP quality verification (Steps 45-49); see Table 1 of FIG. 12.
HCl/0.5% (0.1 M (vol/vol)) Triton X-100 (Sigma, cat. no. T9284) in ddH₂O, Store at room temperature.
Sodium tetraborate (Na₂B₄O₇.10H₂O; 0.1 M, Sigma, cat. no. S-9640, pH 8.5 in ddH₂O)
Tween-20 (0.5% (vol/vol); Sigma, cat. no. P-1379)/1% (wt/vol) BSA (Fisher Scientific, cat. no. BP1600-1) in PBS
Triton X-100 (0.1% (vol/vol); Sigma, cat. no. T9284) in PBS
Triton X-100 (0.5% (vol/vol); Sigma, cat. no. T9284) in PBS
BSA (Fisher Scientific, cat. no. BP1600-1)
GenomePlex Complete Whole Genome Amplification Kit (Sigma, cat. no. WGA2)
GenomePlex WGA Reamplification Kit (Sigma, cat. no. WGA3)
QIAquick PCR Purification Kit (QIAGEN, cat. no. 28106)
NimbleGen Dual-Color DNA Labeling Kit (NimbleGen, cat. no. 05223547001)
NimbleGen Hybridization Kit (NimbleGen, cat. no. 05583683001)
NimbleGen Wash Buffer Kit (NimbleGen, cat. no. 05584507001)

Equipment
Nylon mesh (37 μm; Small Parts, cat. no. CMN-0040-D)
Filter syringe (BD Biosciences, cat. no. H8293-005663)
Round-bottom polystyrene tube (5 ml; Falcon, cat. no. 352054)
Round-bottom tube (15 ml; Falcon, cat. no. 2059)
FACSAria cell sorter (BD Biosciences, or a comparable sorter)
Hemocytometer
Vortexer
Sonicator (Heat Systems-Ultrasonics W-380, Heat Systems Ultrasonics)
Thermocycler
Spectrophotometer (NanoDrop, Thermo Scientific)
Electrophoresis apparatus
Appropriate NimbleGen Arrays and Mixers
Appropriate NimbleGen Hybridization System
Appropriate NimbleGen microarray scanner
Parafilm

### Reagent Setup

PBS (1×). To prepare 1 liter, dissolve 8 g NaCl, 0.2 g KCl, 1.44 g Na₂HPO₄ and 0.24 g KH₂PO₄ in 800 ml of ddH₂O. Adjust pH to 7.4 with HCl, and adjust the final volume to 1 liter. Sterilize by autoclaving. Store at room temperature.

Trypsin-EDTA (0.2×). To prepare 50 ml, combine 10 ml of 1× Trypsin-EDTA with 40 ml of 1×PBS. Store at 4° C. for up to 1 month. Warm to room temperature before each use.

Propidium iodide (1 mg ml⁻¹). To prepare 20 ml, dissolve 20 mg PI powder in autoclaved ddH₂O to obtain a final volume of 20 ml, and filter by syringe. Store protected from light for up to 1 year at 4° C.

DAPI staining solution. To prepare ˜1 ml, add 10 μl of 10% (vol/vol) Triton X-100 and 2 μl of 1 mg ml⁻¹ DAPI to 1 ml of PBS. Prepare the solution fresh before each use.

BrdU-specific antibody (12.5 μm1⁻¹). Dilute antibody in 1×PBS from the stock concentration of 0.5 mg ml⁻¹ to a final concentration of 12.5 μg ml⁻¹. Freshly prepare 40 μl of diluted antibody for each sample, and discard unused diluted antibody.

Ammonium acetate (10 M). To prepare 100 ml, dissolve 77.08 g ammonium acetate in 50 ml of ddH₂O. Add ddH₂O to adjust the final volume to 100 ml. Syringe-filter, and store at room temperature.

Tris-HCl (1 M; pH 8.0). To prepare 500 ml, dissolve 60.57 g Tris base in 400 ml of ddH₂O. Add HCl to adjust pH to 8.0. Add additional ddH₂O to adjust the final volume to 500 ml. Sterilize by autoclaving. Store at room temperature.

EDTA (0.5 M). To prepare 1 liter, dissolve 186.1 g disodium EDTA in 800 ml of ddH₂O, Stir vigorously on a magnetic stirrer. Adjust the pH to 8.0 by addition of NaOH. Add ddH₂O to a final volume of 1 liter. Sterilize by autoclaving. Store at room temperature.

TE buffer (1×). To prepare 1 liter, add 10 ml of 1 M Tris-HCl (pH 8.0) to 2 ml of 0.5 M EDTA (pH 8.0), and adjust the final volume to 1 liter with autoclaved ddH₂O, Store at room temperature.

Phenol-chloroform solution. To prepare 50 ml, combine 25 ml of Tris-saturated phenol with 25 ml of chloroform. Allow separation of layers before use. It is recommend that the solution be stored overnight before use to allow adequate separation or centrifuged at maximum speed for 10 min before use to achieve separation. Store at 4° C. protected from light.

SDS-PK buffer. To prepare 50 ml, combine 34 ml autoclaved ddH₂O, 2.5 ml of 1 M Tris-HCl (pH 8.0), 1 ml of 0.5 M EDTA, 10 ml of 5 M NaCl and 2.5 ml of 10% (wt/vol) SDS. Store at room temperature. Warm to 56° C. before use to completely dissolve SDS.

IP buffer (10×). To prepare 50 ml, combine 28.5 ml of ddH₂O, 5 ml of 1 M sodium phosphate (pH 7.0), 14 ml of 5 M NaCl and 2.5 ml of 10% (wt/vol) Triton X-100. Store at room temperature.

IP buffer (1×). To prepare 50 ml, add 5 ml of 10×IP buffer to 45 ml of autoclaved ddH₂O. Store at room temperature.

Digestion buffer. To prepare 50 ml, combine 44 ml of autoclaved ddH₂O, 2.5 ml of 1 M Tris-HCl (pH 8.0), 1 ml of 0.5 M EDTA and 2.5 ml of 10% (wt/vol) SDS. Store at room temperature.

### Equipment Setup—Sonicator

Adjust sonicator settings as needed to achieve a 250 bp to 2 kb distribution of DNA fragment sizes. A water bath-type sonicator (Heat Systems-Ultrasonics W-380) with a 2-s, 50% duty cycle and an output setting of 7 for 4 min may be used.

### Main Procedure

### BrdU Labeling and Staining of Cells for FAC

1. To perform PI staining and ethanol fixation before sorting, follow option A; this method is most commonly used, as it allows for shipping or long-term storage, and it has worked well for most mouse cell lines.^{5,6} For cells that break or clump in ethanol, follow option B; note that a drawback of option B is that cells need to be sorted immediately following BrdU labeling. Alternatively, carry out the procedure for S/G1 sorting described in Box 1 instead of Steps 1-57 (see also FIG. 1). This method obviates the need for BrdU-IP and WGA and can alleviate concerns that sorting early and late fractions of S-phase or WGA introduce a temporal bias; however, in our experiments, E/L (early/late) fractionation has produced results equivalent to the S/G1 method as well as sorting of additional S-phase fractions.^{3,37}

(A) Labeling and PI staining of cells for FACS after ethanol fixation—timing 3.5 h
(i) Add BrdU to cells in culture medium at a final concentration of 50 μM.
(ii) Incubate cells for 2 h in a CO₂ incubator at 37° C. with 5% CO₂.
(iii) For adherent cells, rinse gently with ice-cold PBS twice. For suspension cells, collect cells in a 15-ml tube and proceed directly to Step 1A(vi).
(iv) Detach adherent cells using 0.2× Trypsin-EDTA for 2-3 min or Accutase for 3-6 min. Incubate cells at 37° C. with the enzyme treatment and/or use gentle trituration if necessary to achieve a single-cell suspension, as this is essential for accurate FACS sorting.
(v) Add 5 ml of cell culture medium (containing FBS if trypsin has been used) to the cell culture dish or flask, pipette gently and transfer contents to a 15-ml round-bottom tube.
(vi) Count the number of cells collected using a hemocytometer. Collect enough cells to obtain at least 20,000-30,000 (preferably >150,000) cells in each fraction after sorting (Step 2); this will generally require 0.5-1×106 cells, with more cells required if few cells are in S-phase. For inexperienced users, it is recommended to start with 4×106 to 8×106 cells.
(vii) Centrifuge at ˜200 g for 5 min at room temperature.
(viii) Aspirate the supernatant carefully and resuspend the cells in 2.5 ml of ice-cold PBS containing 1% (vol/vol) FBS.
(ix) Add 7.5 ml of ice-cold 100% ethanol dropwise while gently vortexing. Note that vortexing should be performed gently to avoid cell damage.
(x) Seal the cap of the 15-ml tube with Parafilm, and mix gently but thoroughly. Pause point—If necessary, cells can be stored in the dark at −20° C. indefinitely.
(xi) Resuspend the BrdU-labeled, ethanol-fixed cells by tapping and inverting the tube.
(xii) Transfer 4×106 to 8×106 cells to a 5-ml polystyrene round-bottom tube.
(xiii) Centrifuge at −200 g for 5 min at room temperature.
(xiv) Decant supernatant carefully.
(xv) Resuspend the cell pellet in 2 ml of PBS with 1% (vol/vol) FBS. Mix well by tapping the tube.
(xvi) Centrifuge at −200 g for 5 min at room temperature.
(xvii) Decant supernatant carefully.
(xviii) Resuspend the cell pellet in PBS with 1% (vol/vol) FBS to achieve a solution of 3×106 cells per ml.
(xix) Add 1 mg ml⁻¹ of PI to a final concentration of 50 μg ml⁻¹.
(xx) Add 10 mg ml⁻¹ of RNase A to a final concentration of 250 μml⁻¹.
(xxi) Tap the tube to mix and incubate for 20-30 min at room temperature (22° C.) in the dark.
(xxii) Filter cells by pipetting them through a 37-μm nylon mesh into a 5-ml polystyrene round-bottom tube.
(xxiii) Place samples on ice in the dark, and proceed directly to FACS sorting.

(B) BrdU labeling and DAP I staining of cells for FACSACS—Timing 3 h
(i) Follow Steps 1A(i)-(vii).
(ii) Aspirate the supernatant carefully.
(iii) Add 5 ml of ice-cold PBS, and pipette gently but thoroughly.
(iv) Centrifuge at −200 g for 5 min at room temperature.
(v) Aspirate the supernatant carefully.
(vi) Resuspend the cell pellet in DAPI staining solution to achieve a solution of 5×106 to 10×106 cells per ml.
(vii) Filter the cells by pipetting them through a 37-μm nylon mesh into a 5-ml polystyrene round-bottom tube.
(viii) Place the samples on ice in the dark, and proceed directly to FACS sorting.

2. Run the sample on an FACSAria cell sorter (alternatively, any comparable cell sorter can be used). It is very important to place live samples chilled on ice or at 4° C. during FACS analysis to avoid cell-cycle progression in the absence of BrdU. Protect samples from light.

3. Use forward and side-scatter information to select the desired population of cells to be included in the sort, and exclude doublets or cell debris.

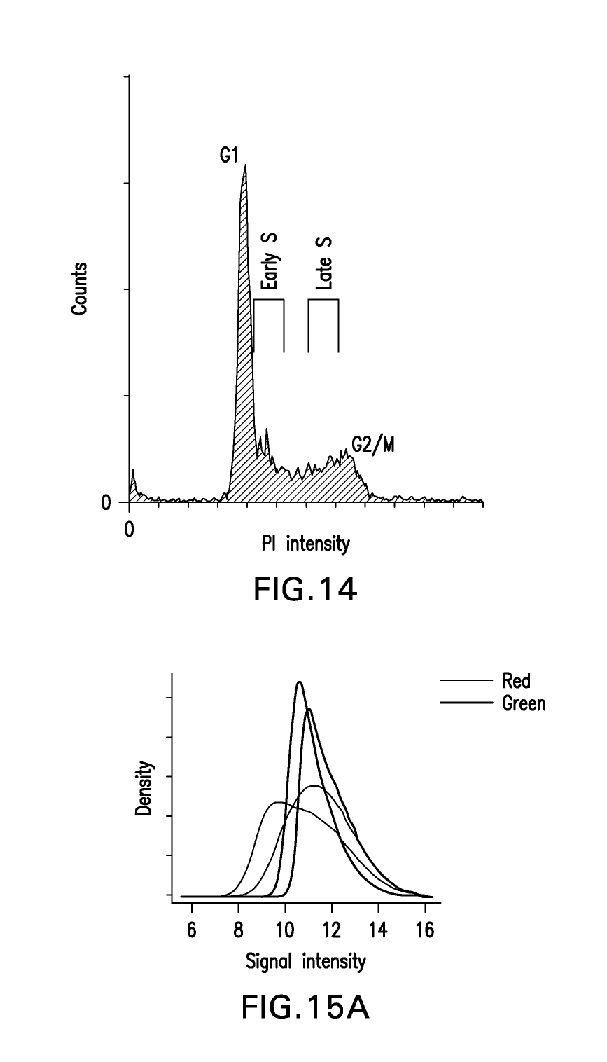

4. Create a histogram that plots cell count on the y-axis and DNA content (fluorochrome intensity) on the x-axis (see FIG. 14).

5. Select two distinct S-phase populations to be sorted into separate fractions, as indicated in FIG. 14. FIG. 14 shows a typical cell-cycle profile for a mammalian fibroblast population obtained during FACS analysis by plotting cell count versus DNA content. In this example, cellular DNA was stained with PI; accordingly, DNA content is represented by PI intensity. A G1 peak, representing cells with 2N DNA content, and a G2/M peak, representing cells that have undergone replication and therefore possess a 4N DNA content, are labeled. The area between these two peaks is representative of cells in S-phase and can be sorted into two fractions, as indicated here, to obtain early and late S-phase samples.

6. Sort cells into fresh 5-ml round-bottom tubes, and place at 4° C. during the sort. Pause point—Store cells immediately on ice in the dark until all samples have been sorted.

7. Centrifuge at 400 g for 10 min at 4° C. Alternatively, if fewer than 150,000 cells have been collected for each fraction, proceed directly to Step 9.

8. Decant supernatant gently, only once. Some residual sheath fluid can be left in the tube to prevent losing the cell pellet, which can easily detach from the tube during this step.

9. Add 1 ml of SDS-PK buffer containing 0.2 mg ml⁻¹ of proteinase K and 0.05 mg ml⁻¹ of glycogen for every 100,000 cells collected, and mix vigorously by tapping the tube.

10. Incubate samples in a 56° C. water bath for 2 h.

11. Mix the sample thoroughly, and aliquot 200 equivalent to ˜20,000 cells, per 1.5-ml tube. Samples can be stored for at least 6 months at −20° C. in the dark before use.

12. Add 200 μl of SDS-PK buffer with 0.05 mg ml⁻¹ of glycogen to each aliquot and proceed directly to BrdU-IP.

### BrdU Immunoprecipitatio—Timing 2-3 Day

13. Extract once with phenol-chloroform, collecting the upper phase in a 1.5-ml tube.

14. Extract once with chloroform, collecting the upper phase in a 1.5-ml tube.

15. Add 1 volume of isopropanol, and mix well.

16. Store at −20° C. for 20 min. Pause point—Samples can be stored in the dark at −20° C. overnight.

17. Centrifuge at 16,000 g for 30 min at 4° C.

18. Discard the supernatant, and add 750 μl of 70% ethanol to the pellet.

19. Centrifuge at 16,000 g for 5 min at 4° C., then remove all ethanol and let the pellet dry.

20. Resuspend the pellet in 500 μl of 1×TE. Pause point—If necessary, the pellet can be stored overnight at 4° C.

21. Sonicate DNA to an average size of approximately 0.7-0.8 kb. Settings required for a 250 bp to 2 kb range should be determined empirically for each sonicator type. See Equipment setup above.

22. Incubate the sample at 95° C. for 5 min to heat-denature the DNA.

23. Cool the sample on ice for 2 min.

24. Add 60 μl of 10×IP buffer to a clean 1.5 ml tube.

25. Add the denatured DNA from Step 22 to the tube from Step 24.

26. Add 40 μl of 12.5 μg ml⁻¹ anti-BrdU antibody.

27. Incubate for 20 min at room temperature with constant rocking Cover tubes with foil, and keep samples in the dark.

28. Add 20 μg of rabbit anti-mouse IgG. Cover tubes with foil, and keep samples in the dark.

29. Incubate for 20 min at room temperature with constant rocking

30. Centrifuge at 16,000 g for 5 min at 4° C.

31. Remove the supernatant completely. If the pellet becomes loose, then briefly centrifuge the sample again in order to completely remove the supernatant without disturbing the pellet. Several centrifugations may be necessary to completely remove the supernatant.

32. Add 750 μl of 1×IP buffer that has been chilled on ice.

33. Centrifuge at 16,000 g for 5 min at 4° C.

34. Remove supernatant completely, as in Step 31.

35. Resuspend the pellet in 200 μl of digestion buffer with freshly added 0.25 mg ml⁻¹proteinase K. Incubate the samples overnight at 37° C.

36. Add 100 μl of fresh digestion buffer with freshly added 0.25 mg ml⁻¹ proteinase K.

37. Incubate the samples for 60 min at 56° C.

38. Extract once with phenol-chloroform, collecting the upper phase in a 1.5-ml tube.

39. Extract once with chloroform, collecting the upper phase in a 1.5-ml tube.

40. Add 0.625 μl of 20 mg ml⁻¹ glycogen, 100 μl of 10 M ammonium acetate and 750 μl of 100% ethanol, and mix well.

41. Store at −20° C. for 20 min. Samples can be stored in the dark at −20° C. indefinitely.

42. Centrifuge at 16,000 g for 30 min at 4° C.

43. Remove supernatant, rinse pellet with 70% (vol/vol) ethanol and dry.

44. Resuspend the pellet in 80 μl of 1×TE (for a final concentration of 250 cell equivalents per μl). Store DNA at 4° C. for up to 1 month or at −20° C. for longer storage.

### PCR Method for Quality Control of BrdU-IP—TIMING 4-6 h

45. Prepare enough PCR master mix to screen all IP samples with each primer set listed in Table 1 of FIG. 12. An example PCR mix is listed in the table below. Mitochondrial primer sets should be used at 1.0 μM concentration instead of 0.5 μM; add 0.63 μl of forward and reverse 20 μM combined primers, and adjust with nuclease-free water accordingly.

TABLE A

| | Amount per | | |
|---|---|---|---|
| Component | reaction μl | Final | |
| Taq buffer (10×) | 1.25 | 1× | |
| dNTPs (10 mM) | 0.25 | 0.2 | mM |
| Taq polymerase (20 U μl − 1) | 0.06 | 1.2 | U |
| F/R 20 μM combined primers | 0.31 | 0.5 | μM |

| | | |
|---|---|---|
| Nuclease-free water | Up to 12.5 | — |

46. Aliquot 11.5 μl of master mix per tube and add 1 μl of IP sample.

47. Run the samples in thermocycler with the following conditions shown in Table B below:

TABLE B

| Cycle number | Denature | Anneal | Extend |
|---|---|---|---|
| 1 | 94° C., 2 min | — | — |
| 2-39 | 94° C., 45 s | 60° C., 45 s | 72° C., 2 min |
| 40 | — | — | 72° C., 5 min |

48. Add 2.5 μA of 6× loading dye to every 12.5 μl reaction and load 6 μl onto 1.5% (wt/vol) agarose gel. Run the gel at 125 V for 16 min.

49. Score each IP based on anticipated enrichment of amplicon DNA (see Experimental design). Multiple samples from the same cell type should amplify consistently, with enrichment consistent with genes of known RT for the given cell type. Before proceeding, verify sample quality with corresponding primer sets listed in Table 1 of FIG. 12.

### Troubleshooting

50. If several IPs of the same sample and S-phase fraction pass the screening, pool equal amounts of each IP to a final volume of 50 μl (e.g., if two IPs pass, combine 25 μl of each in the pool).

### Whole—Genome Amplification—Timing 8 h

51. Precipitate DNA fractions by adding 1.25 μl of 2 mg ml⁻¹ glycogen, 20 μl of 10 M ammonium acetate and 150 μl of ethanol to each 50 μl IP sample (if pooling multiple samples, a total volume of 50 μl should still be used). Mix well, let it stand at −20° C. for 20 min and then centrifuge for 30 min at maximum speed at 4° C.

52. Rinse the pellets with 70% (vol/vol) ethanol, air-dry them, and then resuspend them in 10 μl of nuclease-free water.

53. Transfer the 10 μl samples to 0.2 ml PCR tubes and carry out WGA using an appropriate method or kit. In our experiments, the GenomePlex Complete Whole Genome Amplification Kit has worked well, starting from the library preparation step (i.e., skipping fragmentation).³⁹

54. Purify entire WGA products using an appropriate PCR purification kit, such as QIAquick. Elute in 30 μl nuclease-free water prewarmed to 65° C. and determine the concentration using Nanodrop.

55. Dilute WGA samples to appropriate concentration (1 μl DNA of 20 ng μl⁻¹ may be used) and, if necessary to obtain sufficient material for the chosen array platform, perform a second round of WGA. The GenomePlex WGA Reamplification Kit, Reamplification Procedure A is followed in the second round of WGA in this example.

56. Purify entire reamplified WGA products as in Step 54.

57. Screen purified final products using the PCR method described in Steps 46-49. Pause point—Samples can be stored in the dark at −20° C. for up to 1 month.

### Labeling and Hybridizing—Timing 1-3 d

58. Differentially label reamplified early and late WGA DNA fractions with Cy3 and Cy5 dyes from Step 57 (or nonamplified DNA prepared as in Box 1) according to the method most appropriate for the chosen array platform. The sample labeling instructions for the NimbleGen Dual-Color DNA Labeling Kit may be followed in this example.

59. Hybridize the samples to array(s) using the corresponding method or kit. The NimbleGen Hybridization Kit may be used.

60. After hybridization, wash array(s) as needed. This step may be performed, according to the manufacturer's instructions, using the NimbleGen Wash Buffer Kit.

61. Scan array(s) with an appropriate microarray scanner and software package, such as NimbleGen scanner GenePix 4000B and the accompanying NimbleGen arrays user's guide, CGH analysis v5.1. Newer equipment is accompanied with a newer version of the user's guide and operated slightly differently. For NimbleGen arrays, raw images should be saved as .tif files, and two .pair files (one each for Cy3 and Cy5 channels) will be created per experiment.

### Normalization of Raw Data Sets—Timing 1 d

62. If necessary, install R from http://www.r-project.org/. Create RGL (Red Green List) files from the original NimbleGen .pair files, as described in Steps 63-68. These files contain columns for both red (Cy5) and green (Cy3) channel signal intensities. Example pair files used in Step 65 and throughout are available in Supplementary Data 1, 2, 3 and 4 available on-line with the HTML version of the article Ryba et al., “Genome-scale analysis of replication timing: from bench to bioinformatics,” Nature Protocol, 6(6), 871-95 (2011), and the entire contents and disclosures of this article and supplementary material are incorporated herein by reference.

63. Set the working directory using the command ‘setwd’ in the R console to specify the appropriate file path. Here and in later steps, the ‘>’ symbol denotes the R prompt at the beginning of a line and should be omitted when typing the command.

>setwd(“D:\RT project\Raw datasets”)

64. Read the first five rows of data from the raw data files and determine the data type of each column using the sapply( ) function:

> tab5rows < - read.delim(”318990_4L1210LymphoblastP1_532.pair”,
header = T, nrows = 5, skip = 1)
> classes < - sapply(tab5rows, class)

When reading large tables in R, such as .pair files, explicitly noting the number of rows and data type of each column as illustrated here and in Step 65 will save a substantial amount of memory and calculation time. Occasionally, the sapply( ) function will set the genomic position columns of large data sets as an integer type, which lacks the memory space to store large numbers. If so, set the type manually with >classes[x]=‘numeric’ (where x is the column number containing position information) after creating the classes variable.

65. Read the raw data sets into memory. Note that variable names and file names may be substituted here and elsewhere, as appropriate. The ‘nrows’ parameter can be a modest overestimate; the correct number of rows will be present in the final table, but an estimate allows the system to allocate the correct amount of memory.

> mLymph1Cy3 < - read.delim(”L1210LymphoblastR1_532.pair”,
header = T, nrows = 390000, comment.char = ””, colClasses =
classes, skip = 1) # Supplementary Data 1
> mLymph1Cy5 < - read.delim(”L1210LymphoblastR1_635.pair”,
header = T, nrows = 390000, comment.char = ””, colClasses =
classes, skip = 1) # Supplementary Data 2
> mLymph2Cy3 < - read.delim(”L1210LymphoblastR2_532.pair”,
header = T, nrows = 390000, comment.char = ””, colClasses =
classes, skip = 1) # Supplementary Data 3
> mLymph2Cy5 < - read.delim(”L1210LymphoblastR2_635.pair”,
header = T, nrows = 390000, comment.char = ””, colClasses =
classes, skip = 1) # Supplementary Data 4

66. Extract the Cy3 and Cy5 channel signal intensities from the raw data sets, for example,

> mLymph1 < - data.frame(S_Cy5 = mLymph1Cy5[,10],S_Cy3 =
mLymph1Cy3[,10])
> mLymph2 < - data.frame(S_Cy5 = mLymph2Cy5[,10],S_Cy3 =
mLymph2Cy3[,10])

67. Write the columns extracted in Step 66 to separate RGL files for normalization

> write.table(mLymph1, file = ”L1210LymphoblastR1.rgl.txt”,
row.names = F, quote = F, sep = ”\t”, eol = ”\r\n”)
write.table(mLymph2, file = ”L1210LymphoblastR2.rgl.txt”,
row.names = F, quote = F, sep = ”\t”, eol = ”\r\n”)

68. Create a ‘targets’ text file that describes the target files for normalization. This file is named ‘T.txt’ in this example (see Supplementary Data 5 for an example targets file. Supplementary Data 5 is available on-line with the HTML version of the article Ryba et al., “Genome-scale analysis of replication timing: from bench to bioinformatics,” Nature Protocol, 6(6), 871-95 (2011), and the entire contents and disclosures of this article and supplementary material are incorporated herein by reference.). Note that, to be read correctly, the file should be tab delimited and should contain only one carriage return at the end of the final line. Place this file in the same directory as the raw .pair files and .rgl files generated above.

69. Install a current version of the LIMMA package according to the instructions available at http://bioinf.wehi.edu.au/limma/ or by using the command line interface:

> source(”http://www.bioconductor.org/biocLite.R”)
> biocLite(”limma”)
> biocLite(”statmod”)

70. Perform LOESS and scale normalization using LIMMA as described in Steps 71-73 and verify the results as described in Steps 74-85. This process is more straightforward than many two-color normalization methods, as NimbleGen arrays do not have print tip groups, spot background areas or mismatch spots that must be accounted for. LOESS normalization (normalize within arrays) corrects the internal dependence of red-green ratios on their intensity independently for each array and is examined further in Steps 74 and 75. Scale normalization (normalize between arrays) equalizes the distribution of timing values between multiple samples for comparisons and can be verified in Step 76.

71. Load the LIMMA package and read the raw data sets listed in the file created in Step 68. This will generate na MAlist-type data object, r, which stores the ratios (M-values) and average intensity values (A-values) of raw samples before normalization:

> library(limma)
> t = readTargets(”T.txt”, row.names = ”Name”)
> r = read.maimages(t, source = ”generic”,columns = list(R =
”S_Cy5”, G = ”S_Cy3”))

72. Perform LOESS normalization. This will generate a second MAlist-type data object, MA.l, which stores the samples after within-array normalization.

>MA.l=normalizeWithinArrays(r, method=“loess”)

73. Perform scale normalization. This will generate a third MAList object, MA.q, which stores the samples after between-array normalization. As with ChIP-chip methods,^{13,14} this type of scale normalization may not be appropriate for examining subsets of the genome in which large unbalanced timing changes are expected (e.g., timing of the X chromosome before and after inactivation), but is ideal for whole-genome analyses.

>MA.q=normalizeBetweenArrays (MA.l, method=“scale”)

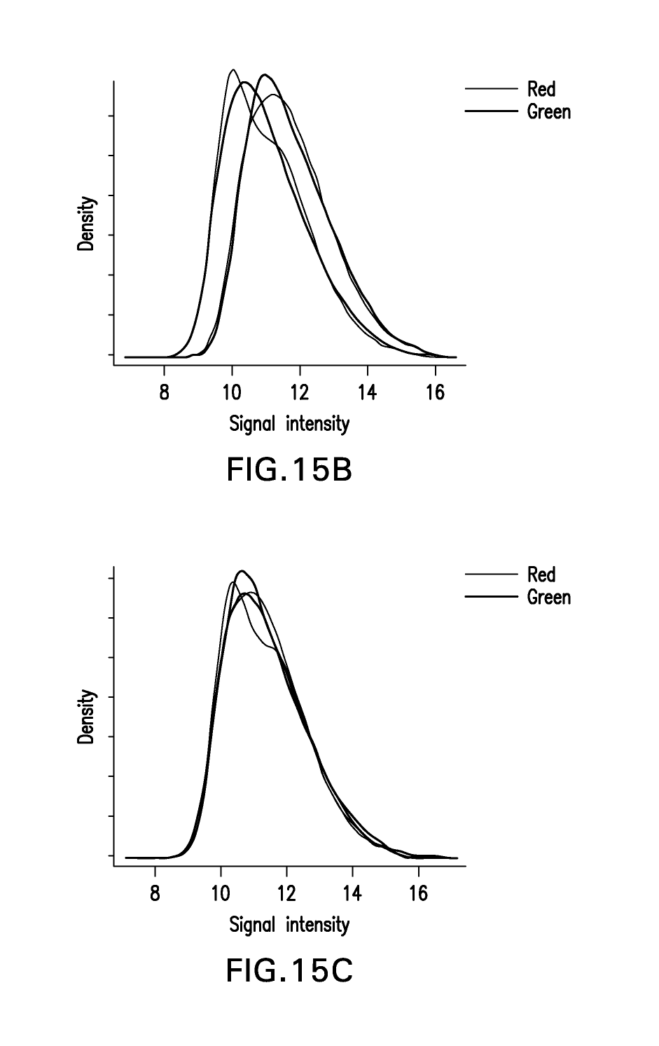

74. Check the distribution of spot intensities for red and green channels after each stage of normalization (FIGS. 15A, 15B and 15C). These distributions should be fairly well aligned and should have tails with high signal values. Experiments in which signal intensity drops off more sharply will often show higher levels of noise in the final data set. Here and in subsequent steps, text following the ‘#’ symbol represents non-executed comments. FIGS. 15A, 15B and 15C depict the distribution of Cy5 (red) and Cy3 (green) signal values before normalization FIG. 15A, after within-array normalization FIG. 15B, and after between-array normalization FIG. 15C in LIMMA.

(b,c) As RT is a relative property, equivalent amounts of DNA are transcribed before and after the middle of S-phase, allowing distributions to be transformed to a common scale for each channel (b) and array (c).

> plotDensities(r) # Raw data
> plotDensities(MA.l) # After within-array normalization
> plotDensities(MA.q) # After between-array normalization

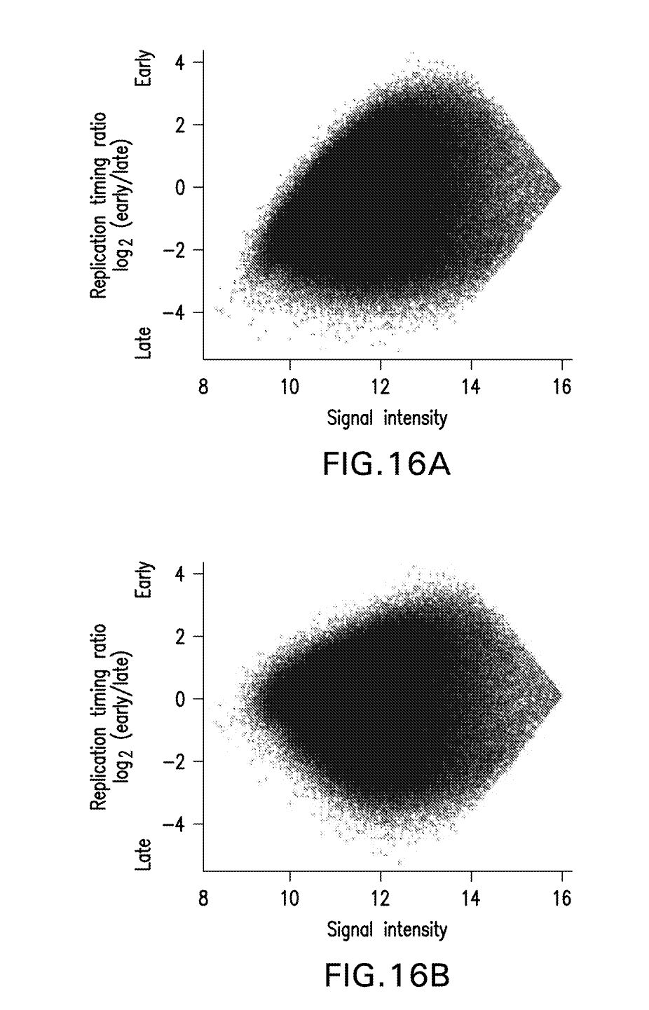

75. Create MA plots to check for a relationship between the ratio of dye intensities (M) and their average (A) (FIGS. 16A and 16B). Points will often be skewed to low Cy5/Cy3 ratios at low intensities due to photobleaching of Cy5 but should be corrected after within-array loess normalization in LIMMA. This bias is the most common artifact for NimbleGen arrays but other types can also be diagnosed with MA plots.⁴⁰ FIGS. 16A and 16B show the dependence of timing ratios on signal intensity. FIGS. 16A and 16B are MA are plots from LIMMA illustrate the relationship between red/green ratios (y axis) and signal intensity (x axis) before (FIG. 16A) and after (FIG. 16B) within-array normalization. The skew of low-intensity data pointing toward Cy3 (here, late) values is a common characteristic of two-color arrays, and is corrected after normalization.

> plotMA(r, array = 1) # Raw data, replicate 1
> plotMA(MA.l, array = 1) # After within-array normalization

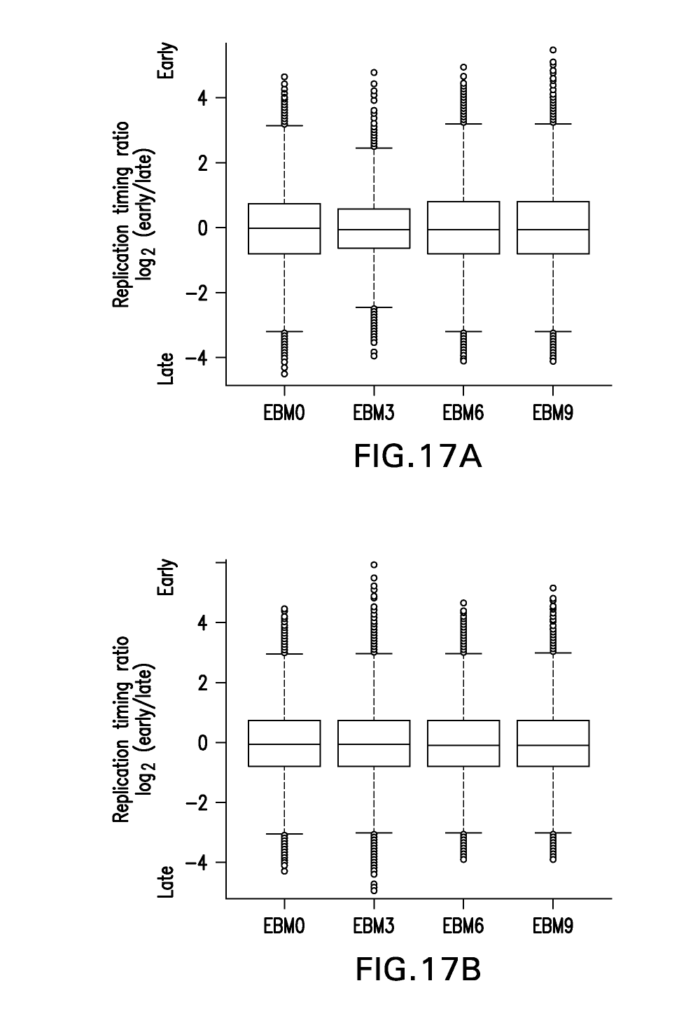

76. Verify that the distribution RT values are equivalent across experiments after normalization by creating boxplots of Cy5/Cy3 ratios for each experiment (FIGS. 17A and 17B). These distributions may be slightly different before normalization (and after within-array normalization), but first and third quartiles (the box boundaries) of all experiments should be equal after between-array normalization. FIGS. 17A and 17B show the verification of scale normalization between data sets. FIGS. 17A and 17B are exemplary boxplots of timing values before (FIG. 17A) and after (FIG. 17B) normalization between arrays, for a 9-d differentiation from embryonic stem cells to neural precursor cells with 3-d intermediates: (EBM0 (embryonic stem cells); EBM3, EBM6 and EBM9 (neural precursor cells)).⁵ Modest differences in the distribution of timing values (with box boundaries representing the first and third quartiles) are equalized after scaling.

> boxplot(MA.l$M~col(MA.l$M), names = colnames(MA.l$M))
> boxplot(MA.q$M~col(MA.q$M), names = colnames(MA.q$M))

77. Create an intermediate file containing the normalized data sets by typing, for example,

>write.table (MA.q$M, file=“Loess_mLymph_{—}112909.txt”, quote=F, row. names=F, sep=“\t”)
This tab-delimited text file will be further processed in Steps 79-85 to sort and average the normalized data sets and check other quality control measures.

78. Remove the other objects from memory.

>rm(r, MA.l, MA.q, mLymph1Cy3, mLymph1Cy5, mLymph2Cy3, mLymph2Cy5, mLymph1,mLymph2); gc(reset=T)
Or, remove all objects.
>rm(list=ls( ))

79. Assign position and chromosome information to the normalized data sets. This can be accomplished using the original .pair files, which typically contain this information in columns ‘POSITION’ and ‘SEQ_ID’, respectively (option A). Some data formats, such as HD2 triplex arrays, contain a different format of SEQ_ID column with chromosome and chromosome end points combined (e.g., ‘chr11:1-134452384’) or no SEQ_ID column. In these cases, extract chromosome labels from the PROBE_ID column (option B)

(A) Copy position and chromosome columns from original .pair files.
(i) Read the intermediate file created in Step 77:

> tab5rows = read.table(”Loess_mLymph_112909.txt”,
header = T, nrows = 5)
> classes = sapply(tab5rows, class)
> RT = read.table(”Loess_mLymph_112909.txt”, header =
T, nrows = 389306, comment.char = ””, colClasses =
classes)

(ii) Next, read the original .pair file containing POSITION and SEQ_ID columns:
>tab5 rows=read.delim(“L1210LymphoblastP1_{—}635.pair”, header=T, nrows=5, skip=1)>
classes=sapply(tab5 rows, class)>
a=read.delim(“L1210LymphoblastP1_{—}635.pair”, header=T, nrows=389306, comment.char=“ ”, colClasses=classes)
(iii) Finally, remove unmapped probes from the files loaded in Steps 79A(i) and (ii) and assign position and chromosome information to the normalized data sets:

> RT = subset(RT, a$POSITION ! = 0)
> a = subset(a, a$POSITION ! = 0)
> RT$CHR = a$SEQ_ID; RT$POSITION = a$POSITION

(B) Parse position and chromosome information from PROBE_ID column.
(i) Load the normalized and .pair files as outlined in Steps 79A(i) and 79A(ii).
(ii) Split the PROBE_ID column into the elements preceding and following ‘FS’; for example, ‘CHR12FS006244334’ will become ‘CHR12’ and ‘006244334’.

> x = strsplit(as.character(a$PROBE_ID), ”FS”)
> y = unlist(x) # chr [1:770156] “CHR01””003001832”
...

(iii) Separate the odd- and even-numbered indices of this object into separate columns and convert the position strings to numeric values.

> y1 = y[c(TRUE, FALSE)] # chr [1:385078]
“CHR01””CHR01” ...
> y2 = y[c(FALSE,TRUE)] # chr [1:385078]
“003001832””003018759” ...
> y2 = as.numeric(y2) # num >[1:385078] 3001832
3018759 ...

(iv) Finally, assign the position and chromosome information to the normalized data set:
>RT=data.frame(CHR=y1, POSITION=y2, RT, stringsAsFactors=F)

80. Sort data sets by chromosome and position. This will ensure that the plotting and autocorrelation checks in Steps 81 and 84 are accurate and that they are required for most downstream analysis. By the default sorting method, the order of mouse chromosomes will be 1, 10-19, 2-9, X and then Y. This order itself is unimportant but should be consistent across experiments to prevent errors in downstream analysis.

>RT=RT[order(RT$CHR, RT$POSITION),]

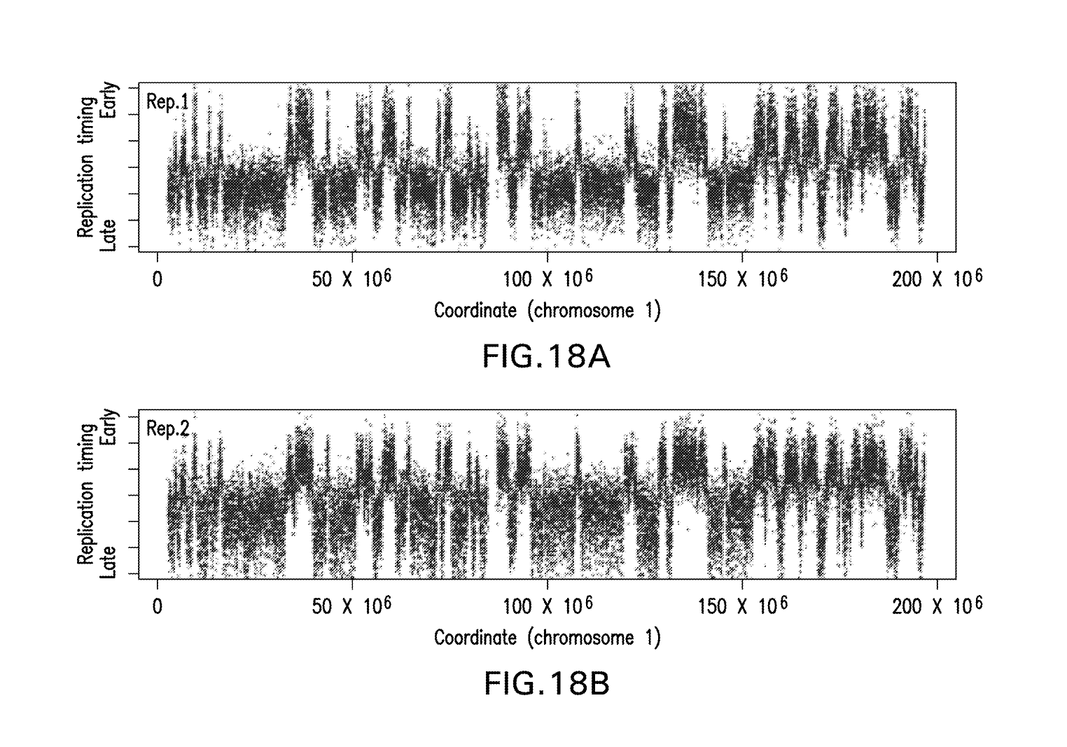

81. Plot timing values across a chromosome (FIGS. 18A and 18B). This serves to verify the orientation for early/late domains, as well as the overall technical quality of the experiments. The data set structure is checked using ‘str(RT)’ for the correct column numbers to plot and adjust the y axis span (‘yim’) as needed. FIGS. 18A and 18B show replication timing values across chromosome 1. For each replicate, individual log₂(Cy5/Cy3) probe intensities are plotted in gray (y axis) against their position on chromosome 1 (x axis). Because of photobleaching of Cy5 diagnosed in Step 75, timing is skewed toward early values in replicate 1 (FIG. 18A, Replicate 1) and late values in replicate 2 (FIG. 18B, Replicate 2), illustrating the practical advantages of dye-swap replicates.

> RTb = subset(RT, RT$CHR = = ”chr1”) # Create a subset of
timing values in chromosome 1
> par (mar = c(3.1,4.1,1,1),mfrow = c(2,1)) # Set plot margins;
include two rows in layout
> plot(RTb[,1]~RTb$POSITION,pch = 19,cex = 0.2,col = ”grey”,ylim
= c(−3,3)) # Plot replicate 1
> plot(RTb[,2]~RTb$POSITION,pch = 19,cex = 0.2,col = ”grey”,ylim
= c(−3,3)) # Plot replicate 2

82. Using known regions of early or late replication, verify that the timing values are properly oriented. If not, reverse them by multiplying the appropriate data columns by −1:

### >RT[,1]=RT[,1]*−1

83. Rename data sets and average replicates as desired, then write a finalized file containing normalized data to the current working directory (see Step 63), for example,

> names(RT)[1:2] = c(”mLymphR1”, ”mLymphR2”)
> RT$mLymphAve = (RT[,1] + RT[,2]) / 2
> write.table(RT, ” LoessScale + CHRPOS_mLymph_112909.txt”,
row.names = F, quote = F, sep = ”\t”)

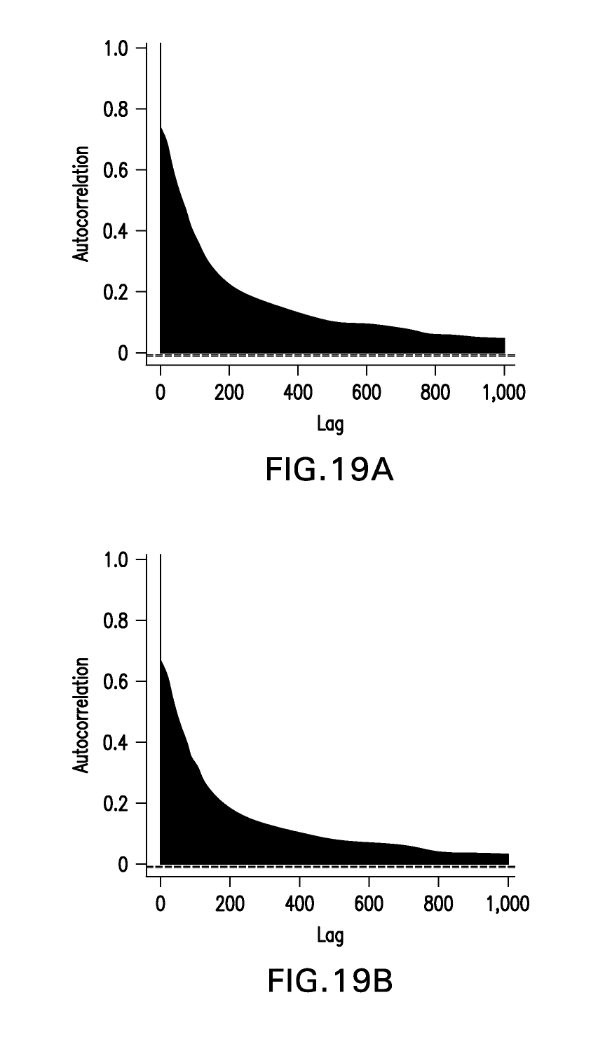

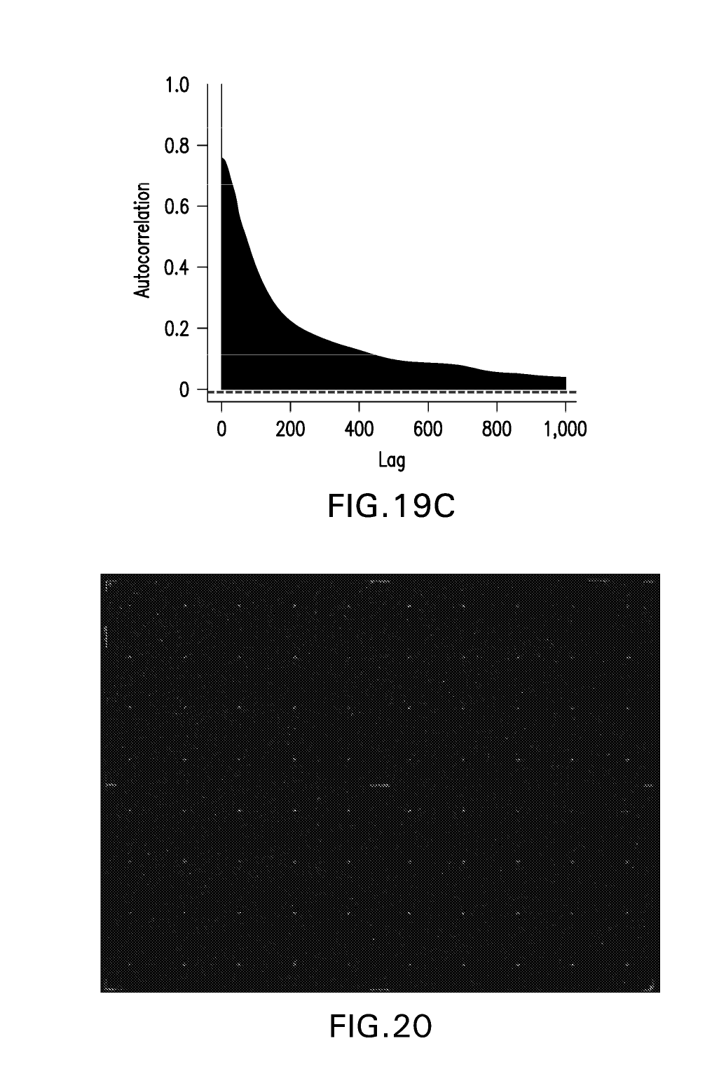

84. For each data set, determine the autocorrelation function (ACF), which describes the correlation between neighboring data points as a function of their genomic distance (FIGS. 19A, 19B and 19C). As nearby loci should replicate almost synchronously, the ACF is a useful measure of overall data quality. High-quality data sets will have a correlation between nearest neighbor timing values of R=0.60-0.80. This measure of signal-to-noise ratio will improve as more replicates with equivalent states are averaged.

> acf(RT[,1],lag = 1000)$acf[2] # Replicate 1: R = 0.742
> acf(RT[,2],lag = 1000)$acf[2] # Replicate 2: R = 0.665
> acf(RT$mLymphAve, lag = 1000)$acf[2] # Averaged 1 and 2: R =
0.762

### Troubleshooting

85. To check for spatial artifacts, examine the original .tif images (FIG. 20) for common characteristics of regional bias, such as streaks, blank regions or overabundance of either channel in any region of the array.⁴¹ Note that the ‘rtiff’ package may first need to be installed as in Step 72. As most probes on tiling microarray designs are randomly distributed with respect to genomic location, spatial artifacts in the scanned images should not affect timing values to a large extent in any particular location in the genome, but may reduce the overall signal-to-noise ratio of the experiment if they cover a substantial portion of the array.

> library(rtiff)
> Cy5 = readTiff(”318990_3MEFfemale_532.tif”)
> plot(Cy5)

### Static Properties of the Timing Program in a Given Cell Type—Timing 3 h

86. After normalization, choose among several common options to analyze the characteristics of timing data sets. Although optional, each method is complementary and useful for a wide range of downstream analysis. To derive an overall timing profile from noisier raw data points, apply a loess smoothing function (option A). Use a correlation metric, generally after LOESS smoothing, to determine the overall levels of similarity among two or more data sets (option B). Perform segmentation (option C) to define the boundaries of replication domains and determine their average timing.

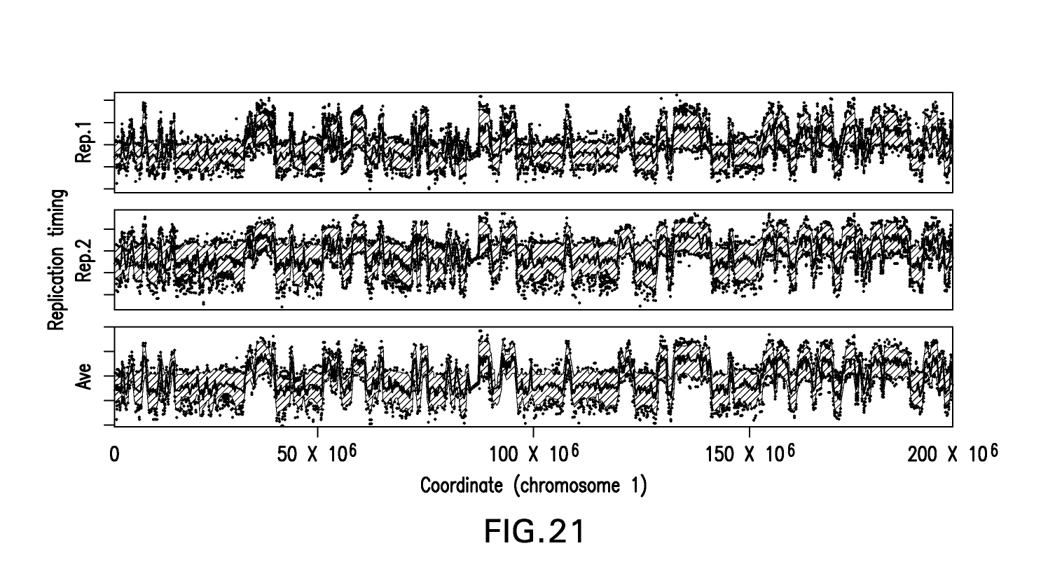

(A) LOESS smoothing
(i) Apply LOESS smoothing to each chromosome as outlined below (FIG. 21). For human and mouse data sets, smoothing may be performed with a bandwidth of 300 kb; other systems may have different optimal smoothing spans that should be determined empirically using the smallest span that reproduces most of the features between replicate profiles.

> chrs = levels(RT$CHR); str(chrs) # Create a list of
all chromosomes
> AllLoess = NULL # Initialize a variable to store all
loess-smoothed data
> for (chr in chrs) { # For each chromosome,
> RTl = NULL # Create a variable to store loess-
smoothed values
> RTb = subset(RT, RT$CHR = = chr) # Subset the data
set to a single chromosome
> lspan = 300000/(max(RTb$POSITION)−min(RTb$POSITION))
# Set smoothing span
> cat(”Current chromosome: ”, chr, ”\n”) # Output
current chromosome to console
> RTla = loess(RTb$ mLymphR1~ RTb$POSITION, span =
lspan) # Smooth data set 1
> RTlb = loess(RTb$mLymphR2~ RTb$POSITION, span =
lspan) # Smooth data set 2
> RTlc = loess(RTb$mLymphAve ~ RTb$POSITION, span =
lspan)# Smooth data set 3
> RTl = data.frame(CHR = RTb$CHR, POSITION =
RTb$POSITION, RTla$fitted, RTlb$fitted, RTlc$fitted) #
Combine the data sets for the current chromosome
> AllLoess = rbind(AllLoess, RTl) # Combine current
chromosome with overall data set
> } # End for loop
> x = as.data.frame(AllLoess) # Reformat the smoothed
data sets as a data frame

(ii) Rename the LOESS-smoothed data sets as desired and save these to a tab-delimited text file. Note that column names within a data frame cannot begin with a number.

> names(x)[3:5] = c(”x300smo_mLymphR1”,
”x300smo_mLymphR2”, ”x300smo_mLymphAve)
> write.table(x, ”300kb_LoessSmo_mLymph_112909.txt”,
row.names = F, quote = F, sep = ”\t”)

(iii) Plot the results of LOESS smoothing as follows (FIG. 21). The “mfrow” parameter may be adjusted for different numbers of data sets.

> RTc = subset(RT, CHR = = ”chr1”) # Subset of raw
timing data in chr1
> LSc = subset(LS, CHR = = ”chr1”) # Subset of
smoothed data in chr1
> par(mar = c(2.2,5.1,1,1), mfrow = c(3,1), col =
”grey”, pch = 19, cex = 0.5, cex.lab = 1.8, xaxs =
”i”)
> plot(RTc$mLymphR1~RTc$POSITION, ylab = ”mLymph R1”,
xaxt = ”n”) # Plot raw data points
> lines(LSc$x300smo_mLymphR1~LSc$POSITION, col =
”blue3”, lwd = 3) # Overlay loess line
> plot(RTc$mLymphR2~RTc$POSITION, ylab = ”mLymph R2”,
xaxt = ”n”)
> lines(LSc$x300smo_{—} mLymphR2~LSc$POSITION, col =
”blue3”, lwd = 3)
> plot(RTc$mLymphAve~RTc$POSITION, xlab = ”Coordinate
(bp)”, ylab = ”mLymph ave”)
> lines(LSc$x300smo_{—} mLymphAve~LSc$POSITION, col =
”blue3”, lwd = 3)

(B) Correlations between data sets
(i) Once the technical quality of the array data is established, compare biological replicate experiments to determine the relative level of biological similarity between samples. When comparing different cell types, to isolate biological rather than array quality differences, LOESS-smoothed averaged replicate data may be used, rather than individual, raw or normalized data:
>cor(x[,c(4:6)]

TABLE C

| | Rep1 | Rep2 | Ave |
|---|---|---|---|
| Lymphoblast Rep1 | 1.000 | 0.978 | 0.995 |
| Lymphoblast Rep2 | 0.978 | 1.000 | 0.994 |
| Lymphoblast Ave | 0.995 | 0.994 | 1.000 |

The cor( ) function defaults to Pearson correlation, but other methods are available (see ?cor in R). If missing values are present, add ‘nasm=T’ to remove them.

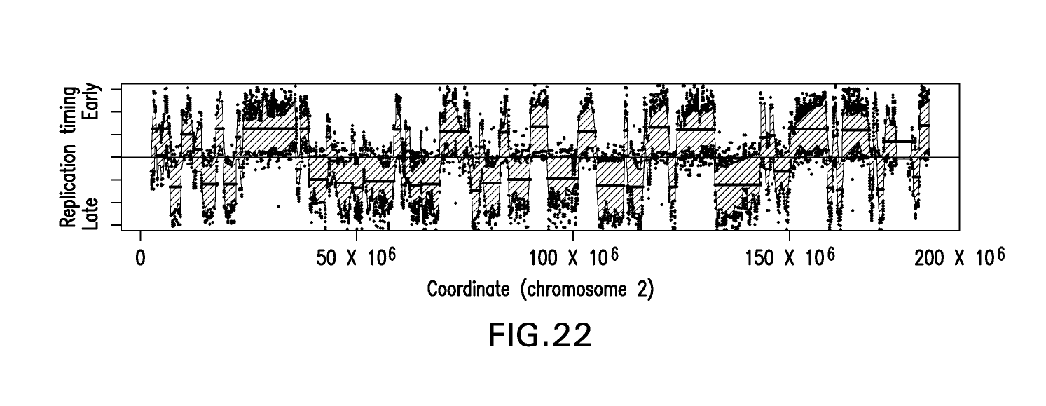

(C) Segmentation
(i) Perform circular binary segmentation as outlined in Steps 86C(ii-iv) (FIG. 22). Biologically, these segments (or ‘replication domains’) appear to correspond to domains of coordinately regulated, synchronously firing origins that may be part of replication factories. Segmentation may be performed as follows using the DNACopy algorithm designed by Venkatraman et al.,⁴² which performs favorably compared with alternatives for CGH copy number analysis.⁴³⁻⁴⁵
(ii) First, load the DNAcopy package and prepare a CNA (copy number array) object for segmentation.

> library(DNAcopy)
> mLymph = CNA(RT$mLymphAve, RT$CHR, RT$POSITION,
data.type = •logratio•, sampleid = •mLymph•)

(iii) Next, segment the CNA object with the desired parameters. The parameters shown are those that have been used for analysis of mouse and human timing data sets, with autocorrelations near 0.8_{3,6}; data of different quality or in different formats may require these to be determined empirically.
>Seg.mLymph=segment(mLymph, nperm=10000, alpha=1e-15, undo.splits=sdundo, undo.SD=1.5, verbose=2)
(iv) Examine the resulting segmentation object ‘Seg.mLymph’, which contains the raw data and segmentation breakpoints assigned by circular binary segmentation₄₆. The number of segments assigned can be determined using str(Seg.mLymph$output) and visualized using various functions built into DNAcopy (FIG. 22).

> par(ask = T,mar = c(3.1,4.1,1,1)) # Set figure
margins; ask before replotting
> plot(Seg.mLymph, plot.type = •c•) # Plot each
chromosome separately
> plot(Seg.mLymph, plot.type = •s•) # Plot overview of
all chromosomes
> plot(subset(Seg.mLymph,chromlist = ”chr2”), pch =
19, pt.cols = c(”gray”,”gray”), xmaploc = T, ylim =
c(−3,3)) # Plot a single chromosome with alternate
format

(v) Create a tab-delimited text file containing segment end points and average RT values for each segment. The file will be written to the current working directory (see Step 63).
>write.table(Seg.mLymph$output, row.names=F, quote=F, sep=“\t”)
(vi) After segmentation, calculate the sizes of replication domains from the segmented data set to examine average sizes for domains with early or late timing.

> Lymph = Seg.mLymphR1$output # Extract domain
information
> Lymph$size = Lymph$loc.end − Lymph$loc.start #
Calculate domain sizes
> LymphEarly = subset(Lymph, Lymph$seg.mean > 0) #
Create subset of early domains
> LymphLate = subset(Lymph, Lymph$seg.mean < 0) #
Create subset of late domains
> boxplot(LymphEarly$size, LymphLate$size) #
Distribution of early/late domain sizes

### Dynamic Changes in the Timing Program—Timing 3 h

87. To examine changes in the replication program during differentiation, use one or several of the methods in this step to leverage the segmentation and loess smoothing methods introduced in Step 86. As no single method is sufficient to fully describe the type, degree and distribution of timing changes during development, several complementary ways to measure these properties and explore the relationships between cell types may be used. These ways include the following: (A) the amount of the genome changing RT (percentage change analysis); (B) the degree and relationships of RT changes between cell types (clustering approaches); and (C) the properties of domains that change timing on differentiation (switching domain analysis).

(A) Percentage change analysis
(i) Determine the amount of the genome with differential timing between two or more cell types using an arbitrary, percentile or significance-based cutoff for RT changes. In one embodiment of the present invention, it is recommended scale data sets to equivalent ranges and apply an empirical cutoff for changes verifiable by PCR to quantify these genome wide, as shown here. As most methods for quantifying timing changes are sensitive to scale differences, data sets should be first scaled and normalized together in LIMMA (see Steps 62-76).

> RTd1 = RT$mLymphR1 − RT$mLymphR2 # Calculate
timing differences between data sets
> mLength = length(RTd1) # Determine total number of
probes
> s = 0.67 # Set cutoff for significant changes
> sum(abs(RTd1) > s)/mLength # Percentage changing, R1
vs. R2
> sum(RTd1 < −s)/mLength # Early to Late changes: 1.6%
of all probes
> sum(RTd1 > s)/mLength # Late to Early changes: 1.3%
of all probes

(B) Clustering approaches
(i) Perform clustering to aggregate experiments with similar timing patterns. For k-means clustering programs such Cluster⁴⁷ and TreeView may be used. For hierarchical clustering, the ‘pvclust’ package in R⁴⁸ may be used to compute clusters based on the stability of connections between cell types and ascribe P values to each node.
(ii) To improve the precision of individual RT measurements and lessen the considerable computational expense of most clustering algorithms, individual timing values may be averaged into larger windows before clustering. Average data sets in windows of ˜200 kb may be typical.

> mLymph.R1 = NULL; mLymph.R2 = NULL # Initialize
variables to store averaged data
> nWin = 35 # 5.8 kb median probe spacing *
35 = 203 kb
> mLength = nrows(RT)/nWin # Calculate number of
windows
> for (x in 1:mLength) { # For each potential window,
> z1 = x * nWin # Determine probe number at window
start
> z2 = (x + 1) * nWin # Determine probe number at
window end
> mLymph.R1[x] = mean(RT$mLymphR1[z1:z2]) # Average
replicate 1 across window
> mLymph.R2[x] = mean(RT$mLymphR2[z1:z2]) # Average
replicate 2 across window
> cat(”Current window: ”, x, ”/”, mLength, ”\n”) #
Write the current window to the console
> } # End for loop
> RTWind = data.frame(mLymph.R1, mLymph.R2) # Write
the results to a new data frame

(iii) Load the pvclust⁴⁸ package and use its corresponding function to cluster data sets using multiscale bootstrap re-sampling, which will assign P values to each node in the hierarchical clustering dendrogram. See ?pvclust after loading the package for additional options and settings.

> library(pvclust)
> cluster.bootstrap < - pvclust(RTWind, nboot = 1000,
method.dist = •abscor•)

(iv) Plot the cluster dendrogram as performed below.

> plot(cluster.bootstrap) # Plot overall dendrogram
> pvrect(cluster.bootstrap) # Outline data sets that
cluster at a significant level

Care should be taken when interpreting the results of hierarchical clustering, as a wide variety of topologies are possible for a single dendrogram, as any node can be flipped horizontally without changing the connections between clusters; agglomerative clusters can change substantially when new experiments are added; and the exact connections produced (although usually not the overall structure of the dendrogram) often change for different clustering algorithms or distance metrics.

(C) Properties of RT switching domains
(i) Perform segmentation on the differences between timing profiles to define the boundaries of domains that switch to earlier or later replication (switching domains) and analyze the properties of genetic and epigenetic elements within them. To compute these domains, first subtract the normalized (not LOESS-smoothed) values of the two experiments to be compared and create a CNA object in a manner similar to Step 86C(ii).
>dRT=CNA(RT$NPCave-RT$ESCave, RT$CHR, RT$POSITION, data.type=“logratio”, sampleid=“NPC-ESC dRT”)
(ii) Next, segment the resulting object, calculate domain sizes and write the segments to a tab-delimited text file.

> Seg.dRT = segment(dRT, nperm = 10000, alpha = 1e−15,
undo.splits = ”sdundo”, undo.SD = 1.5, verbose = 2);
dRTdom = Seg.dRT$output
> dRTdom$size = dRTdom$loc.end − dRTdom$loc.start
> write.table(dRTdom, ”Switching segments, mNPC vs.
mESC.txt”, row.names = F, quote = F, sep = ”\t”)

(iii) Identify domains with the largest timing changes in either direction, as well as domains with stable timing between data sets, using cutoffs from the quantile( ) function.

> quantile(dRTdom$seg.mean, probs = c(0.05, 0.95)) #
Top 5% of changes to early/late
> quantile(dRTdom$seg.mean, probs = c(0.40, 0.60)) #
Middle 20% of smallest changes
> LtoEdom = subset(dRTdom, dRTdom$seg.mean > 1.28552)
# Isolate late-to-early domains
> EtoLdom = subset(dRTdom, dRTdom$seg.mean < −1.32328)
# Isolate early-to-late domains
> middleDom = subset(dRTdom, dRTdom$seg.mean > −
0.14808 # Isolate non-switching domains &
dRTdom$seg.mean < 0.23698)
> boxplot(middleDom$size, LtoEdom$size, EtoLdom$size)
# Plot distributions of domain sizes

### Comparison and Alignment to Outside Data Sets—Timing 6 h

88. Choose among several alternative approaches to compare the timing program with the vast array of genome-wide or gene-centric data made available through initiatives such as ENCyclopedia Of DNA Elements⁴⁹⁻⁵¹ and public repositories such as Gene Expression Omnibus.^{52,53} To study gene-level regulation, assign RT values (option A) and epigenetic marks (option B) to lists of RefSeq or other gene locations. For domain-level analysis, average values within the boundaries of replication domains (option C).

(A) Assignment of RT values to gene promoters
(i) Assign LOESS-smoothed timing values to gene promoters as outlined below. Although the main purpose of LOESS is to derive an overall smoothed RT profile, the smoothed data object produced can be interrogated at any set of genomic coordinates, making it especially valuable for comparing data sets from different array platforms and coordinates. Using this approach, timing data is assigned to the RefSeq gene promoter locations of NCBI as follows:
(ii) Begin by loading the required data sets; these include a table of RefSeq gene locations for the desired species (found at http://www.ncbi.nlm.nih.gov/RefSeq/) and a list of smoothed RT values created in Step 86 and loaded as in Step 65.
(iii) Next, create a list of chromosomes to be analyzed and variables to store the data in each chromosome.

> chrs = levels(RefSeq$CHR) # Create a list of
chromosomes to be analyzed
> AllSm = NULL # Variable to store smoothed data for
all chromosomes
> ChrSm = NULL # Variable to store smoothed data for
one chromosome

(iv) Run the following loop to calculate RT values at transcription start sites of RefSeq genes. Advanced R users may substitute an appropriately reformatted function if desired, and the approach below may be used generically to apply values from any data type regulated on large scales (relative to array probe density) to any list of genomic coordinates.

> for(chr in chrs) { # For each chromosome,
> RTc = subset(RT, CHR = = chr) # Create subset of
timing values in the chromosome
> RSc = subset(RefSeq, CHR = = chr) # Create subset of
RefSeq genes in the chromosome
> cat(”Current chromosome: ”, chr, ”\n”) # Output
current chromosome to console
> lspan = 300000/(max(RTc$POSITION)−min(RTc$POSITION))
# Set smoothing span
> smLym1 = loess(RT$mLymphR1 ~ RT$POSITION, span =
lspan) # Smooth data set 1
> smLym2 = loess(RT$mLymphR2 ~ RT$POSITION, span =
lspan) # Smooth data set 2
> smLym3 = loess(RT$mLymphAve ~ RT$POSITION,
span = lspan) # Smooth data set 3
> Lym1 = predict(smLym1, RSc$TSS) # Predict
(interpolate) values at transcription start sites
> Lym2 = predict(smLym2, RSc$TSS) # Predict values for
data set 2
> Lym3 = predict(smLym3, RSc$TSS) # Predict values for
data set 3
> ChrSm = data.frame(CHR = chr,POSITION = RSc$TSS,
Lym1, Lym2, Lym3)
> AllSm = rbind(AllSm, ChrSm) # Combine information
for all experiments/chromosomes
> } # End for loop

(v) As in Steps 78 and 79, write the results of analysis to an external file before unloading the data from memory:
>write.table(AllSm, “Mouse lymphoblast RT at RefSeq gene positions.txt”, quote=F, sep=“\t”)

(B) Assignment of histone and other epigenetic marks to gene promoters
(i) Assign epigenetic and other data sets to gene promoters using Steps 88B(ii)-(v). Unlike RT, values from epigenetic data sets are often too sparse, relative to their unit of regulation, to apply the method in option 88A. For this example, values from a generic genome-wide ChIP-seq experiment are assigned to windows +500 to −2,500 bases from RefSeq gene promoters.
(ii) As in option A, first load the required data sets as described in Steps 65 and 88A(ii). Two files are required: one with columns describing the genomic coordinate, orientation (+/−) and chromosome of each gene (read into a variable named “RefSeq”) and another with the coordinate, chromosome and data value for each mark (read into variable ‘Marks’).
(iv) Create a list of chromosomes to be analyzed and variables to store the assigned values:
>chrs=levels (Marks$CHR); AllGenes=NULL; AllHist=NULL
(iv) Run the following loop to assign values near transcription start sites to RefSeq genes. The apply function may be set to assign the highest value within the promoter window to the gene; other approaches include averaging the number of reads within the body of genes54, individually analyzing equally spaced bins across open reading frames55 and assessing promoters with significant binding above background56. Bear in mind that the transcription start site may not be the best target for all modifications; indeed, for trimethylated lysine 36 of histone H3 (H3K36me3) marking transcription elongation, values at the transcription end point or exon 5′ ends may better represent overall enrichment.⁵⁷

> for (chr in chrs) { # For each chromosome,
> RSc = subset(RefSeq, CHR = = chr) # Create subset of
RefSeq genes in the chromosome
> MKc = subset(Marks, CHR = = chr) # Create subset of
mark values in the chromosome
> for(m in 1:nrow(RSc)) { # For each gene in the
chromosome,
> if(RSc[m,]$Strand = = ” + ”) { # If the gene is in
the forward orientation,
> RTcSub = subset(RTc, (RTc$Start < RSc[m,]$txStart +
500) & (RTc$Start > RSc[m,]$txStart − 2500)) # Collect
values from txStart + 500 to − 2500bp
> AllHist = rbind(AllHist, apply(RTcSub, 2,
max)[3:12]) # Assign max value to gene
> AllGenes = rbind(AllGenes, RSc[m,]$Gene) # Combine
with overall list
> } # End if
> if(RSc[m,]$Strand = = ”−”) { # If the gene is in the
reverse orientation,
> RTcSub = subset(RTc, (RTc$Start < RSc[m,]$txEnd +
2500) & (RTc$Start > RSc[m,]$txEnd − 500)) # Collect
values from txEnd + 2500 to − 500 bp
> AllHist = rbind(AllHist, apply(RTcSub, 2,
max)[3:12]) # Assign max value to gene
> AllGenes = rbind(AllGenes, RSc[m,]$Gene) # Combine
with overall list
> } # End if
> cat(”Chromosome:”, chr, ” Gene:”, m, ”/”, nrow(RSc),
”\n”) # Output current gene
> } # End gene loop
> } # End chromosome loop

(v) Finally, similarly to previous steps, combine the gene and epigenetic mark information into a single table and output as tab-delimited text.

> OutFile = data.frame(cbind(AllGenes, AllHist),
stringsAsFactors = F)
> write.table(OutFile, file = ”Histone modifications
at RefSeq gene positions.txt”, row.names = F, quote =
F, sep = ”\t”)

(C) Integration of epigenetic mark values over replication domains
(i) Use the method below to correlate domain-wide RT values and the average level of epigenetic marks within timing domains segmented in Step 86C (for static timing domains) or 87C (for domains that switch timing). Given that the magnitude of correlations between genetic properties generally increases when measured in larger windows, it is important to quantify these relationships in windows consistent with biologically regulated unit sizes.
(ii) Read the replication domains created in Step 86C or 87C into variable ‘Seg.RT’.
>Seg.RT=read.table(“Lymph-1 segments.txt”,header=T)
(iii) Create a list of chromosomes and variables in which to store average epigenetic mark and timing values.

> chrs = levels(Seg.RT$chrom)
> MarksData = NULL; RTData = NULL

(iv) Run the loop below to assign the average values of one or multiple epigenetic data sets to each replication domain or modify as needed.

> dom = 0 # Initialize domain number to 0
> for(chr in chrs) { # For each chromosome,
> Seg.RTb = subset(Seg.RT, Seg.RT$chrom = = chr) # Get
timing domains in chromosome
> MarksB = subset(Marks, Marks$CHR = = chr) # Get mark
data in chromosome
> for (i in 1:dim(Seg.RTb)[1]) { # For each domain,
> cat(”Current chr:”, chr, ” Domain:”, dom, ”\n”) #
Output current domain
> MarksD = subset(MarksB, MarksB$Start >
Seg.RTb[i,]$loc.start & MarksB$Start <
Seg.RTb[i,]$loc.end) # Find subset of marks in domain
> MarksD = MarksD[,3:12] # Exclude chr/pos from mark
data
> MarksD[,1:10] = MarksD[,1:10] − MarksD[,1] #
Subtract control values, if needed
> MarksData = rbind(MarksData, apply(MarksD,2,
”mean”)) # Average mark data in domain
> dom = dom + 1 # Increment domain number
> } # End domain loop
> } # End chromosome loop

(v) Finally, find the correlations between domain-wide RT and each type of epigenetic mark and create scatter plots to visualize these relationships.

> cor(Seg.RT$seg.mean, data.frame(MarksData))
> plot(Seg.RT$seg.mean, data.frame(MarksData)[1])

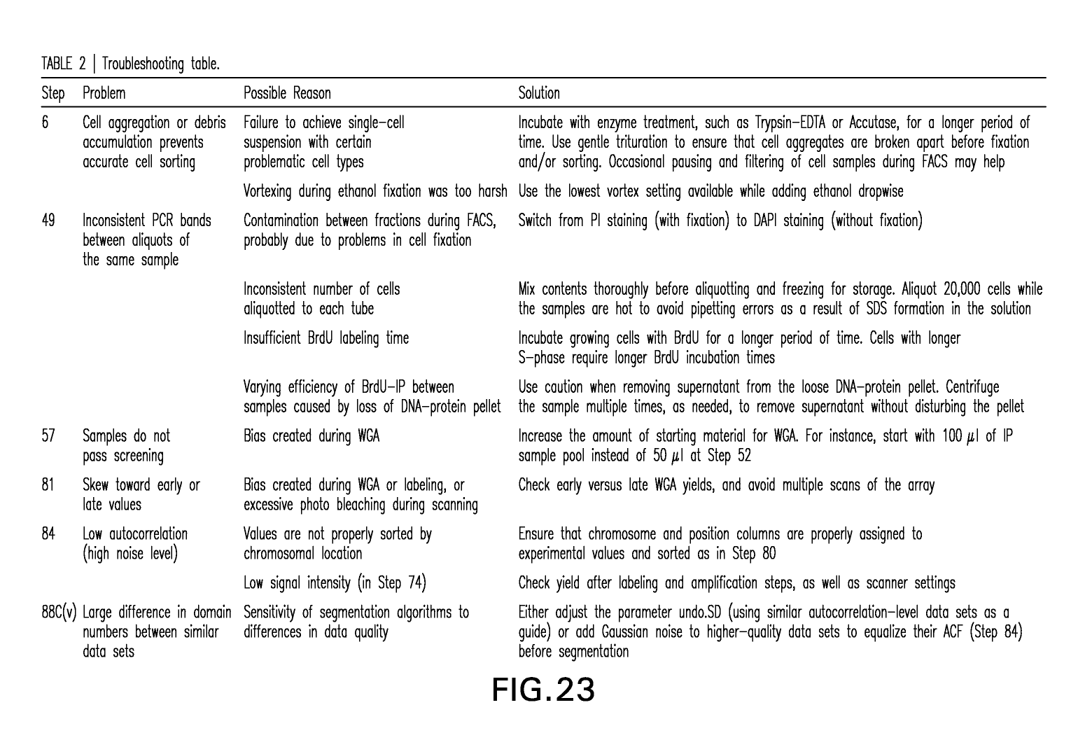

Troubleshooting advice can be found in Table 2 of FIG. 23.

### Results

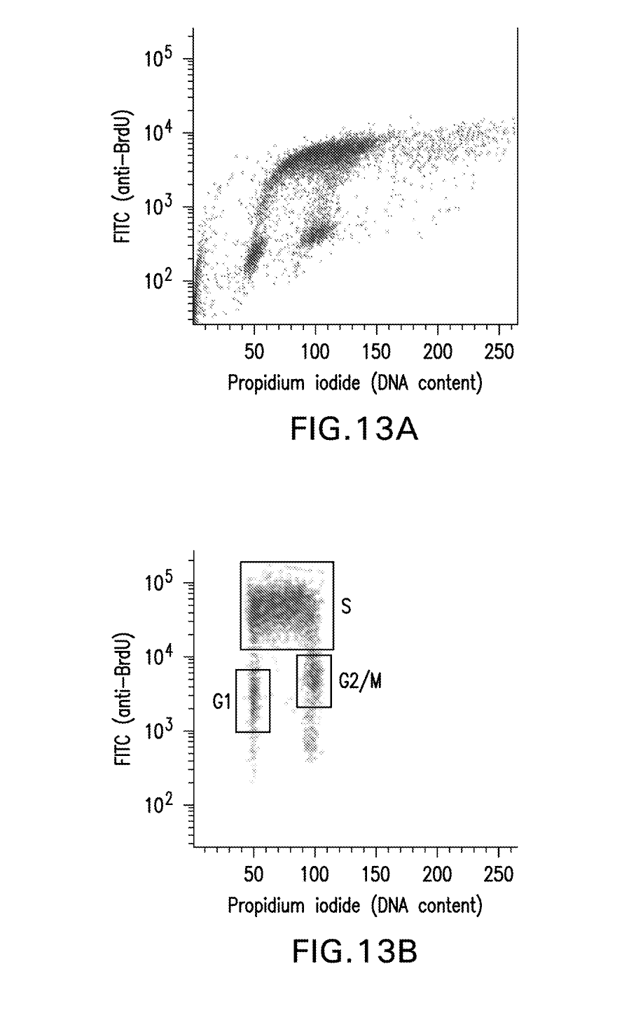

The described method is a powerful tool for genome-scale analysis of RT. However, meaningful data analysis is dependent on the quality of available data. Therefore, measures should be taken throughout the protocol to ensure that each phase of the procedure produces quality starting material for subsequent phases. Results for various steps of the protocol are described here. Typical FACS plots showing successful DNA content analysis and indicating appropriate S-phase fractions to be collected are shown in FIGS. 13A and 13B.

Following cell sorting and BrdU-IP, marker genes with known relative RT (Table 1 of FIG. 12) should be amplified by PCR for multiple IP samples and detected by electrophoresis on an agarose gel. Among the mouse sequences listed in Table 1 of FIG. 12, mitochondrial DNA replicates throughout the cell cycle⁵⁸ and will typically be equally represented in early and late S-phase fractions. Hba-a1, Pou5f1 and Mmp15 are generally early-replicating markers, whereas Hbb-b1, Zfp42, Dppa2, Ptn, Mash1 and Akt3 are generally late-replicating markers. Note that some genes switch RT at some point during development; for instance, Zfp42 and Dppa2 are early-replicating in ESCs, but late-replicating in all somatic cell types examined to date. Therefore, consistency across multiple samples from the same cell type is usually the most reliable way to assess the quality of IP samples. Among the human sequences listed in Table 1 of FIG. 12, mitochondrial DNA is equally represented in early and late S-phase fractions, whereas HBA1, MMP15 and BMP1 are generally early-replicating markers. PTGS2, NETO1, SLITRK6, ZFP42 and DPPA2 are generally late-replicating. High-quality IP reactions show consistency in the relative amount of BrdU-labeled DNA in respective S-phase fractions between samples of the same cell type. This PCR analysis should be performed again directly following WGA in order to ensure that no bias has been introduced during this step of the procedure. If no bias is detected, 4-8 μl of purified WGA3 DNA should be run on a 1.5% agarose gel in order to determine its quality. Quality DNA will range in size from 100 to 1,000 bp, with an average size of ˜400 bp. In addition, WGA3 DNA should have an A₂₆₀/A₂₈₀ value≧1.8 and an A₂₆₀/A₂₃₀ value≧1.9

### Alternative Method for Sorting According to S/G1-Phase—Timing 1 Day

In this method, cells are sorted into two fractions, G1- and S-phase, based on DNA content, and RT is derived from the twofold copy number increase for early versus late-replicating sequences in pure S-phase populations. DNA analysis using flow cytometry can be performed simply by the use of a single DNA-binding fluorescent dye, such as PI or DAPI, as originally described.⁵⁹ Although this method is adequate, simultaneous measurement of BrdU-labeled DNA by performing BrdU/PI double staining for cell cycle analysis can discriminate G1- and early S-phase cells much more efficiently than by PI-only staining In addition, some cell types, particularly those derived from differentiated stem cells or primary tissues, can produce debris that interferes with good S-phase sorting, and a short BrdU label described here can eliminate debris that is not labeled with BrdU. The advantage of this method is that it eliminates the need for BrdU-IP and WGA steps (described in Steps 13-44 and 51-57), which need to be carefully controlled. However, direct comparisons have shown that this method produces a lower signal-to-noise ratio than the method described in the Main Procedure described above.⁶

A much shorter BrdU pulse label is used in this protocol at lower concentration, because in this protocol the object is only to try to identify the cells in S-phase. With longer BrdU-labeling time periods, G2/M cells become labeled. It should be noted that that while the standard protocol for BrdU/PI analysis provided by Becton-Dickinson may be fine for analysis, it has been found that the high concentration of HCl in this method sheared genomic DNA to very small fragments that precluded subsequent steps of the protocol. By titrating HCl, it has been found that 0.1 M HCl produced the optimal compromise between good S- versus G1-phase separation and minimal DNA shearing.

For BrdU/PI double-staining, correction of spectral overlap is critical for successful experiments. Spectral overlap exists between emission spectra of PI and fluorescein isothiocyanate (FITC)/Alexa Fluor 488 (for BrdU). Without correction, the BrdU/PI plots typically look similar to those shown in FIG. 13A. For this correction, the adjustment of the ratio between PI and Alexa Fluor 488 (or FITC) gains can significantly reduce the skewing shown in FIG. 13A. Subtraction of the FITC signal from the PI signal (i.e., compensation) may also be required. To perform these corrections, a ‘BrdU-only’ control is required, prepared by staining BrdU-labeled cells without the addition of PI. A ‘PI-only’ control also helps, prepared by staining non-BrdU-labeled cells for BrdU and PI. (Note: BrdU-labeled specimen stained for PI only does not reflect background signals derived from the anti-BrdU antibody and thus is not as good as unlabeled cells.) This step can be time-consuming, but it is importantl for successful sorting. In one embodiment of the present invention, the gains of forward scatter and side scatter are adjusted first, and then the PI and AlexaFluor488 gain may be adjusted by trial and error to obtain the best possible BrdU/PI plot. It may be possible obtain a reasonable BrdU/PI plot without compensation; otherwise, compensate by subtracting FITC signal from PI signal. The lower the percentage subtracted, the better. FIGS. 13A and 13B show two-dimensional cell-cycle sorting for S- and G1-phases. Cells labeled with BrdU and stained as described in the Alternative Method for Sorting According to S/G1-Phase below, and then analyzed on a FACS instrument. FIG. 13A shows a typical noncorrected BrdU/PI plot. Note how the plot is skewed to the right because of spectral overlap. FIG. 13B shows a corrected BrdU/PI plot. Sorting windows for nicely separated G1, S and G2/M phases of the cell cycle are indicated.

### S/G1 FACS Sorting—Timing 1 Day

1. For adherent cells, remove cell culture medium from exponentially growing cells, and replace with cell culture medium containing BrdU at a final concentration of 10 μM. For suspension cells, add BrdU to the cell culture medium at a final concentration of 10 μM. In order to obviate the amplification step before labeling and array hybridization, start with 6 million cells. One should also prepare a small sample of non-BrdU-labeled, ethanol-fixed cells for PI-only control and set aside a small number of BrdU-labeled cells for BrdU-only control.

2. Incubate cells for 15 min in a CO₂ incubator at 37° C. and 5% CO₂.

3. Fix as described in Steps 1A(iii)-(x) of the Main Procedure. Pause Point—Cells can be stored as in Step 1A.

4. Aliquot (multiples of) 3×106 cells in 1.5 ml tube(s), centrifuge for 5 min at 200 g at room temperature. Removal of supernatant is much easier with 1.5-ml tubes, as the pellets are very loose.

5. Aspirate the supernatant completely with a P200 pipette. Here and elsewhere, an additional pulse spin (˜3 s) will help with discarding residual supernatant.

6. Loosen the pellet by brief vortexing.

7. Add 1 ml of 0.1 M HCl/0.5% (vol/vol) Triton X-100; resuspend by tapping.

8. Incubate for 15 min at room temperature in the dark.

9. Centrifuge for 5 min at 200 g at room temperature, then aspirate the supernatant completely.

10. Add 1 ml of 0.1 M sodium tetraborate, and resuspend by tapping.

11. Centrifuge for 5 min at 200 g at room temperature, then aspirate the supernatant completely.

12. Add 0.15 μg anti-BrdU antibody in 0.5 ml of 0.5% (vol/vol) Tween-20/1% (vol/vol) BSA/PBS, and resuspend by tapping.

13. Incubate for 30 min at room temperature in the dark.

14. Centrifuge for 5 min at 200 g at room temperature, then aspirate the supernatant completely.

15. Add 0.5 ml of 0.5% (vol/vol) Tween-20/1% (vol/vol) BSA/PBS.

16. Centrifuge for 5 min at 200 g at room temperature, then aspirate the supernatant completely.

17. Add 1 μg of anti-mouse IgG-Alexa Fluor 488 in 100 μl of 0.5% (vol/vol) Tween-20/1% (vol/vol) BSA/PBS, and resuspend by tapping (or when 1-2×106 cells are used, add 0.5 μg of mouse-specific IgG—Alexa Fluor 488 in 50 μl).

18. Incubate for 30 min at room temperature in the dark.

19. Centrifuge for 5 min at 200 g at room temperature, then aspirate the supernatant completely.

20. Add 0.5 ml of 0.5% (vol/vol) Tween-20/1% (vol/vol) BSA/PBS.

21. Centrifuge for 5 min at 200 g at room temperature, then aspirate supernatant completely.

22. Resuspend the pellet in 1 ml of 5 μg ml—1 PI in PBS (for ‘BrdU-only’ control, just add PBS).

23. Transfer to a round-bottom 5-ml tube (i.e., Falcon 2054).

24. Adjust the concentration to 2×106 ml⁻¹ by adding 5 μg ml⁻¹ PI in PBS. For BrdU-only sample, adjust to the same concentration by adding PBS without PI.

25. Filter with a 37 μm mesh filter.

26. Bring to flow lab for sorting (on ice, in the dark). Resume the Main Procedure at Step 58.

### Timing

The timing for the steps of the method of this example, including the Alternative Method for Sorting According to S/G1-Phase are as follows:

Steps 1-12, BrdU labeling and FACS sorting: 5-6 h

Steps 13-44, BrdU immunoprecipitation: 2-3 d

Steps 45-50, PCR assay: 4-6 h

Steps 51-57, Whole-genome amplification: ˜5 h

Alternative Method for Sorting According to S/G1-Phase S/G1 FACS sorting: ˜1 d

Step 58, Dye labeling: 3-4 h

Step 59, Hybridization: ˜1 h plus hybridization time

Steps 60 and 61, Washing and scanning: 1-2 h

Steps 62-85, Normalization: ˜1 d

Step 86, Static properties: ˜3 h

Step 87, Dynamic properties: ˜3 h

Step 88, Outside data sets: ˜6 h

All documents, patents, journal articles and other materials cited in the present application are incorporated herein by reference in their entirety. Although the present invention has been fully described in conjunction with several embodiments thereof with reference to the accompanying drawings, it is to be understood that various changes and modifications may be apparent to those skilled in the art. Such changes and modifications are to be understood as included within the scope of the present invention as defined by the appended claims, unless they depart therefrom.

### REFERENCES

The following references are referred to above and are incorporated herein by reference:
1. Pope, B. D., Hiratani, I. & Gilbert, D. M. Domain-wide regulation of DNA replication timing during mammalian development. Chromosome Res. 18, 127-36 (2010).
2. Yaffe, E. et al. Comparative analysis of DNA replication timing reveals conserved large-scale chromosomal architecture. PLoS Genet. 6, e1001011 (2010).
3. Ryba, T. et al. Evolutionarily conserved replication timing profiles predict long-range chromatin interactions and distinguish closely related cell types. Genome Res. 20, 761-70 (2010).
4. Gilbert, D. M. et al. Space and time in the nucleus: developmental control of replication timing and chromosome architecture. Cold Spring Harb. Symp. Quant. Biol. doi:10.1101/sqb.2010.75.011 (2010).
5. Hiratani, I. et al. Genome-wide dynamics of replication timing revealed by in vitro models of mouse embryogenesis. Genome Res. 20, 155-69 (2010).
6. Hiratani, I. et al. Global reorganization of replication domains during embryonic stem cell differentiation. PLoS Biol. 6, e245 (2008).
7. Schwaiger, M. et al. Heterochromatin protein 1 (HP1) modulates replication timing of the Drosophila genome. Genome Res. 20, 771-80 (2010).
8. Schwaiger, M. et al. Chromatin state marks cell-type- and gender-specific replication of the Drosophila genome. Genes Dev. 23, 589-601 (2009).
9. Schübeler, D. et al. Genome-wide DNA replication profile for Drosophila melanogaster: a link between transcription and replication timing. Nat. Genet. 32, 438-42 (2002).
10. Lee, T.-J. et al. Arabidopsis thaliana chromosome 4 replicates in two phases that correlate with chromatin state. PLoS Genet. 6, e1000982 (2010).
11. Koren, A., Soifer, I. & Barkai, N. MRC1-dependent scaling of the budding yeast DNA replication timing program. Genome Res. 20, 781-90 (2010).
12. Raghuraman, M. K. & Brewer, B. J. Molecular analysis of the replication program in unicellular model organisms. Chromosome Res. 18, 19-34 (2010).
13. Hayashi, M. et al. Genome-wide localization of pre-RC sites and identification of replication origins in fission yeast. EMBO J. 26, 1327-39 (2007).
14. Karnani, N., Taylor, C. M. & Dutta, A. Microarray analysis of DNA replication timing. Methods Mol. Biol. 556, 191-203 (2009).
15. Farkash-Amar, S. & Simon, I. Genome-wide analysis of the replication program in mammals. Chromosome Res. 18, 115-25 (2009).
16. Sasaki, T. et al. The Chinese hamster dihydrofolate reductase replication origin decision point follows activation of transcription and suppresses initiation of replication within transcription units. Mol. Cell. Biol. 26, 1051-62 (2006).
17. Gilbert, D. M. Replication origin plasticity, Taylor-made: inhibition vs recruitment of origins under conditions of replication stress. Chromosoma 116, 341-47 (2007).
18. Anglana, M. et al. Dynamics of DNA replication in mammalian somatic cells: nucleotide pool modulates origin choice and interorigin spacing. Cell 114, 385-394 (2003).
19. Gilbert, D. M. Evaluating genome-scale approaches to eukaryotic DNA replication. Nat. Rev. Genet. 11, 673-84 (2010).
20. Gilbert, D. M. Temporal order of replication of Xenopus laevis 5S ribosomal RNA genes in somatic cells. Proc. Natl. Acad. Sci. USA 83, 2924-28 (1986).
21. Gilbert, D. M. & Cohen, S. N. Bovine papilloma virus plasmids replicate randomly in mouse fibroblasts throughout S phase of the cell cycle. Cell 50, 59-68 (1987).
22. Hansen, R. S. et al. Association of fragile X syndrome with delayed replication of the FMR1 gene. Cell 73, 1403-1409 (1993).
23. Yokochi, T. et al. G9a selectively represses a class of late-replicating genes at the nuclear periphery. Proc. Natl. Acad. Sci. USA 106, 19363-68 (2009).
24. Lu, J. et al. G2 phase chromatin lacks determinants of replication timing. J. Cell Biol. 189, 967-80 (2010).
25. Pollack, J. R. et al. Genome-wide analysis of DNA copy-number changes using cDNA microarrays. Nat. Genet. 23, 41-46 (1999).
26. Acevedo, L. G. et al. Genome-scale ChIP-chip analysis using 10,000 human cells. BioTechniques 43, 791-97 (2007).
27. Smyth, G. K. Linear models and empirical Bayes methods for assessing differential expression in microarray experiments. Stat. Appl. Genet. Mol. Biol. 3, 3 (2004).
28. Yang, Y. H. et al. Normalization for cDNA microarray data: a robust composite method addressing single and multiple slide systematic variation. Nucleic Acids Res. 30, e15 (2002).
29. Bolstad, B. M. et al. A comparison of normalization methods for high density oligonucleotide array data based on variance and bias. Bioinformatics 19, 185-93 (2003).
30. Core, R. D. R: A Language and Environment for Statistical Computing. (R Foundation for Statistical Computing, 2008).
31. Gentleman, R. C. et al. Bioconductor: open software development for computational biology and bioinformatics. Genome Biol. 5, R80 (2004).
32. Ihaka, R. & Gentleman, R. R: A language for data analysis and graphics. J. Comput. Graph. Stat. 5, 299-314 (1996).
33. Spector, P. Data Manipulation with R (Springer Publishing Company, 2008).
34. Chambers, J. M. Software for Data Analysis: Programming with R (Springer Publishing Company, 2008).
35. Crawley, M. J. The R Book (Wiley, 2007).
36. Wettenhall, J. M. & Smyth, G. K. limmaGUI: a graphical user interface for linear modeling of microarray data. Bioinformatics 20, 3705-06 (2004).
37. Hansen, R. S. et al. Sequencing newly replicated DNA reveals widespread plasticity in human replication timing. Proc. Natl. Acad. Sci. USA 107, 139-44 (2010).
38. Pombo, A. & Gilbert, D. M. Nucleus and gene expression: the structure and function conundrum. Curr. Opin. Cell Biol. 22, 269-70 (2010).
39. O'Geen, H. et al. Comparison of sample preparation methods for ChIP-chip assays. BioTechniques 41, 577-80 (2006).
40. Peng, S. et al. Normalization and experimental design for ChIP-chip data. BMC Bioinformatics 8, 219 (2007).
41. Reimers, M. & Weinstein, J. N. Quality assessment of microarrays: visualization of spatial artifacts and quantitation of regional biases. BMC Bioinformatics 6, 166 (2005).
42. Venkatraman, E. S. & Olshen, A. B. A faster circular binary segmentation algorithm for the analysis of array CGH data. Bioinformatics 23, 657-63 (2007).
43. Dellinger, A. E. et al. Comparative analyses of seven algorithms for copy number variant identification from single nucleotide polymorphism arrays. Nucleic Acids Res. 38, e105 (2010).
44. Willenbrock, H. & Fridlyand, J. A comparison study: applying segmentation to array CGH data for downstream analyses. Bioinformatics 21, 4084-91 (2005).
45. Lai, W. R. et al. Comparative analysis of algorithms for identifying amplifications and deletions in array CGH data. Bioinformatics 21, 3763-70 (2005).
46. Olshen, A. B. et al. Circular binary segmentation for the analysis of array-based DNA copy number data. Biostatistics 5, 557-72 (2004).
47. Eisen, M. B. et al. Cluster analysis and display of genome-wide expression patterns. Proc. Natl. Acad. Sci. USA 95, 14863-68 (1998).
48. Suzuki, R. & Shimodaira, H. Pvclust: an R package for assessing the uncertainty in hierarchical clustering. Bioinformatics 22, 1540-42 (2006).
49. ENCODE Project Consortium. The ENCODE (ENCyclopedia Of DNA Elements) Project. Science 306, 636-640 (2004).
50. Birney, E. et al. Identification and analysis of functional elements in 1% of the human genome by the ENCODE pilot project. Nature 447, 799-816 (2007).
51. Rosenbloom, K. R. et al. ENCODE whole-genome data in the UCSC genome browser. Nucleic Acids Res. 38, D620-D625 (2010).
52. Edgar, R., Domrachev, M. & Lash, A. E. Gene Expression Omnibus: NCBI gene expression and hybridization array data repository. Nucleic Acids Res. 30, 207-10 (2002).
53. Barrett, T. et al. NCBI GEO: archive for high-throughput functional genomic data. Nucleic Acids Res. 37, D885-D890 (2009).
54. Barski, A. et al. High-resolution profiling of histone methylations in the human genome. Cell 129, 823-37 (2007).
55. Salcedo-Amaya, A. M. et al. Dynamic histone H3 epigenome marking during the intraerythrocytic cycle of Plasmodium falciparum. Proc. Natl. Acad. Sci. USA 106, 9655-60 (2009).
56. Guenther, M. G. et al. A chromatin landmark and transcription initiation at most promoters in human cells. Cell 130, 77-88 (2007).
57. Hon, G., Wang, W. & Ren, B. Discovery and annotation of functional chromatin signatures in the human genome. PLoS Comput. Biol. 5, e1000566 (2009).
58. Aladjem, M. I. et al. Replication initiation patterns in the beta-globin loci of totipotent and differentiated murine cells: evidence for multiple initiation regions. Mol. Cel. Biol. 22, 442-52 (2002).
59. Woodfine, K. et al. Replication timing of the human genome. Hum. Mol. Genet. 13, 191-202 (2004).

What is claimed is:

1. A method for identifying cells comprising the following step:
(a) identifying the cell type of a population of cells by comparing a replication timing test profile to a replication timing reference profile and determining whether the replication timing test profile and the replication timing reference profile are substantially the same,
wherein the replication timing test profile for the population of cells is derived from hybridizing fluorescently labeled DNA from the population of cells to a genomic array having an average probe spacing of about 6 kilobases (kb) or less to determine a replication timing test profile for the population of cells.

2. The method of claim 1, wherein step (a) is conducted by a computer.

3. The method of claim 1, wherein the method comprises the following step:
(b) displaying to a user the cell type identified in step (a).

4. The method of claim 1, wherein the replication timing test profile is a normalized replication timing test profile.

5. The method of claim 1, wherein the replication timing test profile comprises a replication timing profile for the whole genome of the population of cells.

6. The method of claim 1, wherein the genomic array is a comparative genomic hybridization (CGH) array.

7. The method of claim 1, wherein the genomic array is a tiling array.

8. The method of claim 1, wherein the population of cells comprises a cell line.

9. The method of claim 1, wherein the population of cells comprises primary cells derived from an individual.

10. The method of claim 1, wherein the population of cells comprises embryonic stem cells, precursor cells, iPS cells or differentiated cells.

11. The method of claim 1, wherein the population of cells comprises diseased, transformed or tumorigenic cells.

12. The method of claim 1, wherein the population of cells comprises a population of mammalian cells.

13. The method of claim 1, wherein the replication timing reference profile is a replication timing fingerprint for a particular cell type.

14. The method of claim 13, wherein the replication timing fingerprint is defined as at least one region of a chromosome from cells of the particular cell type that differs in replication timing ratio values by at least about 0.5 across a distance of at least about 50 kilobases (kb) compared to different cell types, wherein each replication timing ratio value is equal to log₂(early/late S-phase replication).

15. The method of claim 14, wherein step (a) is carried out such that the replication timing test profile and the replication timing fingerprint are determined to be substantially the same if the replication timing test profile differs from the replication timing fingerprint over the length of the at least one region of a chromosome by about 2.0 or less in terms of their replication timing ratio, wherein each replication timing ratio is equal to log₂(early/late S-phase replication).

16. The method of claim 14, wherein step (a) is carried out such that the replication timing test profile and the replication timing fingerprint are determined to be substantially the same if the replication timing test profile over the length of the at least one region of a chromosome differs from the replication timing fingerprint by about 1.0 or less in terms of their replication timing ratio, wherein each replication timing ratio is equal to log₂(early/late S-phase replication).

17. The method of claim 1, wherein the replication timing reference profile is for: (1) a population of reference cells; or (2) an average replication timing reference profile for different populations of reference cells of the same cell type.

18. The method of claim 17, wherein step (a) is carried out such that the replication timing test profile and the replication timing reference profile are determined to be substantially the same if the average correlation coefficient (R) between the replication timing test profile and the replication timing reference profile is about 0.85 or greater.

19. The method of claim 17, wherein step (a) is carried out such that the replication timing test profile and the replication timing reference profile are determined to be substantially the same if the average correlation coefficient (R) between the replication timing test profile and the replication timing reference profile is about 0.9 or greater.

20. The method of claim 1, wherein step (a) is carried out such that the replication timing test profile and the replication timing reference profile are determined to be substantially the same if (1) at least about 95% of the loess-smoothed replication timing ratio values for the replication timing test profile and the replication timing reference profile differ by less than about 0.5; or (2) less than about 5% of the loess-smoothed replication timing ratio values for the replication timing test profile and the replication timing reference profile differ by more than about 0.5, wherein each replication timing ratio value is equal to log₂(early/late S-phase replication).

21. The method of claim 1, wherein the method comprises the following steps that are conducted prior to step (a):
(b) culturing the population of cells in a growth medium containing a modified nucleotide;
(c) separating the cultured population of cells into a population of early S-phase cells and a population of late S-phase cells based on the amount of DNA content per cell;
(d) obtaining replicated DNA from the population of early S-phase cells and replicated DNA from the population of late S-phase cells based on the modified nucleotide integrated into the respective replicated DNA;
(e) labeling the replicated DNA from the population of early S-phase cells with a first fluorescent label and the replicated DNA from the population of late S-phase cells with a second fluorescent label to provide, respectively, labeled early S-phase replicated DNA and labeled late S-phase replicated DNA; and
(f) hybridizing the labeled early S-phase replicated DNA and the labeled late S-phase replicated DNA to the genomic array to obtain the replication timing test profile for the population of cells.

22. The method of claim 21, wherein the modified nucleotide is bromodeoxyuridine (BrdU).

23. The method of claim 22, wherein the obtaining step (d) comprises the following steps: (1) separately isolating total DNA from each population of cells; (2) fragmenting total DNA into smaller fragments; and (3) immunoprecipitating replicated DNA using an anti-BrdU antibody.

24. The method of claim 21, wherein the separating step (c) comprises separating cells by fluorescent-activated cell sorting (FACS).

25. The method of claim 21, wherein the first and second fluorescent labels are different.

26. The method of claim 25, wherein the first and second fluorescent labels are each either cyanin-3 (Cy-3) or cyanin-5 (Cy-5).

27. The method of claim 1, wherein the method comprises the following steps that are conducted prior to step (a):
(b) separating the population of cells into a population of G1-phase cells and a population of S-phase cells based on the amount of DNA content per cell;
(c) obtaining DNA separately from each of the population of G1-phase and the population S-phase cells;
(d) labeling the DNA from the population of G1-phase cells with a first fluorescent label and the DNA from the population of S-phase cells with a second fluorescent label to provide, respectively, labeled G1-phase DNA and labeled S-phase DNA; and
(e) hybridizing the labeled G1-phase DNA and the labeled S-phase DNA to the genomic array to obtain the replication timing test profile for the population of cells.

28. The method of claim 27, wherein the separating step (b) comprises separating cells by fluorescent-activated cell sorting (FACS).

29. The method of claim 27, wherein the first and second fluorescent labels are different.

30. The method of claim 29, wherein the first and second fluorescent labels are each either cyanin-3 (Cy-3) or cyanin-5 (Cy-5).

31. The method of claim 1, wherein the method comprises the following steps that are conducted prior to step (a):
(b) dividing the population of cells into a first population of cells and a second population of cells;
(c) synchronizing the first population of cells and the second population of cells;
(d) after step (c), culturing the first population of cells for a first predetermined period of time and the second population of cells for a second predetermined period of time, wherein the first predetermined period of time is the amount of time to reach early S-phase, and wherein the second predetermined period of time is the amount of time to reach late S-phase;
(e) exposing the first population of cells after the first predetermined period of time to a modified nucleotide for a third period of time and the second population of cells after the second predetermined period of time to a modified nucleotide for a fourth period of time;
(f) isolating total DNA from the first population of cells after the third predetermined period of time and total DNA from the second population of cells after the fourth predetermined period of time;
(g) obtaining replicated DNA from the total DNA from the first population of cells and replicated DNA from the total DNA from the second population of cells based on the modified nucleotide integrated into the respective replicated DNA;
(h) labeling the replicated DNA from the first population of cells with a first fluorescent label and the replicated DNA from the second population of cells with a second fluorescent label; and
(i) hybridizing the labeled replicated DNA from the first population of cells and the labeled replicated DNA from the second population of cells to the genomic array to obtain the replication timing test profile for the population of cells.

32. The method of claim 31, wherein the modified nucleotide is bromodeoxyuridine (BrdU).

33. The method of claim 32, wherein the obtaining step (g) comprises the following steps: (1) separately isolating total DNA from each population of cells; (2) fragmenting total DNA into smaller fragments; and (3) immunoprecipitating replicated DNA using an anti-BrdU antibody.

34. The method of claim 31, wherein the first and second fluorescent labels are different.

35. The method of claim 34, wherein the first and second fluorescent labels are each either cyanin-3 (Cy-3) or cyanin-5 (Cy-5).

36. The method of claim 1, wherein the population of cells comprises transformed cells and wherein step (a) comprises identifying the cell type of the population of cells as transformed cells.

37. The method of claim 1, wherein the population of cells comprises cancerous cells and wherein step (a) comprises identifying the cell type of the population of cells as cancerous cells.

38. The method of claim 1, wherein the population of cells comprises tumor cells and wherein step (a) comprises identifying the cell type of the population of cells as tumor cells.


SEQUENCE LISTING (42 sequences)

SEQ ID NO: 1 - DNA, 22 bp, Artificial Sequence
  Description of Artificial Sequence Synthetic primer
cctaggaatcacctcccattcc

SEQ ID NO: 2 - DNA, 22 bp, Artificial Sequence
  Description of Artificial Sequence Synthetic primer
gtgtttaaggggttggctaggg

SEQ ID NO: 3 - DNA, 22 bp, Artificial Sequence
  Description of Artificial Sequence Synthetic primer
gaccctcttctctgcacagctc

SEQ ID NO: 4 - DNA, 22 bp, Artificial Sequence
  Description of Artificial Sequence Synthetic primer
gctaccgaggctccagcttaac

SEQ ID NO: 5 - DNA, 22 bp, Artificial Sequence
  Description of Artificial Sequence Synthetic primer
cctgaggagaagtctgccgtta

SEQ ID NO: 6 - DNA, 22 bp, Artificial Sequence
  Description of Artificial Sequence Synthetic primer
gaacctctgggtccaagggtag

SEQ ID NO: 7 - DNA, 22 bp, Artificial Sequence
  Description of Artificial Sequence Synthetic primer
caggcctctggtctctgtcatt

SEQ ID NO: 8 - DNA, 22 bp, Artificial Sequence
  Description of Artificial Sequence Synthetic primer
agagctgagaaaccaccaccag

SEQ ID NO: 9 - DNA, 22 bp, Artificial Sequence
  Description of Artificial Sequence Synthetic primer
gatgaagcctcgacccctagat

SEQ ID NO: 10 - DNA, 22 bp, Artificial Sequence
  Description of Artificial Sequence Synthetic primer
acccgtcagagacgaacttgag

SEQ ID NO: 11 - DNA, 22 bp, Artificial Sequence
  Description of Artificial Sequence Synthetic primer
gttctaggctggtgtcccattg

SEQ ID NO: 12 - DNA, 22 bp, Artificial Sequence
  Description of Artificial Sequence Synthetic primer
ctttctgtactgcgggtggaac

SEQ ID NO: 13 - DNA, 22 bp, Artificial Sequence
  Description of Artificial Sequence Synthetic primer
ggaggtggaatgctagggactt

SEQ ID NO: 14 - DNA, 22 bp, Artificial Sequence
  Description of Artificial Sequence Synthetic primer
gctgagtgtggccttaagagga

SEQ ID NO: 15 - DNA, 22 bp, Artificial Sequence
  Description of Artificial Sequence Synthetic primer
ggagaacatgcctccacagtct

SEQ ID NO: 16 - DNA, 22 bp, Artificial Sequence
  Description of Artificial Sequence Synthetic primer
gtcctggaagttgagtggatgg

SEQ ID NO: 17 - DNA, 22 bp, Artificial Sequence
  Description of Artificial Sequence Synthetic primer
cttgtggggacacccagataag

SEQ ID NO: 18 - DNA, 22 bp, Artificial Sequence
  Description of Artificial Sequence Synthetic primer
aaccacctccaggcagtagtga

SEQ ID NO: 19 - DNA, 22 bp, Artificial Sequence
  Description of Artificial Sequence Synthetic primer
aggtggacagcgaagacagaac

SEQ ID NO: 20 - DNA, 22 bp, Artificial Sequence
  Description of Artificial Sequence Synthetic primer
ggccatcagcagtgtcctaaac

SEQ ID NO: 21 - DNA, 20 bp, Artificial Sequence
  Description of Artificial Sequence Synthetic primer
gacatctggttcttacttca

SEQ ID NO: 22 - DNA, 20 bp, Artificial Sequence
  Description of Artificial Sequence Synthetic primer
gtttttggggtttggcatta

SEQ ID NO: 23 - DNA, 19 bp, Artificial Sequence
  Description of Artificial Sequence Synthetic primer
aaggggagcagaggcatca

SEQ ID NO: 24 - DNA, 18 bp, Artificial Sequence
  Description of Artificial Sequence Synthetic primer
agggcttgggagggactg

SEQ ID NO: 25 - DNA, 22 bp, Artificial Sequence
  Description of Artificial Sequence Synthetic primer
cagtaagccacagatcctattg

SEQ ID NO: 26 - DNA, 22 bp, Artificial Sequence
  Description of Artificial Sequence Synthetic primer
cccatagtgactattgactgtg

SEQ ID NO: 27 - DNA, 22 bp, Artificial Sequence
  Description of Artificial Sequence Synthetic primer
ccctccctaagtgccagtttct

SEQ ID NO: 28 - DNA, 22 bp, Artificial Sequence
  Description of Artificial Sequence Synthetic primer
gtaatcgccctcagcagtgtct

SEQ ID NO: 29 - DNA, 20 bp, Artificial Sequence
  Description of Artificial Sequence Synthetic primer
aacagaaggcctgccttgac

SEQ ID NO: 30 - DNA, 20 bp, Artificial Sequence
  Description of Artificial Sequence Synthetic primer
tgcatagcacgacagcattg

SEQ ID NO: 31 - DNA, 22 bp, Artificial Sequence
  Description of Artificial Sequence Synthetic primer
tgagattagccccgagactgag

SEQ ID NO: 32 - DNA, 22 bp, Artificial Sequence
  Description of Artificial Sequence Synthetic primer
cgtcccctttgtcatgtactcc

SEQ ID NO: 33 - DNA, 22 bp, Artificial Sequence
  Description of Artificial Sequence Synthetic primer
ccacaggaagacaggaagcagt

SEQ ID NO: 34 - DNA, 22 bp, Artificial Sequence
  Description of Artificial Sequence Synthetic primer
agccagacaggagccctagagt

SEQ ID NO: 35 - DNA, 22 bp, Artificial Sequence
  Description of Artificial Sequence Synthetic primer
ctggaatgagttactgacgggg

SEQ ID NO: 36 - DNA, 22 bp, Artificial Sequence
  Description of Artificial Sequence Synthetic primer
ctggccccactgtgtaataagc

SEQ ID NO: 37 - DNA, 22 bp, Artificial Sequence
  Description of Artificial Sequence Synthetic primer
gaagatgagcaaggtggagacg

SEQ ID NO: 38 - DNA, 22 bp, Artificial Sequence
  Description of Artificial Sequence Synthetic primer
agtaggacgagaccggagaacc

SEQ ID NO: 39 - DNA, 22 bp, Artificial Sequence
  Description of Artificial Sequence Synthetic primer
gaagtgtgggttgaacctctgg

SEQ ID NO: 40 - DNA, 22 bp, Artificial Sequence
  Description of Artificial Sequence Synthetic primer
gcaccctctccactgttctgat

SEQ ID NO: 41 - DNA, 40 bp, Artificial Sequence
  Description of Artificial Sequence Synthetic primer
taatacgactcactatagggggctcagaactgaacaaaga

SEQ ID NO: 42 - DNA, 21 bp, Artificial Sequence
  Description of Artificial Sequence Synthetic primer
gctcataatgttgttccacct